(19) United States
(12) Patent Application Publication
(10) Pub. No.: US 2010/0160176 A1
(43) Pub. Date: Jun. 24, 2010

(54) RAT GENE EXPRESSION PROFILING OF DRUG TRANSPORTERS, CYTOCHROME P450s, TRANSFERASES AND NUCLEAR XENOBIOTIC RECEPTORS FOR PREDICTING DRUG EFFECTS

(75) Inventors: Robert Shipman, Mississauga (CA); Jodi A. Morrison, Mississauga (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: NOAB BIODISCOVERIES INC., Mississauga, ON (CA)

(21) Appl. No.: 12/604,716

(22) Filed: Oct. 23, 2009

Related U.S. Application Data
(60) Provisional application No. 61/107,878, filed on Oct. 23, 2008.

(51) Int. Cl. C40B 30/04; C40B 40/06; C40B 50/06

(52) U.S. Cl. 506/9; 506/16; 506/26

(57) ABSTRACT

The disclosure describes materials and methods for detecting the expression of genes and generating a gene expression profile from drug-treated rat primary cells or established rat cell lines using a unique combination of rat cytochrome p450 enzyme, nuclear xenobiotic receptor, transferase and transporter gene sequences. The materials include sets of primers, PCR amplicons and arrays. The methods include hybridization assays. Assays for the detection of the expression of the genes are also provided. In addition, the disclosure provides the use of the materials and methods in drug screening assays and, specifically, the detection of potential drug-drug interaction(s).

The present application contains the benefit of Provisional Application No. 61/107,878, filed Oct. 23, 2008, the contents of which are herein incorporated by reference.

### FIELD OF THE DISCLOSURE

The disclosure relates to compositions, materials and methods for detecting and assessing the expression levels of specific rat genes and various effects thereon. In particular, the disclosure relates to a microarray-comprising a unique combination of discrete, transcriptionally co-regulated groups of rat ADME (adsorption, distribution, metabolism and elimination) related genes and its use for gene expression profiling in drug-treated rat primary cells or established rat cell lines.

### BACKGROUND OF THE DISCLOSURE

Specific genes are responsible for the metabolism, conjugation and elimination of both natural substrates (endobiotics—steroid hormones, lipids, fatty acids, bile acids, prostaglandins, peptides, etc.) and synthetic compounds (xenobiotics—drugs). Compounds enter the cell via specific uptake transporters or passive diffusion, cytochrome p450s metabolise these compounds, transferases conjugate these compounds prior to elimination and efflux transporters facilitate removal of these conjugated compounds from cells.

The ability to predict drug-drug interactions, adverse drug reactions or toxic drug effects before drugs are used in clinical trials or administered to patients has been one of the central objectives in drug discovery and development (Cunningham et al. Ann NY Acad Sci 919 52 2000; Gerold et al. Physiol Genomics 5 161 2001; Kier et al. Mutation Research 549 101 2004). It is noted that (i) adverse drug effects account for more than 2,000,000 hospitalizations and 100,000 deaths per year in the US and (ii) half of the drugs withdrawn from the US market between 1997 and 2002 exhibited significant drug-drug interactions.

The variability in drug response is due to individual differences in the levels of expression of drug metabolizing enzymes and drug transporters at specific sites of drug absorption, distribution and elimination. This variability can alter both the overall drug exposure and drug distribution which may result in adverse drug effects, toxic drug effects or drug failure/lack of efficacy (Worthman et al. Drug Meatb Disp 35 1700 2007).

The majority of drug-drug interactions occur during drug metabolism and result from either one drug inhibiting or decreasing the metabolism, conjugation and/or elimination of another drug or one drug inducing or increasing the metabolism, conjugation and/or elimination of another drug.

### SUMMARY OF THE DISCLOSURE

Induction of ADME-related gene expression is responsible for increased metabolism of new chemical entities (NCEs) or approved drugs and this induction is mediated via activation of the nuclear xenobiotic receptors (NXRs). Since NXRs coordinately activate genes involved in all phases of xenobiotic metabolism (oxidative metabolism, conjugation and transport), the functional consequences of NXR-mediated co-activation/co-regulation of ADME-related gene expression are manifest as either efficacious drug responses or adverse drug effects due to drug-drug interactions. Assessing the activation and induction of NXR and ADME-related gene expression by drugs can predict the potential for drug-drug interactions and adverse drug effects.

Cytochrome P450s and other drug sensing, transport and metabolism systems play a major role in the potentiation of adverse drug effects. All these genes are strongly expressed in liver cells. The interplay between drug metabolism, detoxification and toxicity depends not only on the drug itself but also on the coordinated regulation and expression of the CYPs and other genes in the drug sensing, transport and metabolism systems.

The expression levels of cytochrome p450 enzymes, nuclear xenobiotic receptors, transferases, uptake transporters and efflux transporters in a cell significantly influence the efficacy of drugs. Thus, for the first time, the present disclosure provides an integrated approach to the analysis of the gene expression of rat cytochrome P450 enzymes, transferases, transporters and nuclear xenobiotic receptors. With respect to drug transport and metabolism, this approach will better define and predict the pharmacokinetics, pharmacodynamics and potential toxic effects of new or existing drugs in rat models.

The present disclosure includes materials and methods to determine a change in the expression profile of a specific and unique subset of rat genes in response to a drug or combination of drugs. In particular, the materials and methods are used to determine a change in the gene expression profile in test cells comprising nucleic acid molecules from a selected subset of target genes involved in drug transport, drug metabolism or regulators of the expression of these genes, or the function of the proteins encoded by these genes. In a specific embodiment, the materials and methods are used to determine the gene expression of the specific combination of cytochrome p450 enzymes, nuclear xenobiotic receptors, transferases, uptake transporters and efflux transporters.

The materials and methods of the present disclosure represent a model that reveals the impact of compounds and other stimuli on the expression of genes encoding cytochrome p450 enzymes, nuclear xenobiotic receptors, transferases, uptake transporters and efflux transporters, that avoids having to test the compounds in humans. The detection and identification of recurrent gene expression profiles, of discrete, transcriptionally co-regulated groups of ADME-related genes found in rats, associated with either adverse drug reactions or toxic drug effects can have profound implications for drug treatment, drug discovery and drug development programs.

Accordingly, the present disclosure includes an array, which can be used for the convenient, collective and simultaneous analysis of the effects of different stimuli (for eg. drugs, drug-like compounds or other chemical entities) on the coordinated gene expression of rat cytochrome P450 enzymes, transferases, uptake transporters, efflux transporters and nuclear xenobiotic receptors. The array is used in a screening process for the evaluation of potential drug-drug interactions or adverse effects prior to use and/or testing in humans. For example, the array can be used during animal studies and/or preclinical trials for a new drug or new formulation of an existing drug.

Primer pairs for generating nucleic acids that specifically hybridize to only one gene encoding a specific member of a unique subset of ADME-related genes, including cytochrome p450 enzymes, nuclear xenobiotic receptors, transferases, uptake transporters and efflux transporters have been prepared. These primers were used to generate double stranded nucleic acid molecules, also referred to herein as amplicons, that can be used as probes in assays, such as array-based assays, to screen for the expression of genes encoding these proteins in test cells.

In one aspect, the present disclosure includes an array comprising a plurality of nucleic acid probes each corresponding to a unique gene transcript and each immobilized on a solid support wherein the plurality comprises a unique probe for each gene encoding at least one rat cytochrome p450 enzyme, at least one rat nuclear xenobiotic receptor, at least one rat transferase, at least one rat uptake transporter and at least one rat efflux transporter. In an embodiment the at least one rat cytochrome p450 enzyme, at least one rat nuclear xenobiotic receptor, at least one rat transferase, at least one rat uptake transporter and at least one rat efflux transporter are those that are relevant to the ADME of prototypical inducer compounds. In a further embodiment, the at least one rat transferase is a sulfotransferase and a UDP glucuronosyltransferase. In another embodiment, the at least one uptake transporter is a solute ligand carrier (SLC) uptake transporter. In another embodiment, the efflux transporter is an ATP biding cassetter (ABC) efflux transporter.

In another aspect, the array comprises a unique probe for each of the following genes: rat CAR1 NR1I1, rat FXR NR1H4, rat LXR NR1H2, rat PPARA, rat PPARD, rat PPARG, rat PXR, rat RXRA, rat RXRB, rat RXRG, rat CYP1A2, rat CYP1B1, rat CYP2B2, rat CYP2C7, rat CYP2D22, rat CYP2E1, rat CYP3A1, rat CYP19A1, rat CYP27A1, rat ABCA1, rat ABCA2, rat ABCA5, rat ABCA7, rat ABCA17, rat ABCB1, rat ABCB1a, ABCB2, rat ABCB3, rat ABCB4, rat ABCB6, rat ABCB7, rat ABCB8, rat ABCB9, rat ABCB10, rat ABCB11, rat ABCC1, rat ABCC2, rat ABCC3, rat ABCC4, rat ABCC5, rat ABCC6, rat ABCC8, rat ABCC9, rat ABCC12, rat ABCD2, rat ABCD3, rat ABCF3, rat ABCG1, rat ABCG2, rat ABCG3, rat ABCG3a, rat ABCG3b, rat ABCG5, rat ABCG8, rat ACTb, rat B2M, rat GAPDH, rat RPLP0, rat VIL1, rat VIL2, rat SLC10A1, rat SLC10A2, rat SLC21A1, rat SLC21A2, rat SLC21A4, rat SLC21A5, rat SLC21A7, rat SLC21A9, rat SLC21A11, rat SLC21A12, rat SLC21A13, rat SLC21A14, rat SLC22A1, rat SLC22A2, rat SLC22A3, rat SLC22A4, rat SLC22A5, rat SLC22A6, rat SLC22A8, rat SLC22A9, rat SLC22A12, rat SLC22A17, rat SLC22A18, rat SLC28A1, rat SLC28A2, rat SLC28A3, rat SLC29A1, rat SLC29A2, rat SLC29A3, rat SULT1A1, rat SULT1B1, rat SULT1D1, rat SULT1E1, rat SULT2A2, rat SULT2B1, rat SULT4A1, rat UGT1A, rat UGT2A1, rat UGT2B, rat UGT2B17, rat UGT2B5, rat UGT2B36, rat UGT2B37 and rat UGT8.

In another aspect, the present disclosure includes an array comprising a plurality of nucleic acid probes each corresponding to a unique gene transcript and each immobilized on a solid support wherein the plurality comprises each of the sequences listed in SEQ ID NOs: 3, 6, 9, 12, 15, 18, 21, 24, 27, 30, 33, 36, 39, 42, 45, 48, 51, 54, 57, 60, 63, 66, 69, 72, 75, 78, 81, 84, 87, 90, 93, 96, 99, 102, 105, 108, 111, 114, 117, 120, 123, 126, 129, 132, 135, 138, 141, 144, 147, 150, 153, 156, 159, 162, 165, 168, 171, 174, 177, 180, 183, 186, 189, 192, 195, 198, 201, 204, 207, 210, 213, 216, 219, 222, 225, 228, 231, 234, 237, 240, 243, 246, 249, 252, 255, 258, 261, 264, 267, 270, 273, 276, 279, 282, 285, 288, 291, 294, 297, 300, 303, 306, 309 and 312, and wherein each probe in the plurality of nucleic acid probes consists of one of the sequences listed in SEQ ID NOs: 3, 6, 9, 12, 15, 18, 21, 24, 27, 30, 33, 36, 39, 42, 45, 48, 51, 54, 57, 60, 63, 66, 69, 72, 75, 78, 81, 84, 87, 90, 93, 96, 99, 102, 105, 108, 111, 114, 117, 120, 123, 126, 129, 132, 135, 138, 141, 144, 147, 150, 153, 156, 159, 162, 165, 168, 171, 174, 177, 180, 183, 186, 189, 192, 195, 198, 201, 204, 207, 210, 213, 216, 219, 222, 225, 228, 231, 234, 237, 240, 243, 246, 249, 252, 255, 258, 261, 264, 267, 270, 273, 276, 279, 282, 285, 288, 291, 294, 297, 300, 303, 306, 309 and 312.

In another embodiment, the probes on the array are double stranded and therefore also comprise the perfect complement of the sequences listed in SEQ ID NOs: 3, 6, 9, 12, 15, 18, 21, 24, 27, 30, 33, 36, 39, 42, 45, 48, 51, 54, 57, 60, 63, 66, 69, 72, 75, 78, 81, 84, 87, 90, 93, 96, 99, 102, 105, 108, 111, 114, 117, 120, 123, 126, 129, 132, 135, 138, 141, 144, 147, 150, 153, 156, 159, 162, 165, 168, 171, 174, 177, 180, 183, 186, 189, 192, 195, 198, 201, 204, 207, 210, 213, 216, 219, 222, 225, 228, 231, 234, 237, 240, 243, 246, 249, 252, 255, 258, 261, 264, 267, 270, 273, 276, 279, 282, 285, 288, 291, 294, 297, 300, 303, 306, 309 and 312.

In another aspect of the present disclosure, there is included an array comprising a plurality of nucleic acid probes immobilized on a solid support, wherein
(a) the plurality of nucleic acid probes corresponds to a multiplicity of gene transcripts;
(b) each nucleic acid probe is complementary to a distinct gene transcript; and
(c) each nucleic acid probe of the plurality is prepared by amplification of cDNA using a primer pair consisting of nucleic acid sequences selected from:
SEQ ID NO:1 and SEQ ID NO:2;
SEQ ID NO:4 and SEQ ID NO:5;
SEQ ID NO:7 and SEQ ID NO:8;
SEQ ID NO:10 and SEQ ID NO:11;
SEQ ID NO:13 and SEQ ID NO:14;
SEQ ID NO:16 and SEQ ID NO:17;
SEQ ID NO:19 and SEQ ID NO:20;
SEQ ID NO:22 and SEQ ID NO:23;
SEQ ID NO:25 and SEQ ID NO:26;
SEQ ID NO:28 and SEQ ID NO:29;
SEQ ID NO:31 and SEQ ID NO:32;
SEQ ID NO:34 and SEQ ID NO:35;
SEQ ID NO:37 and SEQ ID NO:38;
SEQ ID NO:40 and SEQ ID NO:41;
SEQ ID NO:43 and SEQ ID NO:44;
SEQ ID NO:46 and SEQ ID NO:47;
SEQ ID NO:49 and SEQ ID NO:50;
SEQ ID NO:52 and SEQ ID NO:53;
SEQ ID NO:55 and SEQ ID NO:56;
SEQ ID NO:58 and SEQ ID NO:59;
SEQ ID NO:61 and SEQ ID NO:62;
SEQ ID NO:64 and SEQ ID NO:65;
SEQ ID NO:67 and SEQ ID NO:68;
SEQ ID NO:70 and SEQ ID NO:71;
SEQ ID NO:73 and SEQ ID NO:74;
SEQ ID NO:76 and SEQ ID NO:77;
SEQ ID NO:79 and SEQ ID NO:80;
SEQ ID NO:82 and SEQ ID NO:83;
SEQ ID NO:85 and SEQ ID NO:86;
SEQ ID NO:88 and SEQ ID NO:89;
SEQ ID NO:91 and SEQ ID NO:92;
SEQ ID NO:94 and SEQ ID NO:95;
SEQ ID NO:97 and SEQ ID NO:98;
SEQ ID NO:100 and SEQ ID NO:101;
SEQ ID NO:103 and SEQ ID NO:104;
SEQ ID NO:106 and SEQ ID NO:107;
SEQ ID NO:109 and SEQ ID NO:110;
SEQ ID NO:112 and SEQ ID NO:113;
SEQ ID NO:115 and SEQ ID NO:116;
SEQ ID NO:118 and SEQ ID NO:119;
SEQ ID NO:121 and SEQ ID NO:122;
SEQ ID NO:124 and SEQ ID NO:125;
SEQ ID NO:127 and SEQ ID NO:128;
SEQ ID NO:130 and SEQ ID NO:131;
SEQ ID NO:133 and SEQ ID NO:134;
SEQ ID NO:136 and SEQ ID NO:137;
SEQ ID NO:139 and SEQ ID NO:140;
SEQ ID NO:142 and SEQ ID NO:143;
SEQ ID NO:145 and SEQ ID NO:146;
SEQ ID NO:148 and SEQ ID NO:149;
SEQ ID NO:151 and SEQ ID NO:152;
SEQ ID NO:154 and SEQ ID NO:155;
SEQ ID NO:157 and SEQ ID NO:158;
SEQ ID NO:160 and SEQ ID NO:161;
SEQ ID NO:163 and SEQ ID NO:164;
SEQ ID NO:166 and SEQ ID NO:167;
SEQ ID NO:169 and SEQ ID NO:170;
SEQ ID NO:172 and SEQ ID NO:173;
SEQ ID NO:175 and SEQ ID NO:176;
SEQ ID NO:178 and SEQ ID NO:179;
SEQ ID NO:181 and SEQ ID NO:182;
SEQ ID NO:184 and SEQ ID NO:185;
SEQ ID NO:187 and SEQ ID NO:188;
SEQ ID NO:190 and SEQ ID NO:191;
SEQ ID NO:193 and SEQ ID NO:194;
SEQ ID NO:196 and SEQ ID NO:197;
SEQ ID NO:199 and SEQ ID NO:200;
SEQ ID NO:202 and SEQ ID NO:203;
SEQ ID NO:205 and SEQ ID NO:206;
SEQ ID NO:208 and SEQ ID NO:209;
SEQ ID NO:211 and SEQ ID NO:212;
SEQ ID NO:214 and SEQ ID NO:215;
SEQ ID NO:217 and SEQ ID NO:218;
SEQ ID NO:220 and SEQ ID NO:221;
SEQ ID NO:223 and SEQ ID NO:224;
SEQ ID NO:226 and SEQ ID NO:227;
SEQ ID NO:229 and SEQ ID NO:230;
SEQ ID NO:232 and SEQ ID NO:233;
SEQ ID NO:235 and SEQ ID NO:236;
SEQ ID NO:238 and SEQ ID NO:239;
SEQ ID NO:241 and SEQ ID NO:242;
SEQ ID NO:244 and SEQ ID NO:245;
SEQ ID NO:247 and SEQ ID NO:248;
SEQ ID NO:250 and SEQ ID NO:251;
SEQ ID NO:253 and SEQ ID NO:254;
SEQ ID NO:256 and SEQ ID NO:257;
SEQ ID NO:259 and SEQ ID NO:260;
SEQ ID NO:262 and SEQ ID NO:263;
SEQ ID NO:265 and SEQ ID NO:266;
SEQ ID NO:268 and SEQ ID NO:269;
SEQ ID NO:271 and SEQ ID NO:272;
SEQ ID NO:274 and SEQ ID NO:275;
SEQ ID NO:277 and SEQ ID NO:278;
SEQ ID NO:280 and SEQ ID NO:281;
SEQ ID NO:283 and SEQ ID NO:284;
SEQ ID NO:286 and SEQ ID NO:287;
SEQ ID NO:289 and SEQ ID NO:290;
SEQ ID NO:292 and SEQ ID NO:293;
SEQ ID NO:295 and SEQ ID NO:296;
SEQ ID NO:298 and SEQ ID NO:299;
SEQ ID NO:301 and SEQ ID NO:302;
SEQ ID NO:304 and SEQ ID NO:305;
SEQ ID NO:307 and SEQ ID NO:308; and
SEQ ID NO:310 and SEQ ID NO:311.

A further aspect of the disclosure is an isolated nucleic acid molecule having a nucleic acid sequence consisting of:
(a) a nucleic acid sequence of SEQ ID NOs: 3, 6, 9, 12, 15, 18, 21, 24, 27, 30, 33, 36, 39, 42, 45, 48, 51, 54, 57, 60, 63, 66, 69, 72, 75, 78, 81, 84, 87, 90, 93, 96, 99, 102, 105, 108, 111, 114, 117, 120, 123, 126, 129, 132, 135, 138, 141, 144, 147, 150, 153, 156, 159, 162, 165, 168, 171, 174, 177, 180, 183, 186, 189, 192, 195, 198, 201, 204, 207, 210, 213, 216, 219, 222, 225, 228, 231, 234, 237, 240, 243, 246, 249, 252, 255, 258, 261, 264, 267, 270, 273, 276, 279, 282, 285, 288, 291, 294, 297, 300, 303, 306, 309 or 312; and/or
(b) a nucleic acid sequence complementary to (a).

These isolated nucleic acid molecules can be used in assays, such as arrays, to detect the coordinated expression of genes encoding cytochrome p450 enzymes, nuclear xenobiotic receptors, transferases, uptake transporters and efflux transporters. The array can be used to determine a change in the gene expression profile of test cells in response to a compound or drug or a combination of compounds or drugs. In addition, the array can be used to detect the presence of drug-drug interactions test cells.

In a further embodiment, the disclosure includes a method of gene expression analysis comprising:
(a) contacting one or more pools of nucleic acids under hybridization conditions with an array of the present disclosure; and
(b) detecting hybridization of the one or more pools of nucleic acids with the plurality of nucleic acid probes,
wherein the presence of hybridization indicates gene expression.

In an embodiment of the disclosure the method of analysis is used to detect the coordinated expression of genes encoding cytochrome p450 enzymes, nuclear xenobiotic receptors, transferases, uptake transporters and efflux transporters. In this embodiment, if hybridization is present, this is indicative of expression of the hybridized genes and this information is used to prepare a gene expression profile.

In a further embodiment, the method of analysis is used to perform drug-associated gene expression profiling of genes encoding cytochrome p450 enzymes, nuclear xenobiotic receptors, transferases, uptake transporters and efflux transporters. Such profiling can be used to identify potential modulators of gene expression. In this embodiment, if hybridization is present, this is indicative of drug-induced expression of the hybridized genes or drug-inhibited expression of the hybridized genes.

The array and methods disclosed herein can also be used to predict the potential for drug-drug interactions. Accordingly, in another aspect, the method of analysis is used for determining if two drugs modulate the expression of at least one of the same genes encoding cytochrome p450 enzymes, nuclear xenobiotic receptors, transferases, uptake transporters and efflux transporters. If the two drugs have in common modulation of the expression of at least one of these genes, then there is a potential for drug-drug interactions between the two drugs if they are contemporaneously administered to the subject.

The drug screening methods of the disclosure can be used to generate information useful when designing drug or chemical therapy for the treatment of disease.

Other features and advantages of the present disclosure will become apparent from the following detailed description. It should be understood, however, that the detailed description and the specific examples while indicating preferred embodiments of the disclosure are given by way of illustration only, since various changes and modifications within the spirit and scope of the disclosure will become apparent to those skilled in the art from this detailed description.

### BRIEF DESCRIPTION OF THE DRAWINGS

The disclosure will now be described in relation to the drawings in which:

FIG. 1 shows the upper and lower primer sequences used to amplify a portion of rat CAR1 NR111 (SEQ ID NOS:1-2, bolded) and the single stranded version of the PCR product obtained using the primers (SEQ ID NO:3).

FIG. 2 shows the upper and lower primer sequences (SEQ ID NOS:4-5, bolded) used to amplify a portion of rat FXR NR1H4 and the single stranded version of the PCR product obtained using the primers (SEQ ID NO:6).

FIG. 3 shows the upper and lower primer sequences (SEQ ID NOS:7-8, bolded) used to amplify a portion of rat LXR NR1H2 and the single stranded version of the PCR product obtained using the primers (SEQ ID NO:9).

FIG. 4 shows the upper and lower primer sequences (SEQ ID NOS:10-11, bolded) used to amplify a portion of rat PPARA and the single stranded version of the PCR product obtained using the primers (SEQ ID NO:12).

FIG. 5 shows the upper and lower primer sequences (SEQ ID NOS:13-14, bolded) used to amplify a portion of rat PPARD and the single stranded version of the PCR product obtained using the primers (SEQ ID NO:15).

FIG. 6 shows the upper and lower primer sequences (SEQ ID NOS:16-17, bolded) used to amplify a portion of rat PPARG and the single stranded version of the PCR product obtained using the primers (SEQ ID NO:18).

FIG. 7 shows the upper and lower primer sequences (SEQ ID NOS:19-20, bolded) used to amplify a portion of rat PXR and the single stranded version of the PCR product obtained using the primers (SEQ ID NO:21).

FIG. 8 shows the upper and lower primer sequences (SEQ ID NOS:22-23, bolded) used to amplify a portion of rat RXRA and the single stranded version of the PCR product obtained using the primers (SEQ ID NO:24).

FIG. 9 shows the upper and lower primer sequences (SEQ ID NOS:25-26, bolded) used to amplify a portion of rat RXRB and the single stranded version of the PCR product obtained using the primers (SEQ ID NO:27).

FIG. 10 shows the upper and lower primer sequences (SEQ ID NOS:28-29, bolded) used to amplify a portion of rat RXRG and the single stranded version of the PCR product obtained using the primers (SEQ ID NO:30).

FIG. 11 shows the upper and lower primer sequences (SEQ ID NOS:31-32, bolded) used to amplify a portion of rat CYP1A2 and the single stranded version of the PCR product obtained using the primers (SEQ ID NO:33).

FIG. 12 shows the upper and lower primer sequences (SEQ ID NOS:34-35, bolded) used to amplify a portion of rat CYP1B1 and the single stranded version of the PCR product obtained using the primers (SEQ ID NO:36).

FIG. 13 shows the upper and lower primer sequences (SEQ ID NOS:37-38, bolded) used to amplify a portion of rat CYP2B2 and the single stranded version of the PCR product obtained using the primers (SEQ ID NO:39).

FIG. 14 shows the upper and lower primer sequences (SEQ ID NOS:40-41, bolded) used to amplify a portion of rat CYP2C7 and the single stranded version of the PCR product obtained using the primers (SEQ ID NO:42).

FIG. 15 shows the upper and lower primer sequences (SEQ ID NOS:43-44, bolded) used to amplify a portion of rat CYP2D22 and the single stranded version of the PCR product obtained using the primers (SEQ ID NO:45).

FIG. 16 shows the upper and lower primer sequences (SEQ ID NOS:46-47, bolded) used to amplify a portion of rat CYP2E1 and the single stranded version of the PCR product obtained using the primers (SEQ ID NO:48).

FIG. 17 shows the upper and lower primer sequences (SEQ ID NOS:49-50, bolded) used to amplify a portion of rat CYP3A1 and the single stranded version of the PCR product obtained using the primers (SEQ ID NO:51).

FIG. 18 shows the upper and lower primer sequences (SEQ ID NOS:52-53, bolded) used to amplify a portion of rat CYP19A1 and the single stranded version of the PCR product obtained using the primers (SEQ ID NO:54).

FIG. 19 shows the upper and lower primer sequences (SEQ ID NOS:55-56, bolded) used to amplify a portion of rat CYP27A1 and the single stranded version of the PCR product obtained using the primers (SEQ ID NO:57).

FIG. 20 shows the upper and lower primer sequences (SEQ ID NOS:58-59, bolded) to amplify a portion of rat ABCA1 and the single stranded version of the PCR product obtained using the primers (SEQ ID NO:60).

FIG. 21 shows the upper and lower primer sequences (SEQ ID NOS:61-62, bolded) used to amplify a portion of rat ABCA2 and the single stranded version of the PCR product obtained using the primers (SEQ ID NO:63).

FIG. 22 shows the upper and lower primer sequences (SEQ ID NOS:64-65, bolded) used to amplify a portion of rat ABCA5 and the single stranded version of the PCR product obtained using the primers (SEQ ID NO:66).

FIG. 23 shows the upper and lower primer sequences (SEQ ID NOS:67-68, bolded) used to amplify a portion of rat ABCA7 and the single stranded version of the PCR product obtained using the primers (SEQ ID NO:69).

FIG. 24 shows the upper and lower primer sequences (SEQ ID NOS:70-71, bolded) used to amplify a portion of rat ABCA17 and the single stranded version of the PCR product obtained using the primers (SEQ ID NO:72).

FIG. 25 shows the upper and lower primer sequences (SEQ ID NOS:73-74, bolded) used to amplify a portion of rat ABCB1 and the single stranded version of the PCR product obtained using the primers (SEQ ID NO:75).

FIG. 26 shows the upper and lower primer sequences (SEQ ID NOS:76-77, bolded) used to amplify a portion of rat ABCB1a and the single stranded version of the PCR product obtained using the primers (SEQ ID NO:78).

FIG. 27 shows the upper and lower primer sequences (SEQ ID NOS:79-80, bolded) used to amplify a portion of rat ABCB2 and the single stranded version of the PCR product obtained using the primers (SEQ ID NO:81).

FIG. 28 shows the upper and lower primer sequences (SEQ ID NOS:82-83, bolded) used to amplify a portion of rat ABCB3 and the single stranded version of the PCR product obtained using the primers (SEQ ID NO:84).

FIG. 29 shows the upper and lower primer sequences (SEQ ID NOS:85-86, bolded) used to amplify a portion of rat ABCB4 and the single stranded version of the PCR product obtained using the primers (SEQ ID NO:87).

FIG. 30 shows the upper and lower primer sequences (SEQ ID NOS:88-89, bolded) used to amplify a portion of rat ABCB6 and the single stranded version of the PCR product obtained using the primers (SEQ ID NO:90).

FIG. 31 shows the upper and lower primer sequences (SEQ ID NOS:91-92, bolded) used to amplify a portion of rat ABCB7 and the single stranded version of the PCR product obtained using the primers (SEQ ID NO:93).

FIG. 32 shows the upper and lower primer sequences (SEQ ID NOS:94-95, bolded) used to amplify a portion of rat ABCB8 and the single stranded version of the PCR product obtained using the primers (SEQ ID NO:96).

FIG. 33 shows the upper and lower primer sequences (SEQ ID NOS:97-98, bolded) used to amplify a portion of rat ABCB9 and the single stranded version of the PCR product obtained using the primers (SEQ ID NO:99).

FIG. 34 shows the upper and lower primer sequences (SEQ ID NOS:100-101, bolded) used to amplify a portion of rat ABCB10 and the single stranded version of the PCR product obtained using the primers (SEQ ID NO:102).

FIG. 35 shows the upper and lower primer sequences (SEQ ID NOS:103-104, bolded) used to amplify a portion of rat ABCB11 and the single stranded version of the PCR product obtained using the primers (SEQ ID NO:105).

FIG. 36 shows the upper and lower primer sequences (SEQ ID NOS:106-107, bolded) used to amplify a portion of rat ABCC1 and the single stranded version of the PCR product obtained using the primers (SEQ ID NO:108).

FIG. 37 shows the upper and lower primer sequences (SEQ ID NOS:109-110, bolded) used to amplify a portion of rat ABCC2 and the single stranded version of the PCR product obtained using the primers (SEQ ID NO:111).

FIG. 38 shows the upper and lower primer sequences (SEQ ID NOS:112-113, bolded) used to amplify a portion of rat ABCC3 and the single stranded version of the PCR product obtained using the primers (SEQ ID NO:114).

FIG. 39 shows the upper and lower primer sequences (SEQ ID NOS:115-116, bolded) used to amplify a portion of rat ABCC4 and the single stranded version of the PCR product obtained using the primers (SEQ ID NO:117).

FIG. 40 shows the upper and lower primer sequences (SEQ ID NOS:118-119, bolded) used to amplify a portion of rat ABCC5 and the single stranded version of the PCR product obtained using the primers (SEQ ID NO:120).

FIG. 41 shows the upper and lower primer sequences (SEQ ID NOS:121-122, bolded) used to amplify a portion of rat ABCC6 and the single stranded version of the PCR product obtained using the primers (SEQ ID NO:123).

FIG. 42 shows the upper and lower primer sequences (SEQ ID NOS:124-125, bolded) used to amplify a portion of rat ABCC8 and the single stranded version of the PCR product obtained using the primers (SEQ ID NO:126).

FIG. 43 shows the upper and lower primer sequences (SEQ ID NOS:127-128, bolded) used to amplify a portion of rat ABCC9 and the single stranded version of the PCR product obtained using the primers (SEQ ID NO:129).

FIG. 44 shows the upper and lower primer sequences (SEQ ID NOS:130-131, bolded used to amplify a portion of rat ABCC12 and the single stranded version of the PCR product obtained using the primers (SEQ ID NO:132).

FIG. 45 shows the upper and lower primer sequences (SEQ ID NOS:133-134, bolded) used to amplify a portion of rat ABCD2 and the single stranded version of the PCR product obtained using the primers (SEQ ID NO:135).

FIG. 46 shows the upper and lower primer sequences (SEQ ID NOS:136-137, bolded) used to amplify a portion of rat ABCD3 and the single stranded version of the PCR product obtained using the primers (SEQ ID NO:138).

FIG. 47 shows the upper and lower primer sequences (SEQ ID NOS:139-140, bolded) used to amplify a portion of rat ABCF3 and the single stranded version of the PCR product obtained using the primers (SEQ ID NO:141).

FIG. 48 shows the upper and lower primer sequences (SEQ ID NOS:142-143, bolded) used to amplify a portion of rat ABCG1 and the single stranded version of the PCR product obtained using the primers (SEQ ID NO:144).

FIG. 49 shows the upper and lower primer sequences (SEQ ID NOS:145-146, bolded) used to amplify a portion of rat ABCG2 and the single stranded version of the PCR product obtained using the primers (SEQ ID NO:147).

FIG. 50 shows the upper and lower primer sequences (SEQ ID NOS:148-149, bolded) used to amplify a portion of rat ABCG3 and the single stranded version of the PCR product obtained using the primers (SEQ ID NO:150).

FIG. 51 shows the upper and lower primer sequences (SEQ ID NOS:151-152, bolded) used to amplify a portion of rat ABCG3a and the single stranded version of the PCR product obtained using the primers (SEQ ID NO:153).

FIG. 52 shows the upper and lower primer sequences (SEQ ID NOS:154-155, bolded) used to amplify a portion of rat ABCG3b and the single stranded version of the PCR product obtained using the primers (SEQ ID NO:156).

FIG. 53 shows the upper and lower primer sequences (SEQ ID NOS:157-158, bolded) used to amplify a portion of rat ABCG5 and the single stranded version of the PCR product obtained using the primers (SEQ ID NO:159).

FIG. 54 shows the upper and lower primer sequences (SEQ ID NOS:160-161, bolded) used to amplify a portion of rat ABCG8 and the single stranded version of the PCR product obtained using the primers (SEQ ID NO:162).

FIG. 55 shows the upper and lower primer sequences (SEQ ID NOS:163-164, bolded) used to amplify a portion of rat ACTb and the single stranded version of the PCR product obtained using the primers (SEQ ID NO:165).

FIG. 56 shows the upper and lower primer sequences (SEQ ID NOS:166-167, bolded) used to amplify a portion of rat B2M and the single stranded version of the PCR product obtained using the primers (SEQ ID NO:168).

FIG. 57 shows the upper and lower primer sequences (SEQ ID NOS:169-170, bolded) used to amplify a portion of rat GAPDH and the single stranded version of the PCR product obtained using the primers (SEQ ID NO:171).

FIG. 58 shows the upper and lower primer sequences (SEQ ID NOS:172-173, bolded) used to amplify a portion of rat RPLP0 and the single stranded version of the PCR product obtained using the primers (SEQ ID NO:174).

FIG. 59 shows the upper and lower primer sequences (SEQ ID NOS:175-176, bolded) used to amplify a portion of rat VIL1 and the single stranded version of the PCR product obtained using the primers (SEQ ID NO:177).

FIG. 60 shows the upper and lower primer sequences (SEQ ID NOS:178-179, bolded) used to amplify a portion of rat VIL2 and the single stranded version of the PCR product obtained using the primers (SEQ ID NO:180).

FIG. 61 shows the upper and lower primer sequences (SEQ ID NOS:181-182, bolded) used to amplify a portion of rat SLC10A1 and the single stranded version of the PCR product obtained using the primers (SEQ ID NO:183).

FIG. 62 shows the upper and lower primer sequences (SEQ ID NOS:184-185, bolded) used to amplify a portion of rat SLC10A2 and the single stranded version of the PCR product obtained using the primers (SEQ ID NO:186).

FIG. 63 shows the upper and lower primer sequences (SEQ ID NOS:187-188, bolded) used to amplify a portion of rat SLC21A1 and the single stranded version of the PCR product obtained using the primers (SEQ ID NO:189).

FIG. 64 shows the upper and lower primer sequences (SEQ ID NOS:190-191, bolded) used to amplify a portion of rat SLC21A2 and the single stranded version of the PCR product obtained using the primers (SEQ ID NO:192).

FIG. 65 shows the upper and lower primer sequences (SEQ ID NOS:193-194, bolded) used to amplify a portion of rat SLC21A4 and the single stranded version of the PCR product obtained using the primers (SEQ ID NO:195).

FIG. 66 shows the upper and lower primer sequences (SEQ ID NOS:196-197, bolded) used to amplify a portion of rat SLC21A5 and the single stranded version of the PCR product obtained using the primers (SEQ ID NO:198).

FIG. 67 shows the upper and lower primer sequences (SEQ ID NOS:199-200, bolded) used to amplify a portion of rat SLC21A7 and the single stranded version of the PCR product obtained using the primers (SEQ ID NO:201).

FIG. 68 shows the upper and lower primer sequences (SEQ ID NOS:202-203, bolded) used to amplify a portion of rat SLC21A9 and the single stranded version of the PCR product obtained using the primers (SEQ ID NO:204).

FIG. 69 shows the upper and lower primer sequences (SEQ ID NOS:205-206, bolded) used to amplify a portion of rat SLC21A11 and the single stranded version of the PCR product obtained using the primers (SEQ ID NO:207).

FIG. 70 shows the upper and lower primer sequences (SEQ ID NOS:208-209, bolded) used to amplify a portion of rat SLC21A12 and the single stranded version of the PCR product obtained using the primers (SEQ ID NO:210).

FIG. 71 shows the upper and lower primer sequences (SEQ ID NOS:211-212, bolded) used to amplify a portion of rat SLC21A13 and the single stranded version of the PCR product obtained using the primers (SEQ ID NO:213).

FIG. 72 shows the upper and lower primer sequences (SEQ ID NOS:214-215, bolded) used to amplify a portion of rat SLC21A14 and the single stranded version of the PCR product obtained using the primers (SEQ ID NO:216).

FIG. 73 shows the upper and lower primer sequences (SEQ ID NOS:217-218, bolded) used to amplify a portion of rat SLC22A1 and the single stranded version of the PCR product obtained using the primers (SEQ ID NO:219).

FIG. 74 shows the upper and lower primer sequences (SEQ ID NOS:220-221, bolded) used to amplify a portion of rat SLC22A2 and the single stranded version of the PCR product obtained using the primers (SEQ ID NO:222).

FIG. 75 shows the upper and lower primer sequences (SEQ ID NOS:223-224, bolded) used to amplify a portion of rat SLC22A3 and the single stranded version of the PCR product obtained using the primers (SEQ ID NO:225).

FIG. 76 shows the upper and lower primer sequences (SEQ ID NOS:226-227, bolded) used to amplify a portion of rat SLC22A4 and the single stranded version of the PCR product obtained using the primers (SEQ ID NO:228).

FIG. 77 shows the upper and lower primer sequences (SEQ ID NOS:229-230, bolded) used to amplify a portion of rat SLC22A5 and the single stranded version of the PCR product obtained using the primers (SEQ ID NO:231).

FIG. 78 shows the upper and lower primer sequences (SEQ ID NOS:232-233, bolded) used to amplify a portion of rat SLC22A6 and the single stranded version of the PCR product obtained using the primers (SEQ ID NO:234).

FIG. 79 shows the upper and lower primer sequences (SEQ ID NOS:235-236, bolded) used to amplify a portion of rat SLC22A8 and the single stranded version of the PCR product obtained using the primers (SEQ ID NO:237).

FIG. 80 shows the upper and lower primer sequences (SEQ ID NOS:238-239, bolded) used to amplify a portion of rat SLC22A9 and the single stranded version of the PCR product obtained using the primers (SEQ ID NO:240).

FIG. 81 shows the upper and lower primer sequences (SEQ ID NOS:241-242, bolded) used to amplify a portion of rat SLC22A12 and the single stranded version of the PCR product obtained using the primers (SEQ ID NO:243).

FIG. 82 shows the upper and lower primer sequences (SEQ ID NOS:244-245, bolded) used to amplify a portion of rat SLC22A17 and the single stranded version of the PCR product obtained using the primers (SEQ ID NO:246).

FIG. 83 shows the upper and lower primer sequences (SEQ ID NOS:247-248, bolded) used to amplify a portion of rat SLC22A18 and the single stranded version of the PCR product obtained using the primers (SEQ ID NO:249).

FIG. 84 shows the upper and lower primer sequences (SEQ ID NOS:250-251, bolded) used to amplify a portion of rat SLC28A1 and the single stranded version of the PCR product obtained using the primers (SEQ ID NO:252).

FIG. 85 shows the upper and lower primer sequences (SEQ ID NOS:253-254, bolded) used to amplify a portion of rat SLC28A2 and the single stranded version of the PCR product obtained using the primers (SEQ ID NO:255).

FIG. 86 shows the upper and lower primer sequences (SEQ ID NOS:256-257, bolded) used to amplify a portion of rat SLC28A3 and the single stranded version of the PCR product obtained using the primers (SEQ ID NO:258).

FIG. 87 shows the upper and lower primer sequences (SEQ ID NOS:259-260, bolded) used to amplify a portion of rat SLC29A1 and the single stranded version of the PCR product obtained using the primers (SEQ ID NO:261).

FIG. 88 shows the upper and lower primer sequences (SEQ ID NOS:262-263, bolded) used to amplify a portion of rat SLC29A2 and the single stranded version of the PCR product obtained using the primers (SEQ ID NO:264).

FIG. 89 shows the upper and lower primer sequences (SEQ ID NOS:265-266, bolded) used to amplify a portion of rat SLC29A3 and the single stranded version of the PCR product obtained using the primers (SEQ ID NO:267).

FIG. 90 shows the upper and lower primer sequences (SEQ ID NOS:268-269, bolded) used to amplify a portion of rat SULT1A1 and the single stranded version of the PCR product obtained using the primers (SEQ ID NO:270).

FIG. 91 shows the upper and lower primer sequences (SEQ ID NOS:271-272, bolded) used to amplify a portion of rat SULT1B1 and the single stranded version of the PCR product obtained using the primers (SEQ ID NO:273).

FIG. 92 shows the upper and lower primer sequences (SEQ ID NOS:274-275, bolded) used to amplify a portion of rat SULT1D1 and the single stranded version of the PCR product obtained using the primers (SEQ ID NO:276).

FIG. 93 shows the upper and lower primer sequences (SEQ ID NOS:277-278, bolded) used to amplify a portion of rat SULT1E1 and the single stranded version of the PCR product obtained using the primers (SEQ ID NO:279).

FIG. 94 shows the upper and lower primer sequences (SEQ ID NOS:280-281, bolded) used to amplify a portion of rat SULT2A2 and the single stranded version of the PCR product obtained using the primers (SEQ ID NO:282).

FIG. 95 shows the upper and lower primer sequences (SEQ ID NOS:283-284, bolded) used to amplify a portion of rat SULT2B1 and the single stranded version of the PCR product obtained using the primers (SEQ ID NO:285).

FIG. 96 shows the upper and lower primer sequences (SEQ ID NOS:286-287, bolded) used to amplify a portion of rat SULT4A1 and the single stranded version of the PCR product obtained using the primers (SEQ ID NO:288).

FIG. 97 shows the upper and lower primer sequences (SEQ ID NOS:289-290, bolded) used to amplify a portion of rat UGT1A and the single stranded version of the PCR product obtained using the primers (SEQ ID NO:291).

FIG. 98 shows the upper and lower primer sequences (SEQ ID NOS:292-293, bolded) used to amplify a portion of rat UGT2A1 and the single stranded version of the PCR product obtained using the primers (SEQ ID NO:294).

FIG. 99 shows the upper and lower primer sequences (SEQ ID NOS:295-296, bolded) used to amplify a portion of rat UGT2B and the single stranded version of the PCR product obtained using the primers (SEQ ID NO:297).

FIG. 100 shows the upper and lower primer sequences (SEQ ID NOS:298-299, bolded) used to amplify a portion of rat UGT2B17 and the single stranded version of the PCR product obtained using the primers (SEQ ID NO:300).

FIG. 101 shows the upper and lower primer sequences (SEQ ID NOS:301-302, bolded) used to amplify a portion of rat UGT2B5 and the single stranded version of the PCR product obtained using the primers (SEQ ID NO:303).

FIG. 102 shows the upper and lower primer sequences (SEQ ID NOS:304-305, bolded) used to amplify a portion of rat UGT2B36 and the single stranded version of the PCR product obtained using the primers (SEQ ID NO:306).

FIG. 103 shows the upper and lower primer sequences (SEQ ID NOS:307-308, bolded) used to amplify a portion of rat UGT2B37 and the single stranded version of the PCR product obtained using the primers (SEQ ID NO:309).

FIG. 104 shows the upper and lower primer sequences (SEQ ID NOS:310-311, bolded) used to amplify a portion of rat UGT8 and the single stranded version of the PCR product obtained using the primers (SEQ ID NO:312).

FIG. 105 shows the rat CYP, NXR, ABC Transporter gene RT-PCR amplification products from various rat tissue total RNA (brain, kidney, liver, lung) samples as analysed by electrophoresis at 150V for 20 min in 1×TAE running buffer in an agarose gel.

FIG. 106 shows the normalized fluorescence intensity dendrogram plot for CYP and NXR Transporter gene expression in normal rat brain, kidney, liver and lung tissue

FIG. 107 shows the normalized fluorescence intensity dendrogram plot for ABC Transporter gene expression in normal rat brain, kidney, liver and lung tissue

FIG. 108 shows the normalized fluorescence intensity dendrogram plot for CYP, NXR and ABC Transporter gene expression in the rat hepatoma cell line CRL-1600 treated with either dexamethasone (DEX) or pregnanolone-16-alpha-carbonitrile (PCN).

FIG. 109 shows the normalized fluorescence intensity dendrogram plot for CYP, NXR and ABC Transporter gene expression in the female rat primary hepatocytes treated with either dexamethasone (DEX) or pregnanolone-16-alpha-carbonitrile (PCN). FIG. 109 also shows a pattern of gene expression consistent with potential drug-drug interaction between DEX and PCN since both drugs induce CYP3A1 gene expression and suppress ABCD2 gene expression. ABCC3 is also affected by both drugs—PCN suppresses gene expression whereas DEX induces gene expression.

FIG. 110 shows the normalized fluorescence intensity dendrogram plot for CYP, NXR, SLC Transporter and ABC Transporter gene expression in the male rat primary hepatocytes treated with dexamethasone (DEX).

### DETAILED DESCRIPTION OF THE DISCLOSURE

The present disclosure provides materials and methods for detecting the gene expression of and generating a drug-associated gene expression profile for rat cytochrome p450 enzymes [CYPs], nuclear xenobiotic receptors [NXRs], sulfotransferases [SULTs], UDP glucuronosyltransferases [UGTs], Solute Ligand Carrier (uptake) transporters [SLCs] and ATP Binding Cassette (efflux) transporters [ABCs]

### (I) ABBREVIATIONS

The following abbreviations are used throughout the specification:

A: adenine;
C: cytosine;
G: guanine;
T: thymine;
U: uracil.
CAR1 NR1I1: constitutive androstane receptor, nuclear receptor sub-family 1, group H, member 1;
FXRNR1H4: farnesoid X receptor, nuclear receptor sub-family 1, group H, member 4;
LXR NR1H2: liver X receptor, nuclear receptor sub-family 1, group H, member 2;
PPARA: peroxisome proliferator activated receptor alpha;
PPARD: peroxisome proliferator activated receptor delta;
PPARG: peroxisome proliferator activated receptor gamma;
PXR: pregnane X receptor
RXRA: retinoid X receptor Alpha;
RXRB: retinoid X receptor Beta;
RXRG: retinoid X receptor Gamma;
CYP1A2: cytochrome P450, family 1, sub-family A, polypeptide 2;
CYP1B1: cytochrome P450, family 1, sub-family B, polypeptide 1;
CYP2B2: cytochrome P450, family 2, sub-family B, polypeptide 2;
CYP2C7: cytochrome P450, family 2, sub-family C, polypeptide 7;
CYP2D22: cytochrome P450, family 2, sub-family D, polypeptide 22;
CYP2E1: cytochrome P450, family 2, sub-family E, polypeptide 1;
CYP3A1: cytochrome P450, family 3, sub-family A, polypeptide 1;
CYP19A1: cytochrome P450, family 19, sub-family A, polypeptide 1;
CYP27A1: cytochrome P450, family 27, sub-family A, polypeptide 1;
ABCA1: ATP binding cassette, sub-family A, member 1;
ABCA2: ATP binding cassette, sub-family A, member 1;
ABCA5: ATP binding cassette, sub-family A, member 5;
ABCA7: ATP binding cassette, sub-family A, member 7;
ABCA17: ATP binding cassette, sub-family A, member 17;
ABCB1: ATP binding cassette, sub-family B, member 1;
ABCB1a: ATP binding cassette, sub-family B, member 1;
ABCB2: ATP binding cassette, sub-family B, member 2;
ABCB3: ATP binding cassette, sub-family B, member 3;
ABCB4: ATP binding cassette, sub-family B, member 4;
ABCB6: ATP binding cassette, sub-family B, member 6;
ABCB7: ATP binding cassette, sub-family B, member 7;
ABCB8: ATP binding cassette, sub-family B, member 8;
ABCB9: ATP binding cassette, sub-family B, member 9;
ABCB10: ATP binding cassette, sub-family B, member 10
ABCB11: ATP binding cassette, sub-family B, member 11;
ABCC1: ATP binding cassette, sub-family C, member 1;
ABCC2: ATP binding cassette, sub-family C, member 2;
ABCC3: ATP binding cassette, sub-family C, member 3;
ABCC4: ATP binding cassette, sub-family C, member 4;
ABCC5: ATP binding cassette, sub-family C, member 5;
ABCC6: ATP binding cassette, sub-family C, member 6;
ABCC8: ATP binding cassette, sub-family C, member 8;
ABCC9: ATP binding cassette, sub-family C, member 9;
ABCC12: ATP binding cassette, sub-family C, member 12;
ABCD2: ATP binding cassette, sub-family D, member 2;
ABCD3: ATP binding cassette, sub-family D, member 3;
ABCF3: ATP binding cassette, sub-family F, member 3;
ABCG1: ATP binding cassette, sub-family G, member 1;
ABCG2: ATP binding cassette, sub-family G, member 2;
ABCG3: ATP binding cassette, sub-family G, member 3;
ABCG3a: ATP binding cassette, sub-family G, member 3A;
ABCG3b: ATP binding cassette, sub-family G, member 3B;
ABCG5: ATP binding cassette, sub-family G, member 5;
ABCG8: ATP binding cassette, sub-family G, member 8;
ACTb: beta-actin;
B2M: beta-2-microglobulin;
GAPDH: glyceraldehyde-3-phosphate dehydrogenase;
RPLP0: acidic ribosomal phosphoprotein P0;
VIL1: villin 1;
VIL2: villin 2;
SLC10A1: Solute ligand carrier family 10, sub-family A, member 1;
SLC10A2: Solute ligand carrier family 10, sub-family A, member 2;
SLC21A1: Solute ligand carrier family 21, sub-family A, member 1;
SLC21A2: Solute ligand carrier family 21, sub-family A, member 2;
SLC21A4: Solute ligand carrier family 21, sub-family A, member 4;
SLC21A5: Solute ligand carrier family 21, sub-family A, member 5;
SLC21A7: Solute ligand carrier family 21, sub-family A, member 7;
SLC21A9: Solute ligand carrier family 21, sub-family A, member 9;
SLC21A11: Solute ligand carrier family 21, sub-family A, member 11;
SLC21A12: Solute ligand carrier family 21, sub-family A, member 12;
SLC21A13: Solute ligand carrier family 21, sub-family A, member 13;
SLC21A14: Solute ligand carrier family 21, sub-family A, member 14;
SLC22A1: Solute ligand carrier family 22, sub-family A, member 1;
SLC22A2: Solute ligand carrier family 22, sub-family A, member 2;
SLC22A3: Solute ligand carrier family 22, sub-family A, member 3;
SLC22A4: Solute ligand carrier family 22, sub-family A, member 4;
SLC22A5: Solute ligand carrier family 22, sub-family A, member 5;
SLC22A6: Solute ligand carrier family 22, sub-family A, member 6;
SLC22A8: Solute ligand carrier family 22, sub-family A, member 8;
SLC22A9: Solute ligand carrier family 22, sub-family A, member 9;
SLC22A12: Solute ligand carrier family 22, sub-family A, member 12;
SLC22A17: Solute ligand carrier family 22, sub-family A, member 17;
SLC22A18: Solute ligand carrier family 22, sub-family A, member 18;
SLC28A1: Solute ligand carrier family 28, sub-family A, member 1;
SLC28A2: Solute ligand carrier family 28, sub-family A, member 2;
SLC28A3: Solute ligand carrier family 28, sub-family A, member 3;
SLC29A1: Solute ligand carrier family 29, sub-family A, member 1;
SLC29A2: Solute ligand carrier family 29, sub-family A, member 2;
SLC29A3: Solute ligand carrier family 29, sub-family A, member 3;
SULT1A1: Sulfotransferase family 1A, member 1;
SULT1B1: Sulfotransferase family 1B, member 1;
SULT1D1: Sulfotransferase family 1D, member 1;
SULT1E1: Sulfotransferase family 1E, member 1;
SULT2A2: Sulfotransferase family 2A, member 2;
SULT2B1: Sulfotransferase family 2B, member 1;
SULT4A1: Sulfotransferase family 4A, member 1;
UGT1A: UDP glucuronosyltransferase family 1, polypeptide A;
UGT2A1: UDP glucuronosyltransferase family 2, polypeptide A1;
UGT2B: UDP glycosyltransferase family 2, polypeptide B;
UGT2B17: UDP glucuronosyltransferase family 2, polypeptide B17;
UGT2B5: UDP glucuronosyltransferase family 2, polypeptide B5;
UGT2B36: UDP glucuronosyltransferase family 2, polypeptide B36);
UGT2B37: UDP glucuronosyltransferase family 2; polypeptide B37; and
UGT8: UDP glycosyltransferase 8.

### (II) DEFINITIONS

The term “nucleic acids”, “nucleic acid molecules”, “nucleic acid sequences”, “nucleotide sequences” and “nucleotide molecules” are used interchangeably herein and, unless otherwise specified, refer to a polymer of deoxyribonucleic acids, including cDNA, DNA, PNA, or RNA/DNA copolymers. Nucleic acid may be obtained from a cellular extract, genomic or extragenomic DNA, viral DNA, or artificially/chemically synthesized molecules. The term can include double stranded or single stranded deoxyribonucleic acids.

The term “cDNA” refers to complementary or “copy” DNA. Generally, cDNA is synthesized by a DNA polymerase using any type of RNA molecule as a template. Alternatively, the cDNA can be obtained by direct chemical synthesis.

The term “RNA” refers to a polymer of ribonucleic acids, including RNA, mRNA, rRNA, tRNA and small nuclear RNAS, as well as to RNAs that comprise ribonucleotide analogues to natural ribonucleic acid residues, such as 2-O-methylated residues.

The term “PCR amplicon” or “amplicon” refers to a double stranded nucleic acid generated by nucleic acid amplification, particularly PCR amplification.

“Amplification” is defined as the production of additional copies of a nucleic acid sequence and is generally carried out using polymerase chain reaction technologies well known in the art (Dieffenbach C W and G S Dveksler (1995) PCR Primer, a Laboratory Manual, Cold Spring Harbor Press, Plainview N.Y.). As used herein, the term “polymerase chain reaction” (PCR) refers to the method of K. B. Mullis U.S. Pat. Nos. 4,683,195 and 4,683,202, hereby incorporated by reference, which describe a method for increasing the concentration of a segment of a target sequence in a mixture of genomic DNA without cloning or purification. The length of the amplified segment of the desired target sequence is determined by the relative positions of two oligonucleotide primers with respect to each other, and therefore, this length is a controllable parameter. By virtue of the repeating aspect of the process, the method is referred to as PCR. Because the desired amplified segments of the target sequence become the predominant sequences (in terms of concentration) in the mixture, they are said to be “PCR amplified”.

Amplification in PCR requires “PCR reagents” or “PCR materials”, which herein are defined as all reagents necessary to carry out amplification except the polymerase, primers and template. PCR reagents normally include nucleic acid precursors (dCTP, dTTP etc.) and buffer.

As used herein, the term “primer” refers to an oligonucleotide, produced synthetically, that is acts as a point of initiation of synthesis when placed under conditions in which synthesis of a primer extension product that is complementary to a nucleic acid strand is induced, (i.e., in the presence of nucleotides and an inducing agent such as DNA polymerase and at a suitable temperature and pH). The primer is single stranded for maximum efficiency in amplification. In one embodiment, the primer is an oligodeoxyribonucleotide. The primer must be sufficiently long to prime the synthesis of extension products in the presence of the inducing agent. The exact lengths of the primers will depend on many factors, including temperature, source of primer and the use of the method. In an embodiment of the present disclosure the length of the primers is 24 basepair (bp).

The term “pair(s) of primers” refers to an upper primer and a lower primer. The primers can be categorized as upper or lower primers, depending upon the relative orientation of the primer versus the polarity of the nucleic acid sequence of interest (e.g., whether the primer binds to the coding strand or a complementary (noncoding) strand of the sequence of interest).

The term “probe” as used herein means a nucleic acid sequence that is complementary to another nucleic acid sequence, for example a target nucleic acid sequence, and is used to identify the target nucleic acid sequence from a mixture of sequences. Therefore the probe nucleic acid sequence will hybridize only to the target sequence, with minimum cross-hybridization with other nucleic acid sequences, under specified stringency conditions. In an embodiment, hybridization is performed for 15-18 hrs at 60° C. in Schott Nexterion Hybridization buffer [#1066075] to ensure hybridization and then subsequent washes are performed (2×SSC; 0.2% SDS, 2×SSC then 0.2×SSC then water) to eliminate mismatched hybrid duplexes. In an embodiment the probe sequences are double stranded and are denatured prior to hybridization.

The expression “genes relevant to the ADME of prototypical inducer compounds” as used herein refers to any gene that encodes a protein whose function is relevant or involved in the coordinate regulation pathways of adsorption, distribution, metabolism and elimination (ADME) of prototypical compounds or drugs. Accordingly the identity of relevant genes will be dependent on the drug or compound in question as would be known to those skilled in the art. In an embodiment the genes relevant to the ADME of prototypical inducer compounds are those having a homologous human sequence.

The term “prototypical inducer compounds” as used herein refers to compounds belonging to a class of inducer compounds or drugs (i.e. those that induce the activity of a specific gene) that have been selected in the art as representative of that class and are used to comprehend and co-relate their pharmacological effects with the other compounds or drugs of the same group. Examples of prototypical compounds, include but are not limited to, rifampicin, phenobarbital, β-naphthoflavone, dexamethasone, pregnanolone-16-carbonitrile, 3-methyl-cholanthrene, acetaminophen, chlorpromazine and morphine.

The term “transcription” refers to the process of copying a DNA sequence of a gene into an RNA product, generally conducted by a DNA-directed RNA polymerase using the DNA as a template.

The term “isolated”, when used in relation to a nucleic acid molecule or sequence, refers to a nucleic acid sequence that is identified and separated from at least one contaminant nucleic acid with which it is ordinarily associated in its natural source. Isolated nucleic acid is nucleic acid present in a form or setting that is different from that in which it is found in nature. In an embodiment, an isolated nucleic acid is substantially free of cellular material or culture medium when produced by recombinant DNA techniques, or chemical precursors, or other chemicals when chemically synthesized.

As used herein, the term “purified” or “to purify” refers to the removal of undesired components from a sample.

The term “target nucleic acid” or “target sequence” refers to a nucleic acid or nucleic acid sequence which is to be analyzed. A target can be a nucleic acid to which a probe will hybridize. It is either the presence or absence of the target nucleic acid that is to be detected, or the amount of the target nucleic acid that is to be quantified. The term target nucleic acid may refer to the specific subsequence of a larger nucleic acid to which the probe is directed or to the overall sequence (e.g., gene or mRNA) whose expression level it is desired to detect. The difference in usage will be apparent from context.

“Complementary or substantially complementary” refers to the hybridization or base pairing between nucleotides or nucleic acids, such as, for instance, between the two strands of a double stranded DNA molecule or between an oligonucleotide primer and a primer binding site on a single stranded nucleic acid to be sequenced or amplified. Complementary nucleotides are, generally, A and T (or A and U), or C and G. Two single stranded DNA molecules are said to be substantially complementary when the nucleotides of one strand, optimally aligned and compared and with appropriate nucleotide insertions or deletions, pair with at least about 80% of the nucleotides of the other strand, usually at least about 90% to 95%, or from about 98 to 100%. Alternatively, substantial complementary exists when a DNA strand will hybridize under selective hybridization conditions to its complement. Typically, selective hybridization will occur when there is at least about 65% complementary over a stretch of at least 14 to 25 nucleotides, suitably at least about 75%, more suitably at least about 90% complementary. See, M. Kanehisa Nucleic Acids Res. 12:203 (1984).

The term “perfect complement” refers to the exact hybridization match such as in the opposing strands in double stranded nucleic acids.

An “array” is a solid support with at least a first surface having a plurality of different nucleic acid sequences attached to the first surface. An array is an intentionally created collection of molecules which are prepared either synthetically or biosynthetically. Additionally, the term “array” is meant to include those libraries of nucleic acids which can be prepared by spotting nucleic acids of essentially any length (e.g., from 1 to about 1000 nucleotide monomers in length) onto a substrate.

“Solid support”, “support”, and “substrate” are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations.

The terms “compound” and “drug” are used interchangeably herein and mean any agent which may have an effect on gene expression, particularly expression of genes encoding rat cytochrome p450s, nuclear xenobiotic receptors, transferases and transporters, and includes, but is not limited to, small inorganic or organic molecules: peptides and proteins and fragments thereof; carbohydrates, and nucleic acid molecules and fragments thereof. The compound or drug may be isolated from a natural source or be synthetic. The term compound and drug also includes mixtures of compounds or agents such as, but not limited to, combinatorial libraries and extracts from an organism.

The term “exposed” as used herein means that a subject or plurality of cells has been brought into contact with the compound(s) or drug(s) using any method known in the art. For example, cells may be exposed to a compound by adding the compound(s) to the media used for cell storage, growth and/or washing. In a further example, the exposure may be affected by administering the compound(s) to a test subject using any known methods for administration, and the test cells are obtained from the subject, again using any known means.

The term “test cells” refers to a plurality of cells or cell lines, or tissues or organisms, or portions or homogenates thereof which represent a source of target nucleic acids. In one embodiment, the test cells are from a subject. In another embodiment, the test cells are from a rat. In a further embodiment, the test cells are a homogenate of cells or tissues or other biological samples. In another embodiment the test cells are from a subject that has been exposed to a drug or compound in vivo. In a further embodiment, the test cells have been exposed to a drug or compound in vitro. In an embodiment of the present disclosure, the test cells are derived from primary liver, kidney, colon or lung cells, tissue or fine needle biopsy samples, blood, urine, peritoneal fluid or pleural fluid.

The term “control cells” as used herein includes isolated primary cells from rat organs or tissues (eg. liver hepatocytes) that have not been treated with drug in vitro prior to RNA isolation. The term “control cells” also includes cells isolated from organs or tissues from a subject rat that has not been treated with (i.e. administered) drug prior to RNA isolation.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

### (III) ARRAYS OF THE DISCLOSURE

The arrays of the present disclosure have been designed to include a selected and unique subset of probes that bind (i.e. hybridize to) and identify a pre-selected subset of rat ADME-related gene sequences. The genes selected by the present inventors are advantageous because they include critical genes involved directly in ADME, as well as genes whose activation is co-ordinated with the induction of these ADME-related genes, therefore the analysis of the expression profile of these genes under various conditions provides valuable information, for example, for predicting drug-drug interactions or potential adverse drug effects. This represents the first time that probes for this specific group of genes have been put on a single array for coordinated gene expression analysis.

The genes on the arrays of the present disclosure include the following:

### (a) Transporters

Membrane transporters are critical facilitators of the uptake (e.g. solute carrier family (SLC) transporters) and efflux (e.g. ATP binding cassette (ABC) transporters) of drugs. Transporters can alter drug disposition and distribution in several important ways. First, drug uptake can be enhanced by members of the SLC family of transporters. Second, significant and adverse drug-drug interactions can occur when one of the co-administered drugs induces or suppresses transporter gene expression or protein function. Third, drug efflux can be enhanced by members of the ABC family of transporters. Fourth, food-drug interactions can influence both uptake and efflux transporter levels.

Many of these transporters play key roles in pharmacology affecting both the uptake and efflux of administered drugs. As such, these transporters play critical roles in mediating both the chemo-sensitivity and chemo-resistance of cancer cells to cancer chemotherapeutics. ABC transporters are frequently associated with decreased intracellular concentration of chemotherapeutic agents and acquired multi-drug resistance of tumor cells. SLC transporters, including anion, cation, nucleoside and amino acid transporters, are associated with increased sensitivity of tumor cells to chemotherapeutic agents since these transporters facilitate the cellular uptake of hydrophilic compounds.

Membrane transporters can be classified as either passive or active transporters. The active transporters can be further divided into primary or secondary active transporters based on the process of energy coupling and facilitated transport. The ABC transporters are primary active transporters which export compounds against a chemical gradient driven by ATP and an inherent ATPase activity. The majority of passive transporters, which permit compounds to equilibrate along a concentration gradient, ion pumps, secondary active transporters and exchangers belong to the SLC transporter family.

Understanding the role and function of membrane transporters in both normal cells and cancer cells will be valuable in “predicting” chemotherapeutic drug response as well as indicating which transporters might serve as potential therapeutic targets for “preventing” acquired drug resistance.

### (b) Cytochrome P450 Enzymes

Drug metabolism is a major determinant of drug clearance and is the factor most frequently responsible for pharmacokinetic differences in drug responses between individuals. These differences in drug response between individuals are due primarily to the inducible expression of, and polymorphisms in, the drug metabolizing cytochrome P450 enzymes (CYPs).

Many drug-drug interactions are metabolism-based and most involve induction of CYPs. Of the eleven xenobiotic metabolizing CYPs expressed in the rat liver a specific group of six CYPs appear to be responsible for the metabolism of most drugs and their associated drug-drug interactions. This is likely due to the ability of these CYPs to bind and metabolize chemical structures common to many drugs and to the mass abundance of these CYPs in the liver.

An increase in the level of a specific CYP following drug exposure usually raises concerns of potential toxicity, dosage limitations or possible drug-drug interactions should the drug be used in a clinical setting. Consequently, CYP induction following treatment with novel therapeutic agents can be used as a potential marker of adverse drug response.

### (c) Nuclear Xenobiotic Receptors

A complex signaling network exists to protect cells against the potential toxic effects of xenobiotics (exogenous compounds). This system includes the nuclear xenobiotic receptors (NXRs) and functions in concert with other signaling pathways involved in the metabolism of endogenous compounds. The expression of the CYPs and other genes in the drug sensing, transport and metabolism systems is not only regulated by drugs but is also influenced by physiopathological (e.g. steroids, lipids, salts, etc.) and environmental (e.g. nutrients) factors. In addition to regulating CYP expression, the NXRs interact with other nuclear receptors controlling various facets of endogenous metabolism.

### (d) Transferases

Both sulfotransfersaes (SULTs) and UDP-glucuronosyl transferases (UGTs) are involved in a number of important biological processes in all tissues. The SULT and UGT gene families encode phase II biotransformation enzymes that detoxify by catalyzing the sulfonation or glucuronidation of diverse xenobiotic compounds thereby making these compounds more water-soluble and more easily excreted or eliminated. Many of the same xenobiotic compounds that induce CYP gene expression also induce SULT and UGT gene expression. This suggests that transferases may be coordinately regulated with CYPs and other phase I enzymes via the same transcriptional pathways. Transferases play an important role in the metabolism and elimination of xenobiotic and important endobiotic compounds, particularly in the liver. The modulation or perturbation of transferase gene expression by xenobiotics is a potential marker of drug-drug interaction and/or adverse drug effects.

Primer pairs comprising nucleic acid sequences from rat cytochrome p450s, nuclear xenobiotic receptors, transferases and transporters, have been designed and used to prepare nucleic acid probes for gene expression screening analysis. These primer pairs were used to generate PCR amplicons. Each of these PCR amplicons specifically hybridized to a different rat cytochrome p450, nuclear xenobiotic receptor, transferase or transporter gene transcript. By “specifically hybridizes to” it is meant that the a single strand of the PCR amplicon binds, duplexes or hybridizes substantially to or only with a particular nucleic acid sequence with minimum cross-hybridization with other nucleic acid sequences. In other words, the PCR amplicon represents a probe to detect the expression of a specific rat cytochrome p450 gene, nuclear xenobiotic receptor gene, transferase gene or transporter gene.

The PCR amplicons generated using the primer pairs of the disclosure, can be used in assays, such as arrays to detect the coordinated expression of the unique combination of genes encoding rat cytochrome p450s, nuclear xenobiotic receptors, transferases and transporters. Arrays, such as microarrays, have the benefit of assaying gene expression in a high throughput fashion.

Accordingly, in one aspect, the present disclosure includes an array comprising a plurality of nucleic acid probes each corresponding to a unique gene transcript and each immobilized on a solid support wherein the plurality comprises a unique probe for each gene encoding at least one rat cytochrome p450 enzyme, at least one rat nuclear xenobiotic receptor, at least one rat transferase, at least one rat uptake transporter and at least one rat efflux transporter. In an embodiment the at least one rat cytochrome p450 enzyme, at least one rat nuclear xenobiotic receptor, at least one rat transferase, at least one rat uptake transporter and at least one rat efflux transporter are those that are relevant to the ADME of prototypical inducer compounds. In a further embodiment, the at least one rat transferase is a sulfotransferase and a UDP glucuronosyltransferase. In another embodiment, the at least one uptake transporter is a solute ligand carrier (SLC) uptake transporter. In another embodiment, the efflux transporter is an ATP biding cassetter (ABC) efflux transporter.

In another aspect, the array comprises a unique probe for each of the following genes: rat CAR1 NR111, rat FXR NR1H4, rat LXR NR1H2, rat PPARA, rat PPARD, rat PPARG, rat PXR, rat RXRA, rat RXRB, rat RXRG, rat CYP1A2, rat CYP1B1, rat CYP2B2, rat CYP2C7, rat CYP2D22, rat CYP2E1, rat CYP3A1, rat CYP19A1, rat CYP27A1, rat ABCA1, rat ABCA2, rat ABCA5, rat ABCA7, rat ABCA17, rat ABCB1, rat ABCB1a, ABCB2, rat ABCB3, rat ABCB4, rat ABCB6, rat ABCB7, rat ABCB8, rat ABCB9, rat ABCB10, rat ABCB11, rat ABCC1, rat ABCC2, rat ABCC3, rat ABCC4, rat ABCC5, rat ABCC6, rat ABCC8, rat ABCC9, rat ABCC12, rat ABCD2, rat ABCD3, rat ABCF3, rat ABCG1, rat ABCG2, rat ABCG3, rat ABCG3a, rat ABCG3b, rat ABCG5, rat ABCG8, rat ACTb, rat B2M, rat GAPDH, rat RPLP0, rat VIL1, rat VIL2, rat SLC10A1, rat SLC10A2, rat SLC21A1, rat SLC21A2, rat SLC21A4, rat SLC21A5, rat SLC21A7, rat SLC21A9, rat SLC21A11, rat SLC21A12, rat SLC21A13, rat SLC21A14, rat SLC22A1, rat SLC22A2, rat SLC22A3, rat SLC22A4, rat SLC22A5, rat SLC22A6, rat SLC22A8, rat SLC22A9, rat SLC22A12, rat SLC22A17, rat SLC22A18, rat SLC28A1, rat SLC28A2, rat SLC28A3, rat SLC29A1, rat SLC29A2, rat SLC29A3, rat SULT1A1, rat SULT1B1, rat SULT1D1, rat SULT1E1, rat SULT2A2, rat SULT2B1, rat SULT4A1, rat UGT1A, rat UGT2A1, rat UGT2B, rat UGT2B17, rat UGT2B5, rat UGT2B36, rat UGT2B37 and rat UGT8.

In another aspect, the present disclosure includes an array comprising a plurality of nucleic acid probes each corresponding to a unique gene transcript and each immobilized on a solid support wherein the plurality comprises each of the sequences listed in SEQ ID NOs: 3, 6, 9, 12, 15, 18, 21, 24, 27, 30, 33, 36, 39, 42, 45, 48, 51, 54, 57, 60, 63, 66, 69, 72, 75, 78, 81, 84, 87, 90, 93, 96, 99, 102, 105, 108, 111, 114, 117, 120, 123, 126, 129, 132, 135, 138, 141, 144, 147, 150, 153, 156, 159, 162, 165, 168, 171, 174, 177, 180, 183, 186, 189, 192, 195, 198, 201, 204, 207, 210, 213, 216, 219, 222, 225, 228, 231, 234, 237, 240, 243, 246, 249, 252, 255, 258, 261, 264, 267, 270, 273, 276, 279, 282, 285, 288, 291, 294, 297, 300, 303, 306, 309 and 312 and wherein each probe in the plurality of nucleic acid probes consists of one of the sequences listed in SEQ ID NOs: 3, 6, 9, 12, 15, 18, 21, 24, 27, 30, 33, 36, 39, 42, 45, 48, 51, 54, 57, 60, 63, 66, 69, 72, 75, 78, 81, 84, 87, 90, 93, 96, 99, 102, 105, 108, 111, 114, 117, 120, 123, 126, 129, 132, 135, 138, 141, 144, 147, 150, 153, 156, 159, 162, 165, 168, 171, 174, 177, 180, 183, 186, 189, 192, 195, 198, 201, 204, 207, 210, 213, 216, 219, 222, 225, 228, 231, 234, 237, 240, 243, 246, 249, 252, 255, 258, 261, 264, 267, 270, 273, 276, 279, 282, 285, 288, 291, 294, 297, 300, 303, 306, 309 and 312.

In another embodiment, the probes on the array are double stranded and therefore also comprise the perfect complement of each one of the sequences listed in SEQ ID NOs: 3, 6, 9, 12, 15, 18, 21, 24, 27, 30, 33, 36, 39, 42, 45, 48, 51, 54, 57, 60, 63, 66, 69, 72, 75, 78, 81, 84, 87, 90, 93, 96, 99, 102, 105, 108, 111, 114, 117, 120, 123, 126, 129, 132, 135, 138, 141, 144, 147, 150, 153, 156, 159, 162, 165, 168, 171, 174, 177, 180, 183, 186, 189, 192, 195, 198, 201, 204, 207, 210, 213, 216, 219, 222, 225, 228, 231, 234, 237, 240, 243, 246, 249, 252, 255, 258, 261, 264, 267, 270, 273, 276, 279, 282, 285, 288, 291, 294, 297, 300, 303, 306, 309 and 312.

In another aspect, there is included an array comprising a plurality of nucleic acid probes immobilized on a solid support, wherein
(a) the plurality of nucleic acid probes corresponds to a multiplicity of gene transcripts;
(b) each nucleic acid probe is complementary to a distinct gene transcript; and
(c) each nucleic acid probe of the plurality is prepared by amplification of cDNA using a primer pair consisting of nucleic acid sequences selected from:

SEQ ID NO:1 and SEQ ID NO:2;

SEQ ID NO:4 and SEQ ID NO:5;

SEQ ID NO:7 and SEQ ID NO:8;

SEQ ID NO:10 and SEQ ID NO:11;

SEQ ID NO:13 and SEQ ID NO:14;

SEQ ID NO:16 and SEQ ID NO:17;

SEQ ID NO:19 and SEQ ID NO:20;

SEQ ID NO:22 and SEQ ID NO:23;

SEQ ID NO:25 and SEQ ID NO:26;

SEQ ID NO:28 and SEQ ID NO:29;

SEQ ID NO:31 and SEQ ID NO:32;

SEQ ID NO:34 and SEQ ID NO:35;

SEQ ID NO:37 and SEQ ID NO:38;

SEQ ID NO:40 and SEQ ID NO:41;

SEQ ID NO:43 and SEQ ID NO:44;

SEQ ID NO:46 and SEQ ID NO:47;

SEQ ID NO:49 and SEQ ID NO:50;

SEQ ID NO:52 and SEQ ID NO:53;

SEQ ID NO:55 and SEQ ID NO:56;

SEQ ID NO:58 and SEQ ID NO:59;

SEQ ID NO:61 and SEQ ID NO:62;

SEQ ID NO:64 and SEQ ID NO:65;

SEQ ID NO:67 and SEQ ID NO:68;

SEQ ID NO:70 and SEQ ID NO:71;

SEQ ID NO:73 and SEQ ID NO:74;

SEQ ID NO:76 and SEQ ID NO:77;

SEQ ID NO:79 and SEQ ID NO:80;

SEQ ID NO:82 and SEQ ID NO:83;

SEQ ID NO:85 and SEQ ID NO:86;

SEQ ID NO:88 and SEQ ID NO:89;

SEQ ID NO:91 and SEQ ID NO:92;

SEQ ID NO:94 and SEQ ID NO:95;

SEQ ID NO:97 and SEQ ID NO:98;

SEQ ID NO:100 and SEQ ID NO:101;

SEQ ID NO:103 and SEQ ID NO:104;

SEQ ID NO:106 and SEQ ID NO:107;

SEQ ID NO:109 and SEQ ID NO:110;

SEQ ID NO:112 and SEQ ID NO:113;

SEQ ID NO:115 and SEQ ID NO:116;

SEQ ID NO:118 and SEQ ID NO:119;

SEQ ID NO:121 and SEQ ID NO:122;

SEQ ID NO:124 and SEQ ID NO:125;

SEQ ID NO:127 and SEQ ID NO:128;

SEQ ID NO:130 and SEQ ID NO:131;

SEQ ID NO:133 and SEQ ID NO:134;

SEQ ID NO:136 and SEQ ID NO:137;

SEQ ID NO:139 and SEQ ID NO:140;

SEQ ID NO:142 and SEQ ID NO:143;

SEQ ID NO:145 and SEQ ID NO:146;

SEQ ID NO:148 and SEQ ID NO:149;

SEQ ID NO:151 and SEQ ID NO:152;

SEQ ID NO:154 and SEQ ID NO:155;

SEQ ID NO:157 and SEQ ID NO:158;

SEQ ID NO:160 and SEQ ID NO:161;

SEQ ID NO:163 and SEQ ID NO:164;

SEQ ID NO:166 and SEQ ID NO:167;

SEQ ID NO:169 and SEQ ID NO:170;

SEQ ID NO:172 and SEQ ID NO:173;

SEQ ID NO:175 and SEQ ID NO:176;

SEQ ID NO:178 and SEQ ID NO:179;

SEQ ID NO:181 and SEQ ID NO:182;

SEQ ID NO:184 and SEQ ID NO:185;

SEQ ID NO:187 and SEQ ID NO:188;

SEQ ID NO:190 and SEQ ID NO:191;

SEQ ID NO:193 and SEQ ID NO:194;

SEQ ID NO:196 and SEQ ID NO:197;

SEQ ID NO:199 and SEQ ID NO:200;

SEQ ID NO:202 and SEQ ID NO:203;

SEQ ID NO:205 and SEQ ID NO:206;

SEQ ID NO:208 and SEQ ID NO:209;

SEQ ID NO:211 and SEQ ID NO:212;

SEQ ID NO:214 and SEQ ID NO:215;

SEQ ID NO:217 and SEQ ID NO:218;

SEQ ID NO:220 and SEQ ID NO:221;

SEQ ID NO:223 and SEQ ID NO:224;

SEQ ID NO:226 and SEQ ID NO:227;

SEQ ID NO:229 and SEQ ID NO:230;

SEQ ID NO:232 and SEQ ID NO:233;

SEQ ID NO:235 and SEQ ID NO:236;

SEQ ID NO:238 and SEQ ID NO:239;

SEQ ID NO:241 and SEQ ID NO:242;

SEQ ID NO:244 and SEQ ID NO:245;

SEQ ID NO:247 and SEQ ID NO:248;

SEQ ID NO:250 and SEQ ID NO:251;

SEQ ID NO:253 and SEQ ID NO:254;

SEQ ID NO:256 and SEQ ID NO:257;

SEQ ID NO:259 and SEQ ID NO:260;

SEQ ID NO:262 and SEQ ID NO:263;

SEQ ID NO:265 and SEQ ID NO:266;

SEQ ID NO:268 and SEQ ID NO:269;

SEQ ID NO:271 and SEQ ID NO:272;

SEQ ID NO:274 and SEQ ID NO:275;

SEQ ID NO:277 and SEQ ID NO:278;

SEQ ID NO:280 and SEQ ID NO:281;

SEQ ID NO:283 and SEQ ID NO:284;

SEQ ID NO:286 and SEQ ID NO:287;

SEQ ID NO:289 and SEQ ID NO:290;

SEQ ID NO:292 and SEQ ID NO:293;

SEQ ID NO:295 and SEQ ID NO:296;

SEQ ID NO:298 and SEQ ID NO:299;

SEQ ID NO:301 and SEQ ID NO:302;

SEQ ID NO:304 and SEQ ID NO:305;

SEQ ID NO:307 and SEQ ID NO:308 and

SEQ ID NO:310 and SEQ ID NO:311.

The term “immobilized” includes attaching or directly chemically synthesizing the plurality of nucleic acid probes on the substrate as well as physical immobilization, for example in wells or other means for physical restraining, on the substrate. The nucleic acid probes are typically immobilized in prearranged patterns so that their locations are known or determinable. Target nucleic acids in a sample can be detected by contacting the sample with the microarray; allowing the nucleic acid probes and target nucleic acids in the sample to hybridize; and analyzing the extent of hybridization.

In a suitable embodiment, the array is a microarray.

In embodiments of the disclosure, the plurality of nucleic acid probes are arranged in distinct spots on the substrate that are known or on determinable locations within the array. A spot refers to a region where the nucleic acid probe is immobilized on the substrate. Each spot can be sufficiently separated from each other spot on the substrate such that they are distinguishable from each other during the hybridization analysis.

In an embodiment, there are at least 69 spots on the array; one spot for each of the 69 PCR amplicons generated by the 69 sets of primers disclosed herein which are used as nucleic acid probes for the following genes: rat CAR1 NR1I1, rat FXR NR1H4, rat LXR NR1H2, rat PPARA, rat PPARD, rat PPARG, rat PXR, rat RXRA, rat RXRB, rat RXRG, rat CYP1A2, rat CYP1B1, rat CYP2B2, rat CYP2C7, rat CYP2D22, rat CYP2E1, rat CYP3A1, rat CYP19A1, rat CYP27A1, rat ABCA1, rat ABCA17, rat ABCB1, rat ABCB4, rat ABCB9, rat ABCB11, rat ABCC1, rat ABCC2, rat ABCC3, rat ABCC4, rat ABCC5, rat ABCC6, rat ABCC9, rat ABCD2, rat ABCF3, rat ABCG1, rat ABCG2, rat ABCG3, rat ABCG5, rat SLC10A1, rat SLC10A2, rat SLC21A2, rat SLC21A5, rat SLC21A9, rat SLC22A1, rat SLC22A2, rat SLC22A3, rat SLC22A6, rat SLC22A8, rat SLC28A1, rat SLC28A2, rat SLC28A3, rat SLC29A1, rat SLC29A2, rat SLC29A3, rat SULT1A1, rat SULT1B1, rat SULT1D1, rat SULT1E1, rat SULT2A2, rat SULT2B1, rat SULT4A1, rat UGT1A, rat UGT2A1, rat UGT2B, rat UGT2B17, rat UGT2B5, rat UGT2B36, rat UGT2B37 and rat UGT8, In another embodiment, the array additionally includes at least one spot for control nucleic acid molecules, for example rat ACTb, rat B2M, rat GAPDH, rat RPLP0, rat VIL1 and/or rat VIL2.

When the nucleic acid probe is immobilized on the substrate, a conventionally known technique can be used. For example, the surface of the substrate can be treated with polycations such as polylysines to electrostatically bind the molecules through their charges on the surface of the substrate, and techniques to covalently bind the 5′-end of the DNA to the substrate may be used. Also, a substrate that has linkers on its surface can be produced, and functional groups that can form covalent bonds with the linkers can be introduced at the end of the DNA to be immobilized. Then, by forming a covalent bond between the linker and the functional group, the DNA and such can be immobilized.

Other methods of forming arrays of oligonucleotides, peptides and other polymer sequences with a minimal number of synthetic steps are known and may be used in the present disclosure. These methods include, but are not limited to, light-directed chemical coupling and mechanically directed coupling. See Pirrung et al., U.S. Pat. No. 5,143,854 and PCT Application No. WO 90/15070, Fodor et al., PCT Publication Nos. WO 92/10092 and WO 93/09668, which disclose methods of forming vast arrays of peptides, oligonucleotides and other molecules using, for example, light-directed synthesis techniques. See also, Fodor et al., Science, 251, 767-77 (1991). These procedures for synthesis of polymer arrays are now referred to as VLSIPSTM procedures. Using the VLSIPSTM approach, one heterogeneous array of polymers is converted, through simultaneous coupling at a number of reaction sites, into a different heterogeneous array.

An array used to detect gene expression typically includes one or more control nucleic acid molecules or probes. The control may be, for example, an expression level control (e.g. positive controls) or background control (e.g. negative controls).

Background controls are elements printed on the substrate that contain no nucleic acids and thus measure the amount of non-specific hybridization of the labeled cDNA to elements on the substrate.

Expression level controls are probes that hybridize specifically with constitutively expressed genes in the biological sample. Virtually any constitutively expressed gene provides a suitable target for expression level controls. Typically expression level control probes have sequences complementary to sub-sequences of constitutively expressed “housekeeping genes” including, but not limited to the beta-actin gene, the transferrin receptor gene, the glyceraldehyde-3-phosphate dehydrogenase (GAPDH) gene, and the like (Warrington J A et al., Physiol Genomics 2:143-147, 2000, Hsiao L L et al., Physiol Genomics 7:97-104, 2001, Whitfield M L et al., Mol Cell Biol 13:1977-2000, 2002).

### (IV) USES OF THE ARRAY OF THE DISCLOSURE

In a further embodiment, the disclosure includes a method of gene expression analysis comprising:
(a) contacting one or more pools of nucleic acids under hybridization conditions with an array of the present disclosure; and
(b) detecting hybridization of the one or more pools of nucleic acids with the plurality of nucleic acid probes,

wherein the presence of hybridization indicates gene expression.

In an embodiment of the disclosure the method of analysis is used to detect the coordinated expression of genes encoding rat cytochrome p450s, nuclear xenobiotic receptors, transferases and transporters. In this embodiment, if hybridization is present, this is indicative of the expression of the genes.

Accordingly, the method of analysis is used to prepare a gene expression profile. The present disclosure therefore includes a method of preparing a gene expression profile comprising:
(a) contacting one or more pools of target nucleic acids from a plurality cells with an array according to the disclosure under hybridization conditions; and
(b) detecting hybridization of the target nucleic acids with the nucleic acid probes on the array, wherein hybridization is indicative of the expression of the corresponding gene transcript in the plurality of cells; and
(c) creating a gene expression profile based on the hybridization detected in (b).

In a further embodiment, the method of analysis is used to perform drug-associated gene expression profiling of genes encoding rat cytochrome p450s, nuclear xenobiotic receptors, transferases and transporters. Such profiling can be used to identify potential modulators of gene expression. For example, test cells are exposed to a chemical compound or a drug, and then gene expression is detected in a test cells using the methods of the disclosure. In an embodiment, gene expression is detected at various time intervals after the cells are exposed to a compound or drug, for example, every 2 hours after exposure over a 24 hour period. In a further embodiment, after (and optionally before) the cells are exposed to the chemical or drug, mRNA is extracted from a test cells and then cDNA is produced using the extracted mRNA. The cDNA is labeled and allowed to hybridize with the array of the disclosure. The amount of hybridization is detected and compared with the amount of hybridization obtained with a test cells taken either at a different time-point from, or taken from different cells that were treated under the same conditions except that these cells were not exposed to the compound or drug (i.e. control cells). By performing this comparison, the effect of the drug or compound on the expression of each of the genes (whether it be increased, decreased or the same) in the test cells is determined.

In an embodiment of the disclosure, target nucleic acid expression is obtained using reverse transcription. For example, total RNA is extracted from a test cells using techniques known in the art. cDNA is then synthesized using known techniques, such as using either oligo(dT) or random primers. Gene expression is then detected using the said target cDNA by allowing the cDNA to hybridize to the array of the disclosure, then detecting the amount of hybridization of said target cDNA with plurality of nucleic acid probes.

Methods of isolating total RNA are also well known to those skilled in the art. For example, see Chapter 3 of Laboratory Techniques in Biochemistry and Molecular Biology: Hybridization with Nucleic Acid Probes, Part I: Theory and Nucleic Acid Preparation, Tijssen, ed. Elsevier Press (1993); Sambrook et al., Molecular Cloning: A Laboratory Manual (2^{nd} ed.), Vols. 1-3, Cold Spring Harbour Laboratory (1989); or Current Protocols in Molecular Biology, F. Ausubel et al., ed. Greene Publishing and Wiley-Interscience, New York (1987). In an embodiment, the total RNA is isolated from given test cells, for example, using TRIzol reagent (Cat. No. 15596-018, Invitrogen Life Technologies) according to the manufacturer's instructions.

Those of skill in the art will appreciate that the total RNA prepared with most methods includes not only the mature RNA, but also the RNA processing intermediates and nascent pre-mRNA transcripts. For example, total mRNA purified with a poly (dT) column contains RNA molecules with poly (A) tails. Those polyA+RNA molecules could be mature mRNA, RNA processing intermediates, nascent transcripts or degradation intermediates. For use in studying the impact of a compound or drug on gene expression, the test cell is obtained from a source that has been exposed to that compound or drug.

In embodiments, the target nucleic acid molecules may need to be amplified prior to performing the hybridization assay. Methods for amplification, including “quantitative amplification” are well known to those skilled in the art.

In an embodiment the target nucleic acid molecule is labeled with a detectable label. The term “label” refers to any detectable moiety. A label may be used to distinguish a particular nucleic acid from others that are unlabeled, or labeled differently, or the label may be used to enhance detection.

Methods for labeling nucleic acids are well known to those skilled in the art. In an embodiment of the disclosure, the label is simultaneously incorporated during an amplification step in the preparation of target nucleic acid molecules. Thus for example, PCR with labeled primers or labeled nucleotides (for example fluorescein-labeled UTP and/or CTP) will provide a labeled amplification product. Alternatively, a label may be added directly to the original nucleic acid sample or to the amplification product after the amplification is completed using methods known to those skilled in the art (for example nick translation and end-labeling).

Detectable labels that are suitable for use in the methods of the present disclosure include those that are detectable by spectroscopic, photochemical, biochemical, immunochemical, electrical, optical or other means. Some examples of useful labels include biotin staining with labeled streptavidin conjugate, magnetic beads, fluorescent dyes (e.g. cyanine, fluorescein, rhodamine, and the like), radiolabels (e.g. ³H, ³²P, ¹⁴C, ²⁵S or ¹²⁵I), enzymes (e.g. horseradish peroxidase, alkaline phosphatase and others commonly used in ELISA) and colorimetric labels such as colloidal gold or colored glass or plastic (e.g. polystyrene, polypropylene, latex and the like) beads. Patents teaching the use of such labels include U.S. Pat. Nos. 3,817,837, 3,850,752, 3,939,350, 3,996,345, 4,277,437, 4,275,149 and 4,366,241, the contents of all of which are incorporated herein by reference.

Target nucleic acid molecules from test cells that have been subjected to particular stringency conditions hybridize to the plurality of nucleic acid probes on the array. One of skill in the art will appreciate that hybridization conditions may be selected to provide any degree of stringency. In an embodiment, hybridization is performed for 15-18 hrs at 60° C. in Schott Nexterion Hyb buffer (Cat. No. 1066075) to ensure hybridization and then subsequent washes are performed (2×SSC; 0.2% SDS, 2×SSC then 0.2×SSC then water) to eliminate mismatched hybrid duplexes. Hybridization specificity may be evaluated by comparison of hybridization to the test nucleic acid sequences with hybridization to the various controls that can be present (e.g., expression level controls (positive and negative), etc.).

The nucleic acids that do not form hybrid duplexes are washed away leaving the hybridized nucleic acids to be detected, typically through detection of an attached detectable label. After hybridization, the arrays are inserted into a scanner that can detect patterns of hybridization. These hybridization patterns are captured by detecting the labeled target nucleic acid molecule now attached to the array, for e.g., if the target nucleic acid molecule is fluorescently labeled, the hybridization data are collected as light emitted from the labeled groups. Comparison of the absolute intensities of an array exposed to nucleic acids from test cells with intensities produced from the various control cells provides a measure of the relative expression of the nucleic acids represented by each of the probes.

If the target nucleic acid molecule, for example cDNA, is fluorescently labeled, the fluorescence is detected and acquired using a confocal fluorescence scanner, for example, a GSI Lumonics ScanArray Lite Microarray Analysis System, and the fluorescence intensity analyzed with specific quantitation and data processing software on a dedicated computer, for example, QuantArray and GeneLinker Gold. In an embodiment, the intensity of fluorescence increases with increased gene expression. If the transcription indicator, for example cDNA, is radiolabeled, then detection can be carried out using an RU image scanner and such, and the intensity of the radiation can be analyzed with a computer. In an embodiment, the intensity of the radiation increases with increased gene expression.

One skilled in the art will appreciate that one can inhibit or destroy RNAse present in any sample before they are used in the methods of the disclosure. Methods of inhibiting or destroying nucleases, including RNAse, are well known in the art. For example, chaotropic agents may be used to inhibit nucleases or, alternatively, heat treatment followed by proteinase treatment may be used.

In embodiments, the method of analysis may be used to identify compounds or agents that stimulate, induce and/or up-regulate the transcription or expression of one or more rat cytochrome p450 genes, nuclear xenobiotic receptor genes, transferase genes or transporter genes, or to down-regulate, suppress and/or counteract the transcription or expression of these genes, or that have no effect on transcription or expression of these genes, in a given system. One can also compare the specificity of a compound's effect by looking at the expression profile of these genes. Typically, more specific compounds will affect the expression of fewer genes. Further, similar sets of gene expression results or profiles for two different compounds typically indicates a similarity of effects for these two compounds.

The gene expression profile data can be used to design or choose an effective drug for the treatment of disease, such as cancer. For example, by knowing which genes are modulated in the presence of the drug or compound, one can determine a cell's or subject's predisposition to drug toxicity and/or response to drug treatment. In an embodiment of the disclosure, the compound is administered to a subject and gene expression is profiled in test cells from the subject before and/or after administration of the compound. In an alternate embodiment, the compound is administered to a plurality of cells in vitro and gene expression is profiled in these test cells before and/or after administration of the compound. Changes in gene expression are indicative of the toxicity and/or efficacy of the compound in the subject or cells.

In a further embodiment, the method of analysis of the present disclosure is used to detect potential drug/drug interactions by virtue of their concomitant effect on the expression of rat cytochrome p450 genes, nuclear xenobiotic receptor genes, transferase genes and transporter genes. When two or more drugs are administered contemporaneously, for example in combination therapy, gene expression may be altered. This is particularly relevant if two or more drugs are transported by the same transporter. What might be a non-toxic dose of a drug when administered alone, may be a toxic dose when that drug is administered along with another drug; particularly when both drugs are transported by or are substrates for the same transporter. Therefore it is important to determine a drug's effect on gene expression alone, as well as taking in to account the effects on gene expression of the one or more other drugs with which it may be co-administered. To do this, the gene expression profile of two or more drugs are compared and if different drugs modulate the expression of one or more of the same genes, then there is a potential for a drug-drug interaction if the drugs are administered contemporaneously in a subject. As used herein, “administered contemporaneously” means that the two drugs are administered to a subject such that they are both biologically active in the subject at the same time. The exact details of the administration will depend on the pharmacokinetics of the two substances in the presence of each other, and can include administering one substance within 24 hours, intermittently or as infrequent as weekly, of administration of the other. Design of suitable dosing regimens are routine for one skilled in the art. In particular embodiments, two drugs will be administered substantially simultaneously, i.e. within minutes of each other, or in a single composition that comprises both substances.

Accordingly, in a further embodiment of the present disclosure there is provided a method for predicting a potential for drug-drug interactions comprising:
(a) preparing a gene expression profile of a plurality of test cells that have been exposed to a first drug using the method of the disclosure;
(b) separately preparing a gene expression profile of the plurality of test cells that have been exposed to a second drug using the method of the disclosure; and
(c) quantitatively or qualitatively comparing the gene expression profiles from (a) and (b), wherein if the first and second drugs modulate the expression of at least one of the same genes in the plurality of test cells, then there exists a potential for drug-drug interactions between the first and second drugs.

If drug-drug interactions are found, then caution would need to be taken when determining effective drug therapies, including dosing, when the drugs are to be present in the body or cell at the same time.

The methods of the present disclosure may also be used to monitor the changes in the gene expression profile as a function of disease state. For example, a gene expression profile of a plurality of test cells may be obtained at one point in time and again at a later date. Changes in the gene expression profile may be indicative of changes in disease state, treatment response or treatment toxicity.

In further embodiments, the methods of the disclosure further comprise (a) generating a set of expression data from the detection of the amount of hybridization; (b) storing the data in a database; and (c) performing comparative analysis on the set of expression data, thereby analyzing gene expression.

In embodiments, the method of detecting gene expression in the plurality of test cells is performed once or more, over a set period of time and at specified intervals, to monitor and compare the levels of gene expression over that period of time.

The knowledge of rat gene expression profiles under the conditions noted above, for example, in the presence of a drug, in disease or when two or more drugs are to be administered contemporaneously, is particularly important when rats are used as a model system for human disease. As rats will not have all of the same genes as humans, it is important to know the potential mechanisms of adverse drug reactions or toxic drug effects in the model before the drug is applied in human treatment.

The above disclosure generally describes the present disclosure. A more complete understanding can be obtained by reference to the following specific examples. These examples are described solely for the purpose of illustration and are not intended to limit the scope of the disclosure. Changes in form and substitution of equivalents are contemplated as circumstances might suggest or render expedient. Although specific terms have been employed herein, such terms are intended in a descriptive sense and not for purposes of limitation.

The following non-limiting examples are illustrative of the present disclosure:

### EXAMPLES

### Example 1

### Sets of Primers and Resulting PCR Products for Each Cytochrome P450 (CYP), Nuclear Xenobiotic Receptor (NXR), ABC Transporter, SLC Transporter, Sulfotransferase (SULT) and UDP-Glucuronosyltransferase (UGT) Gene

### (a) Results:

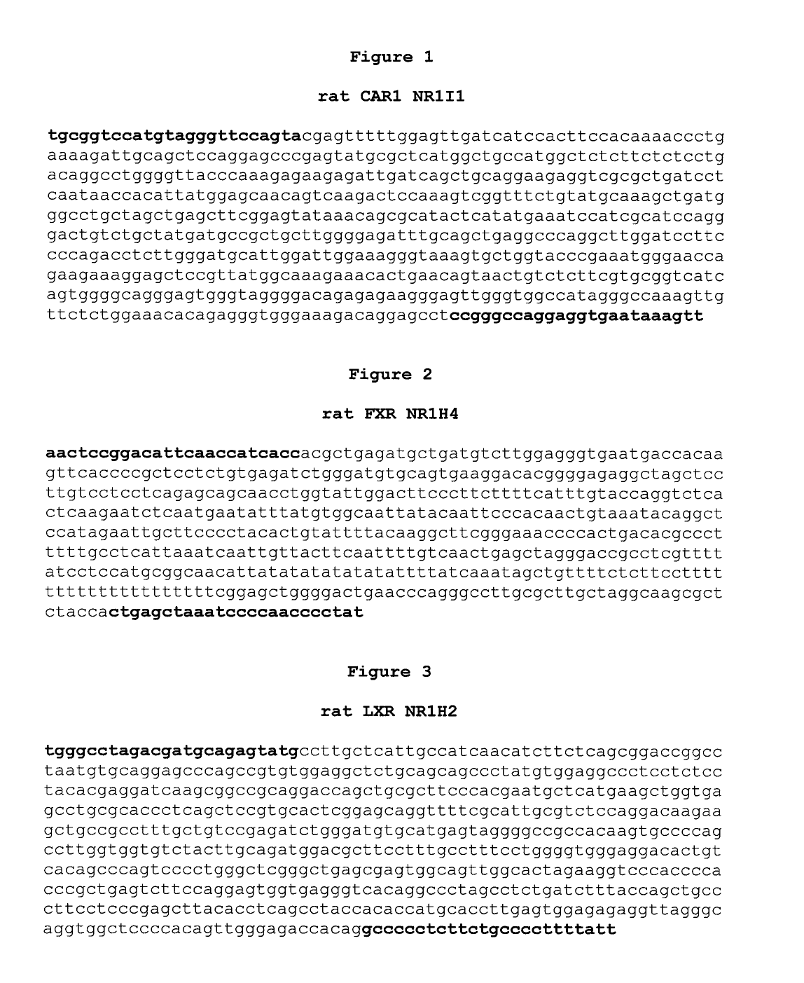

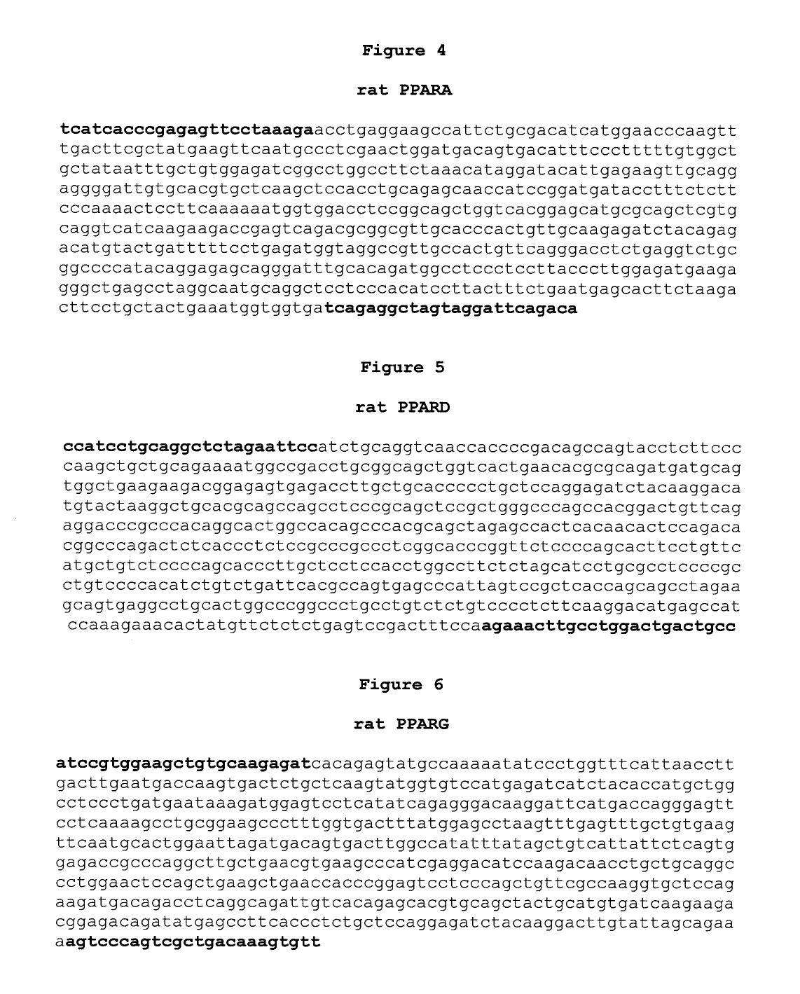

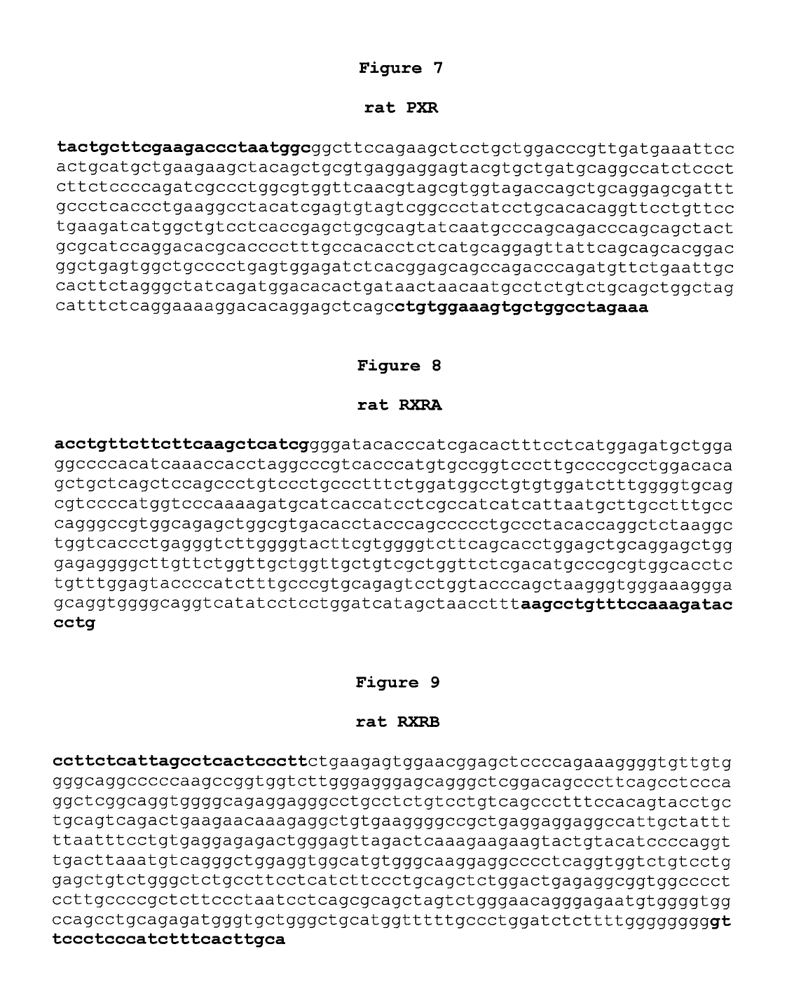

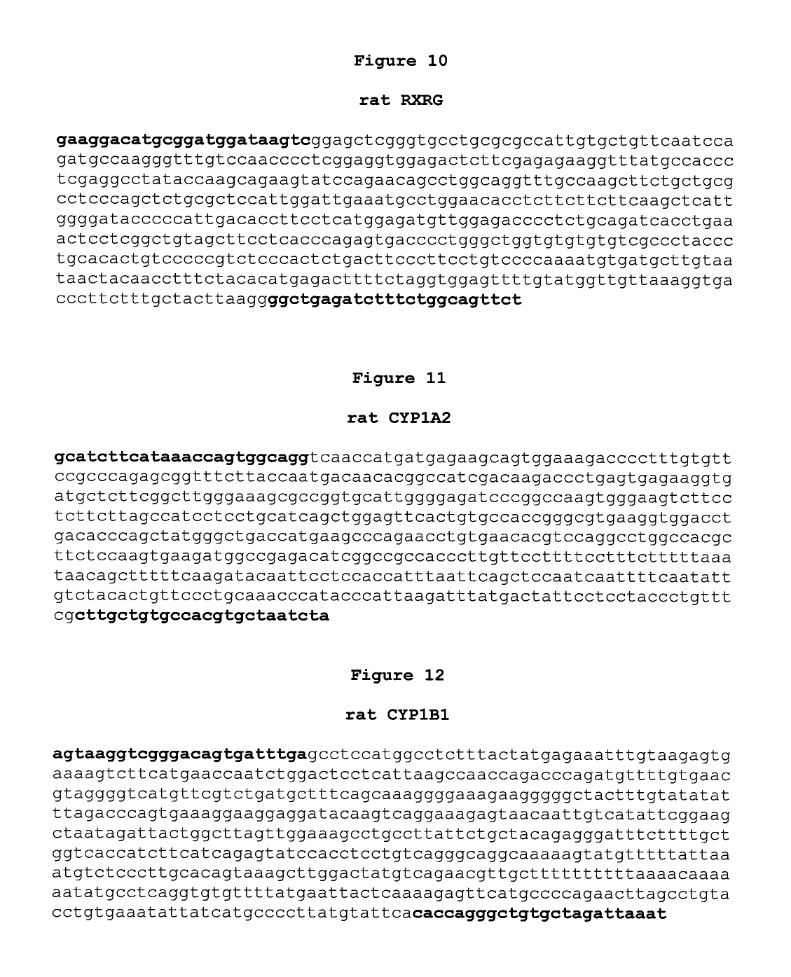

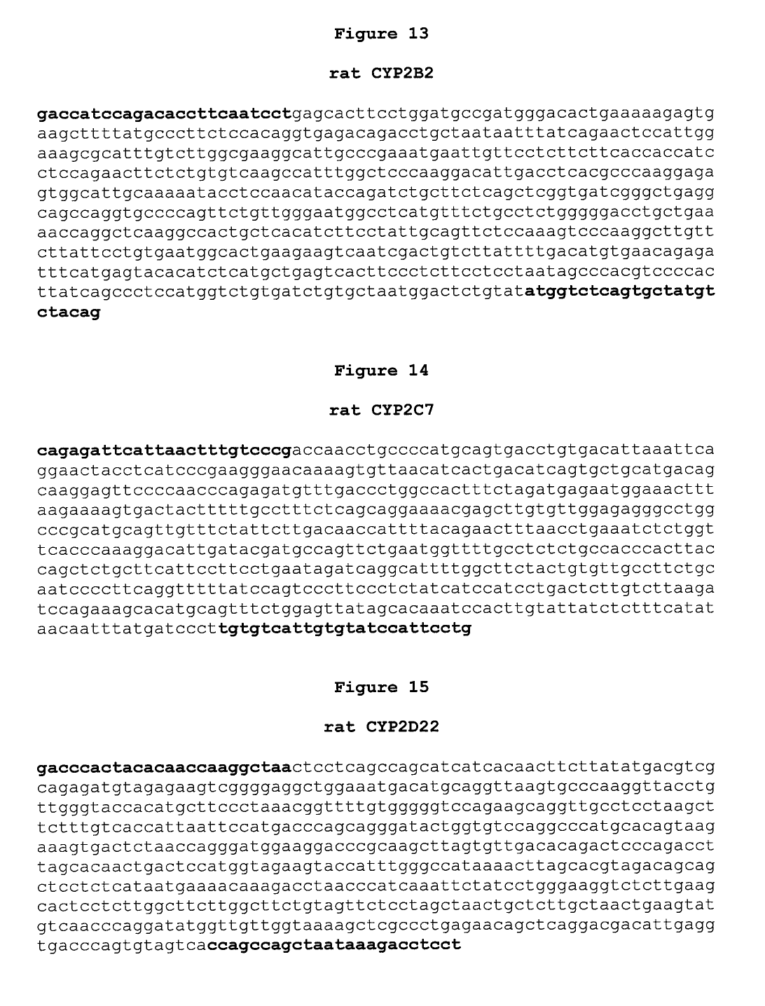

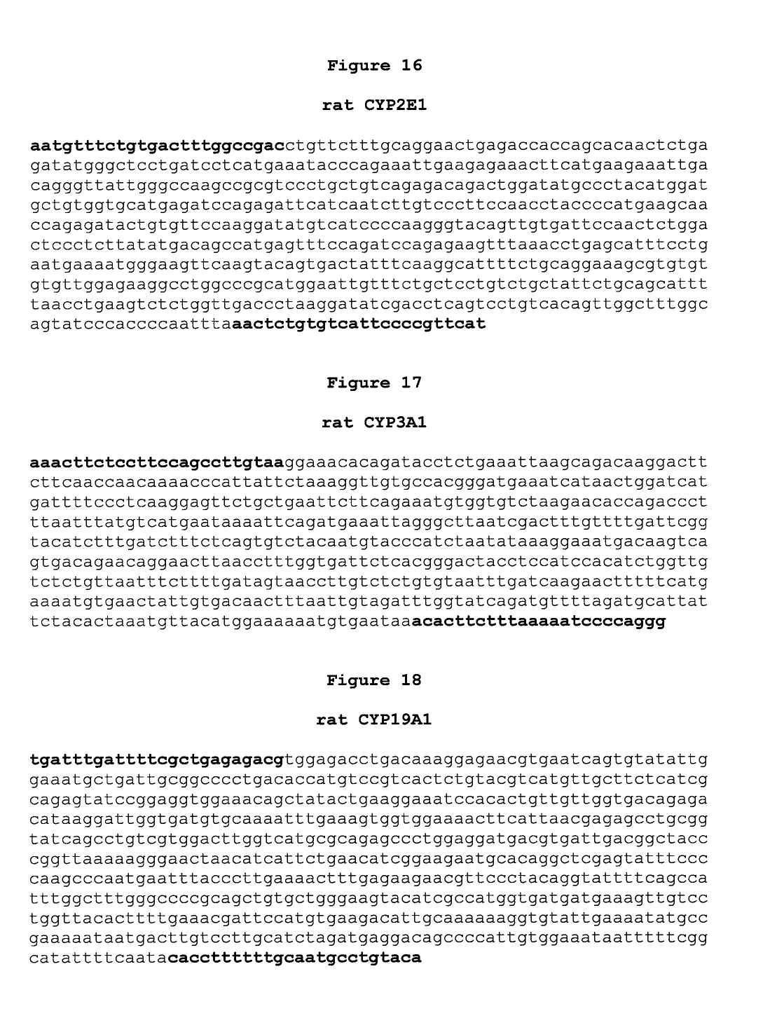

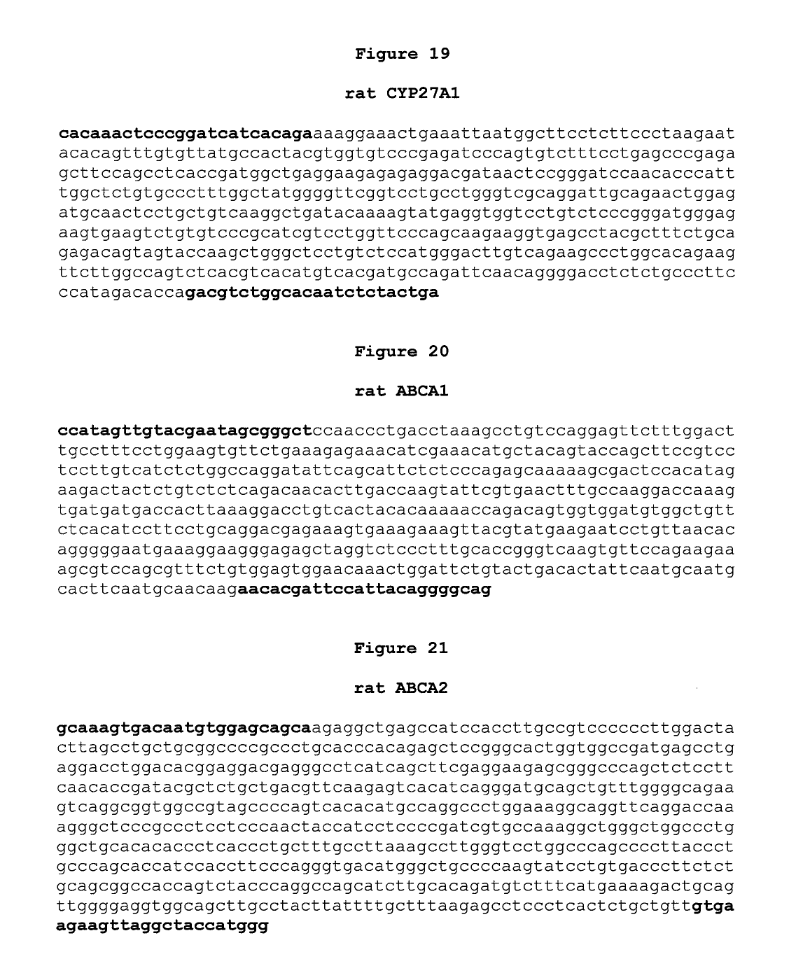

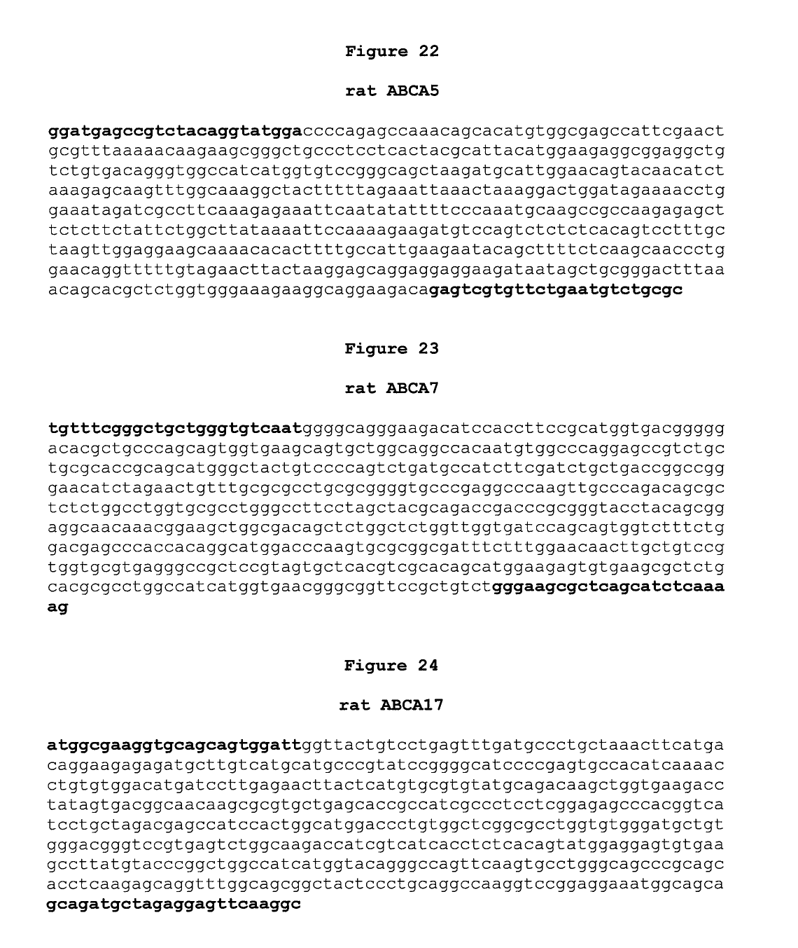

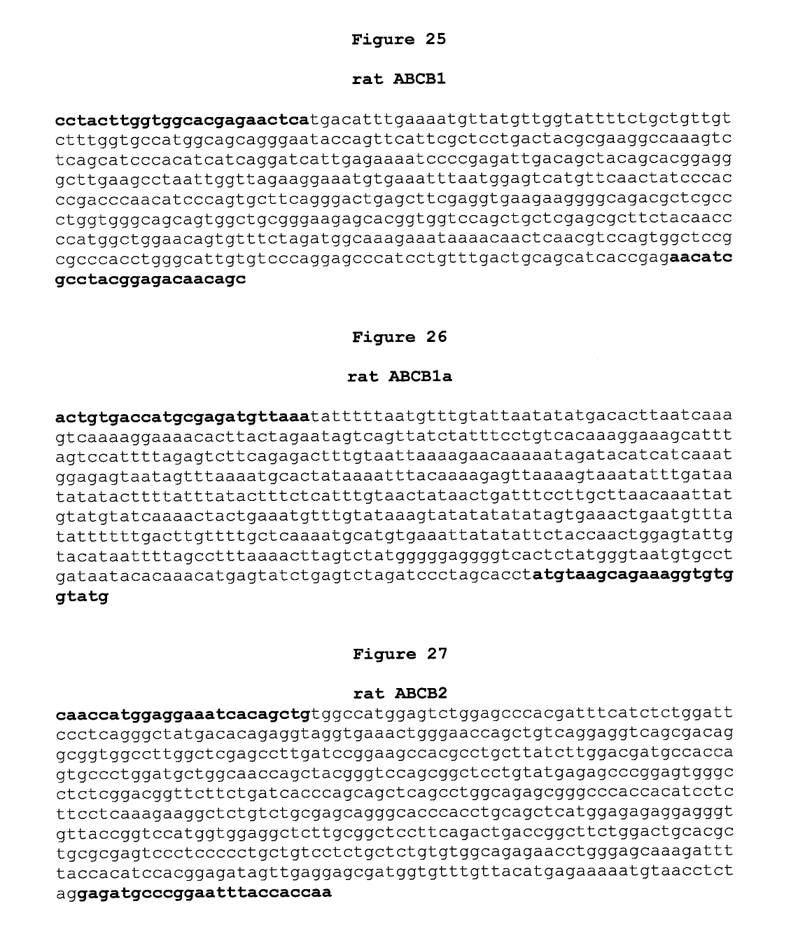

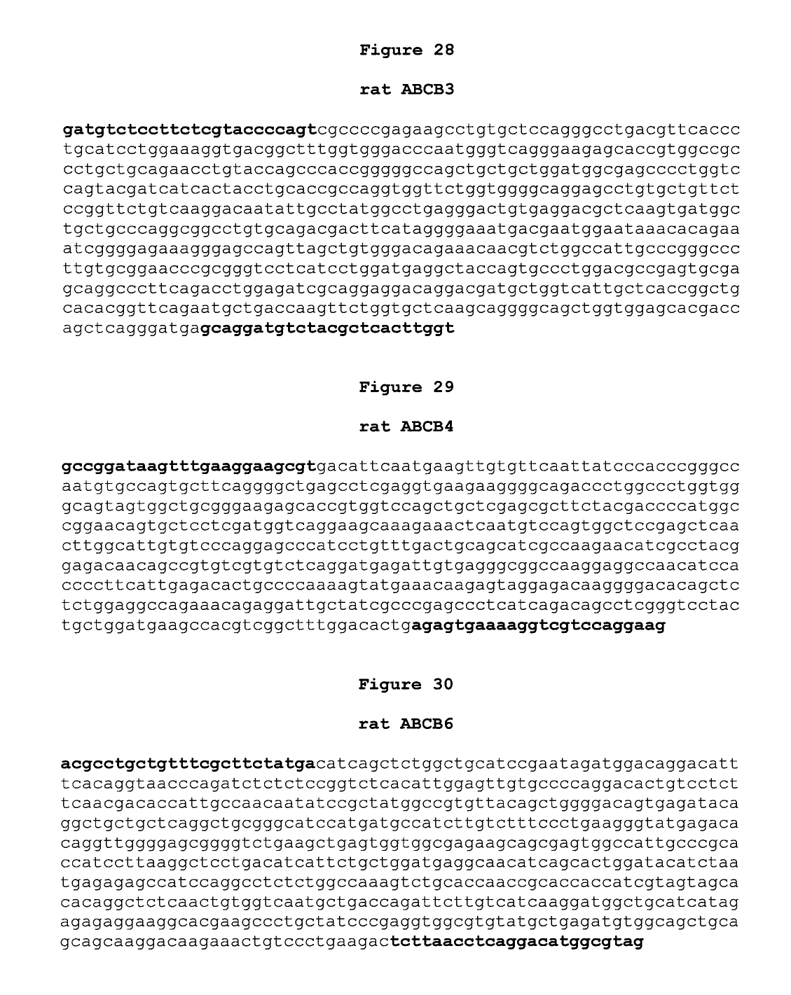

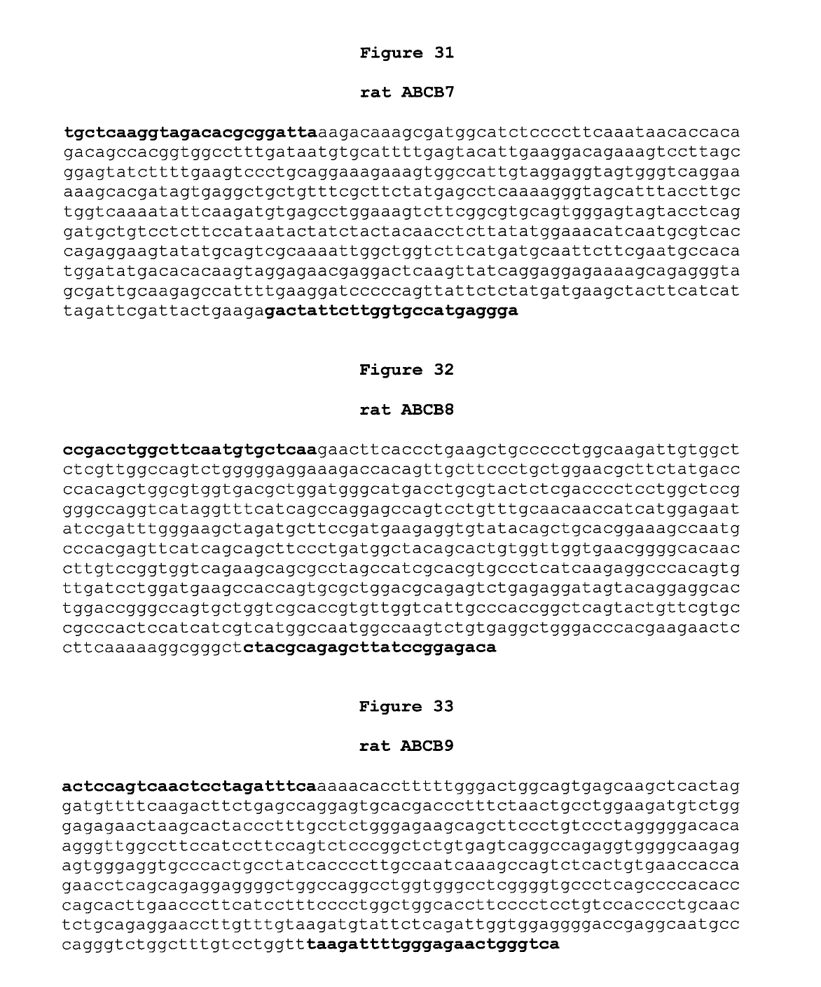

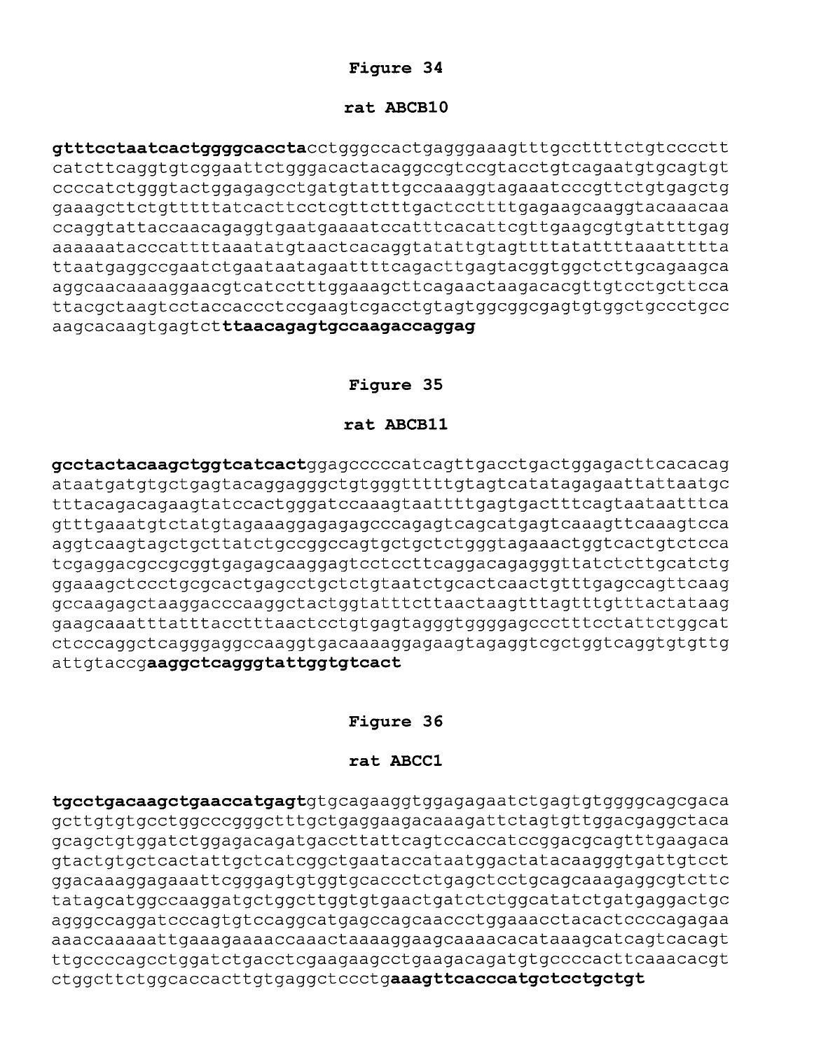

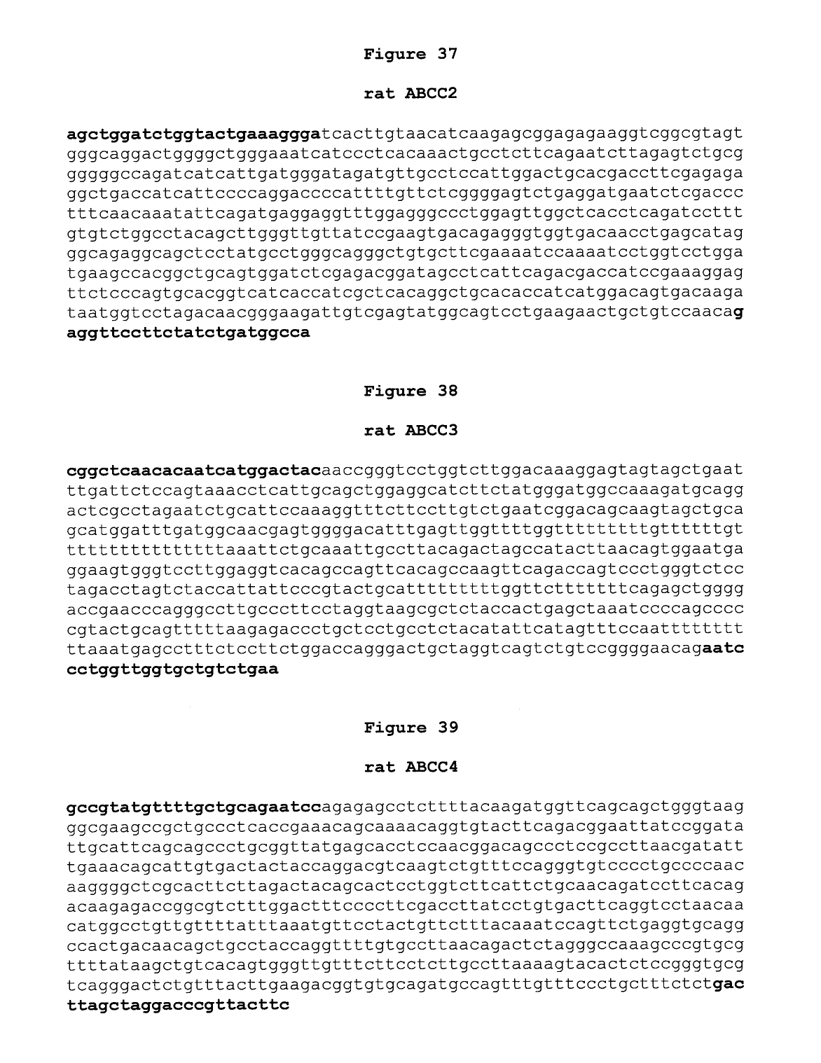

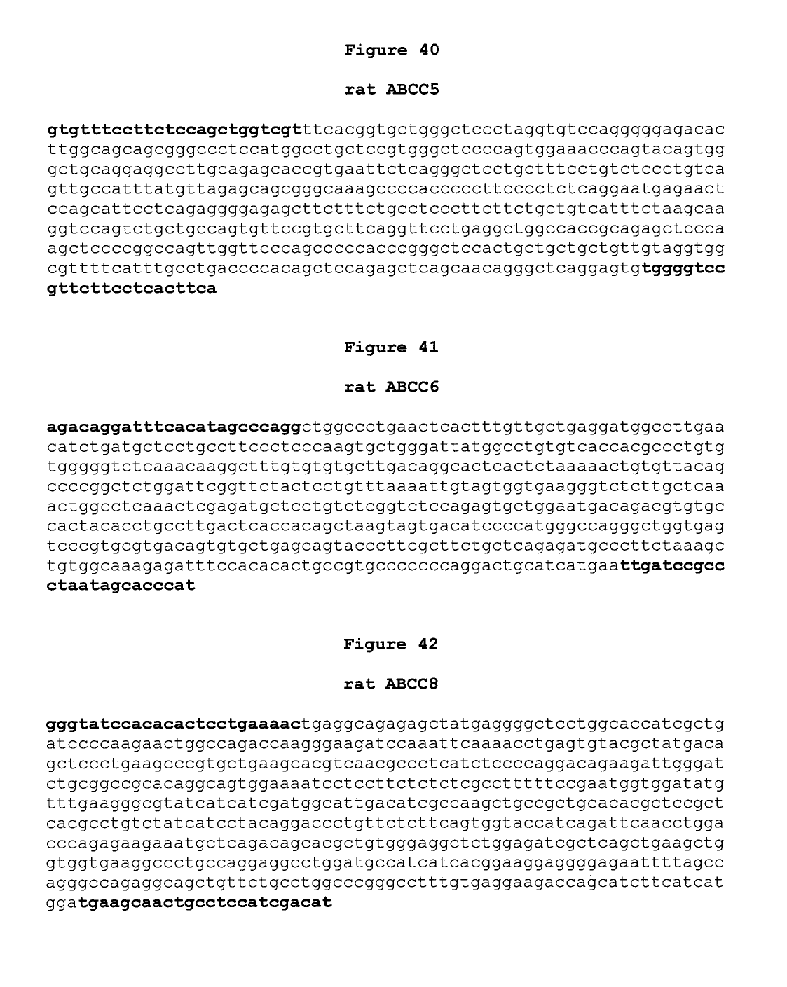

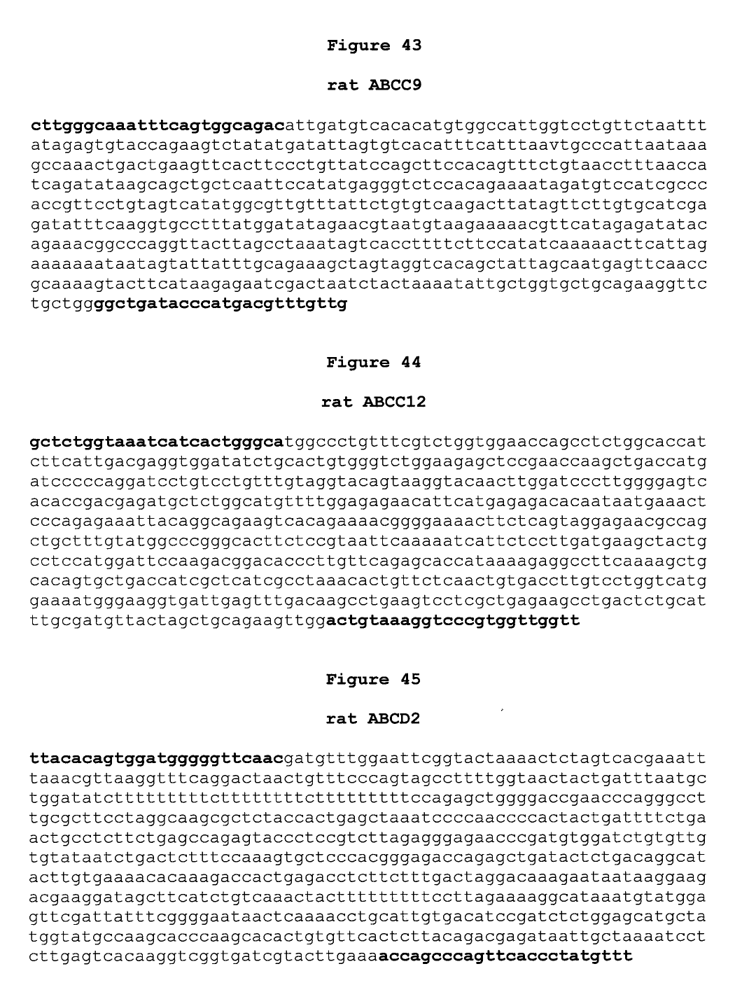

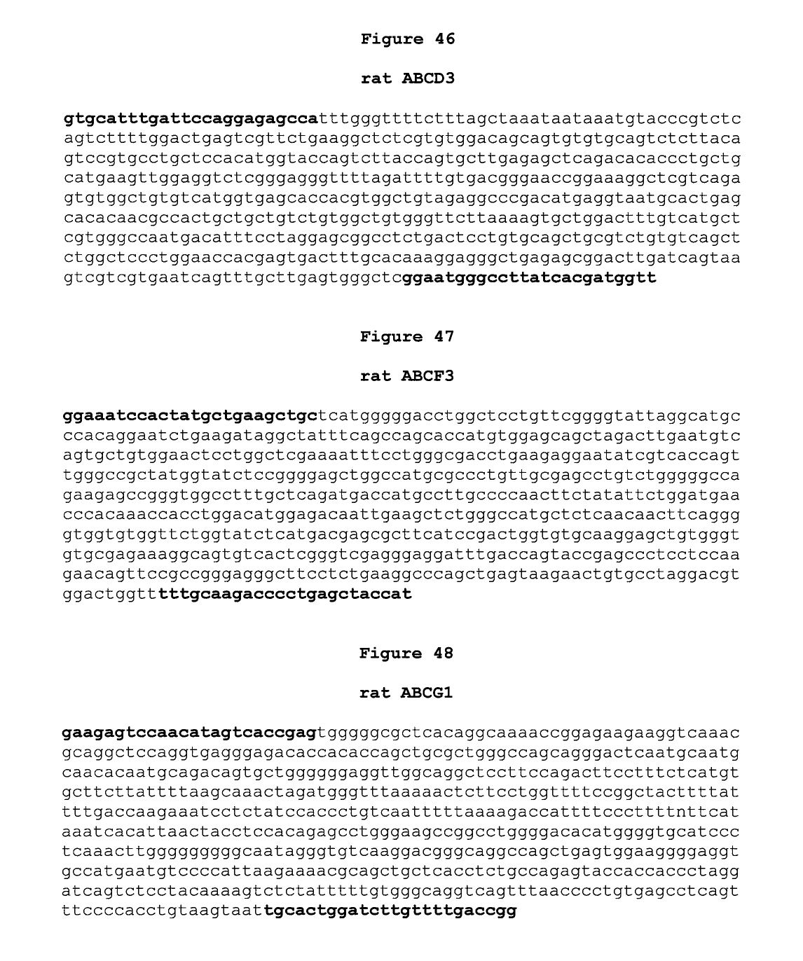

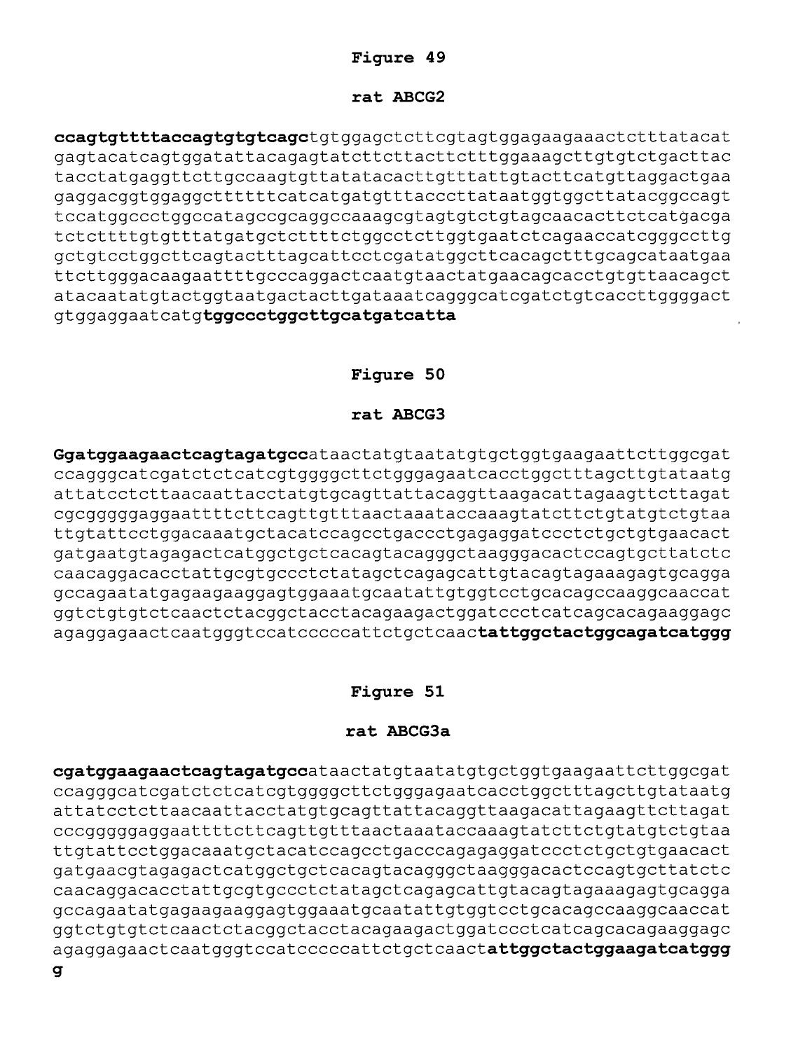

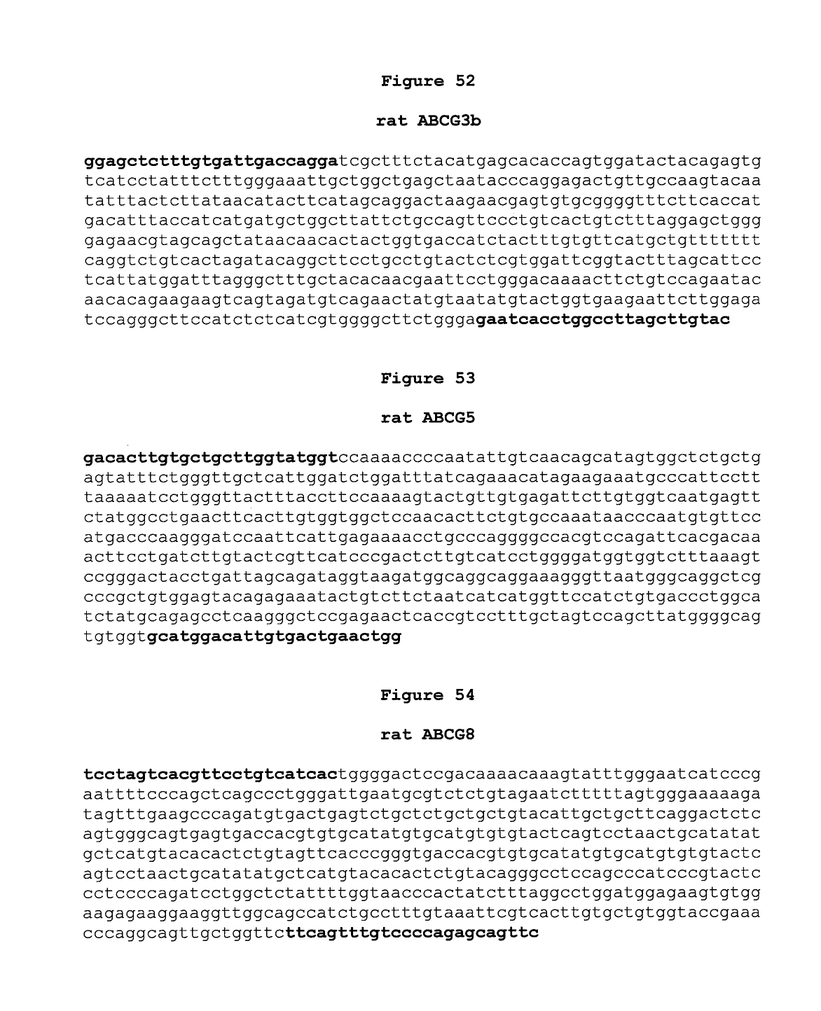

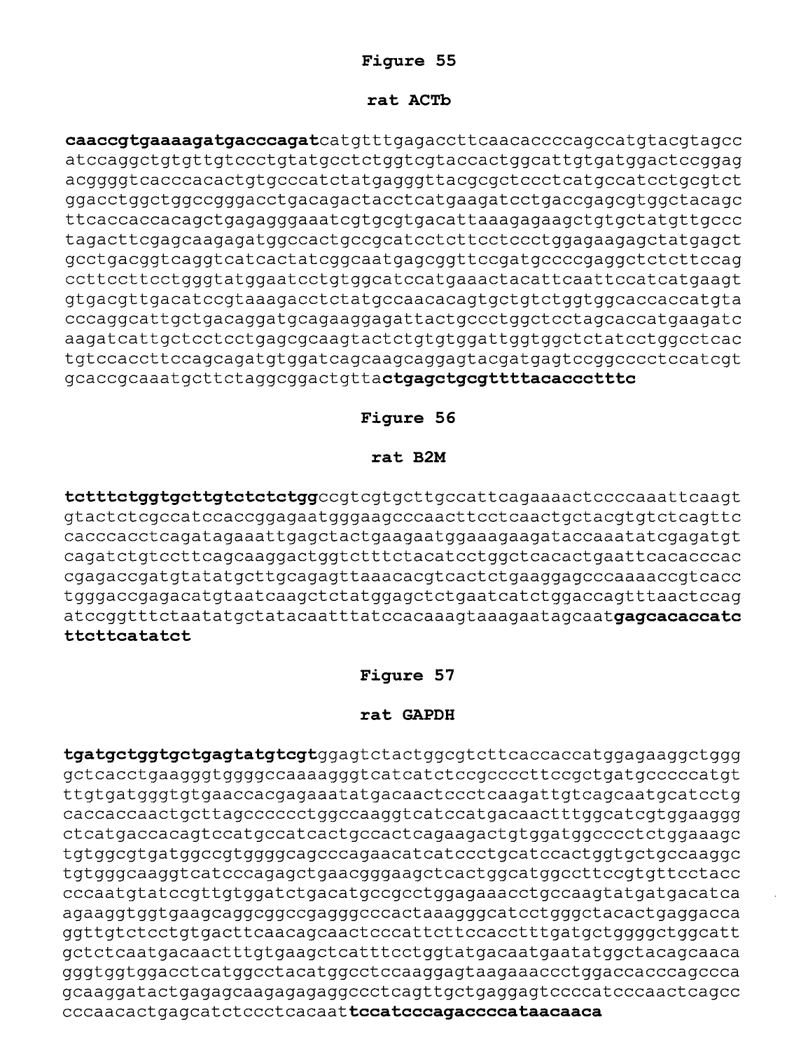

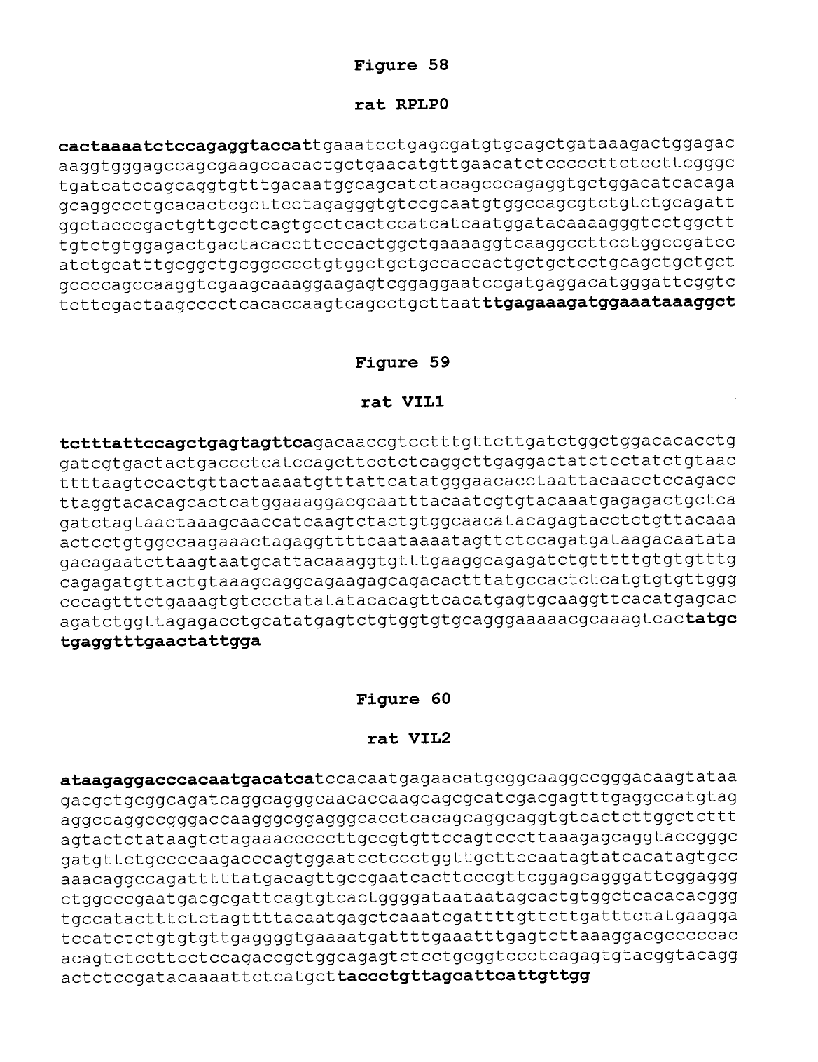

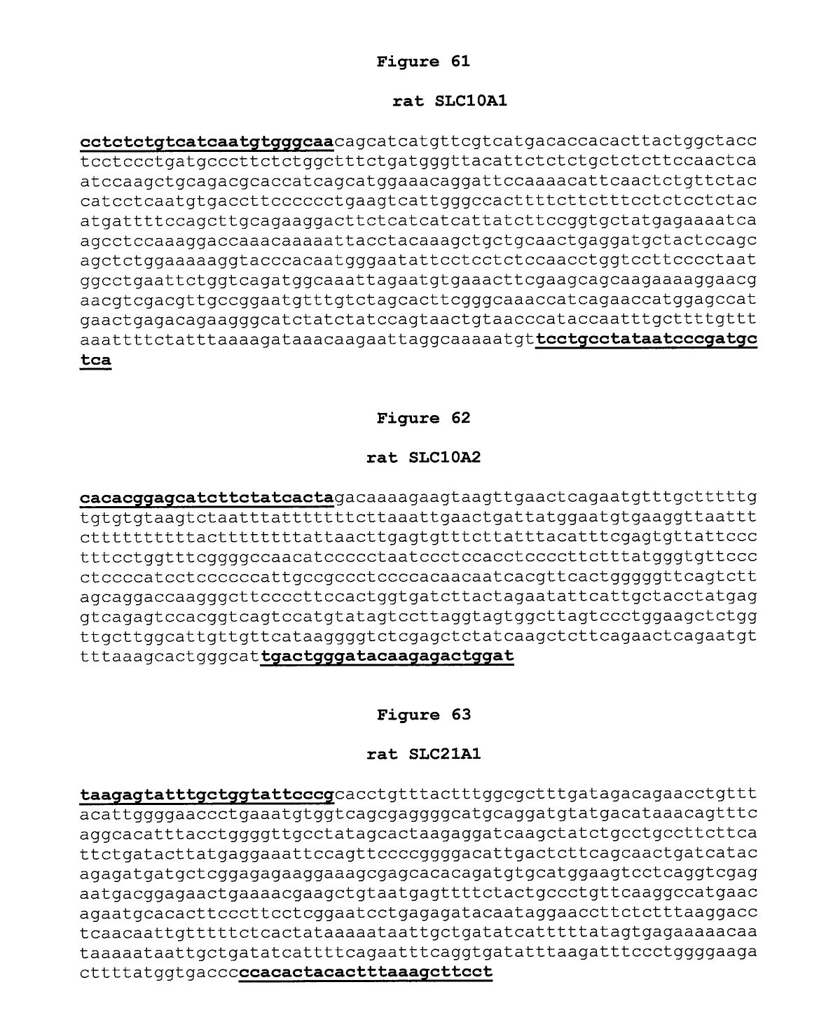

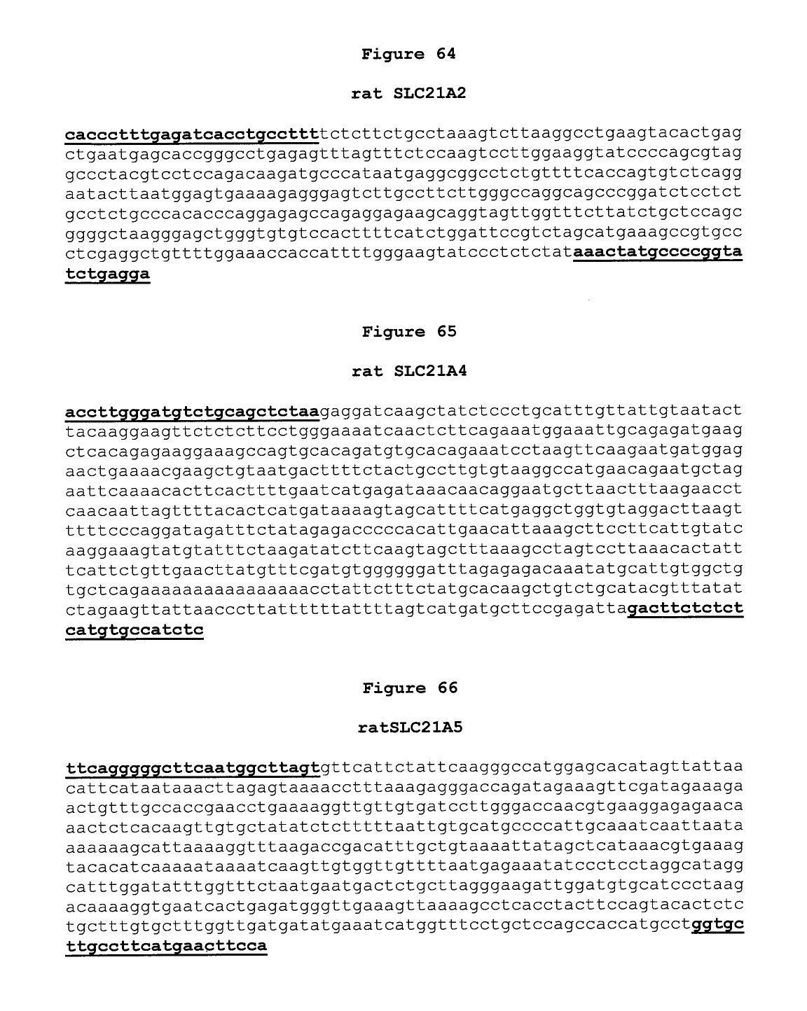

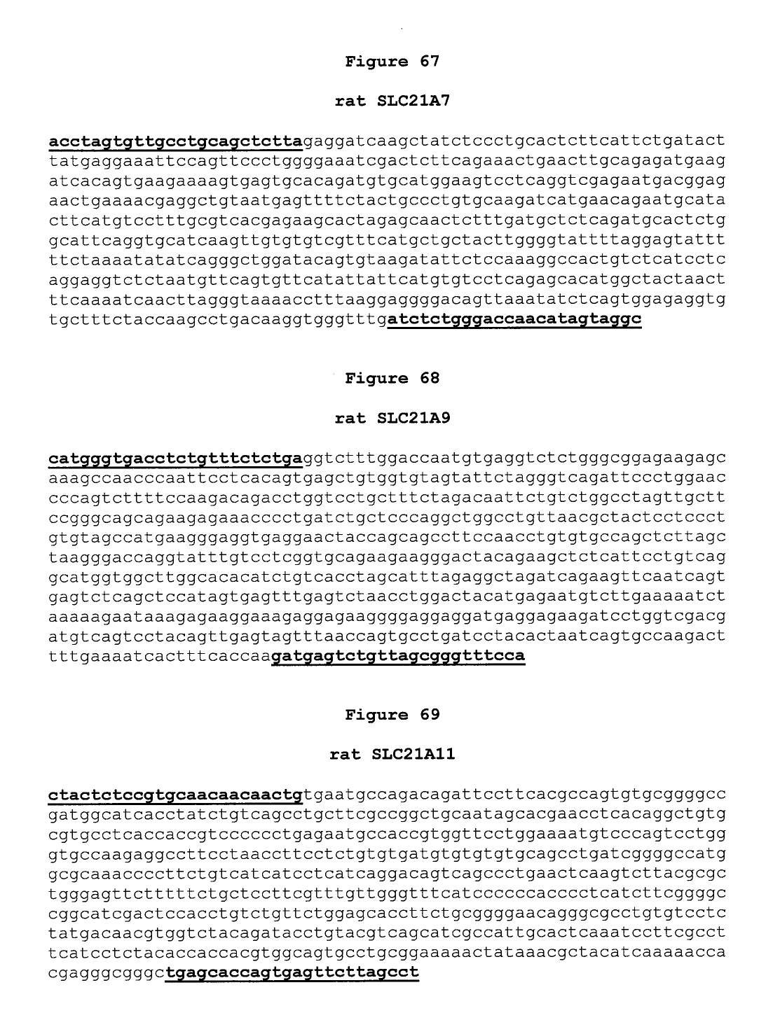

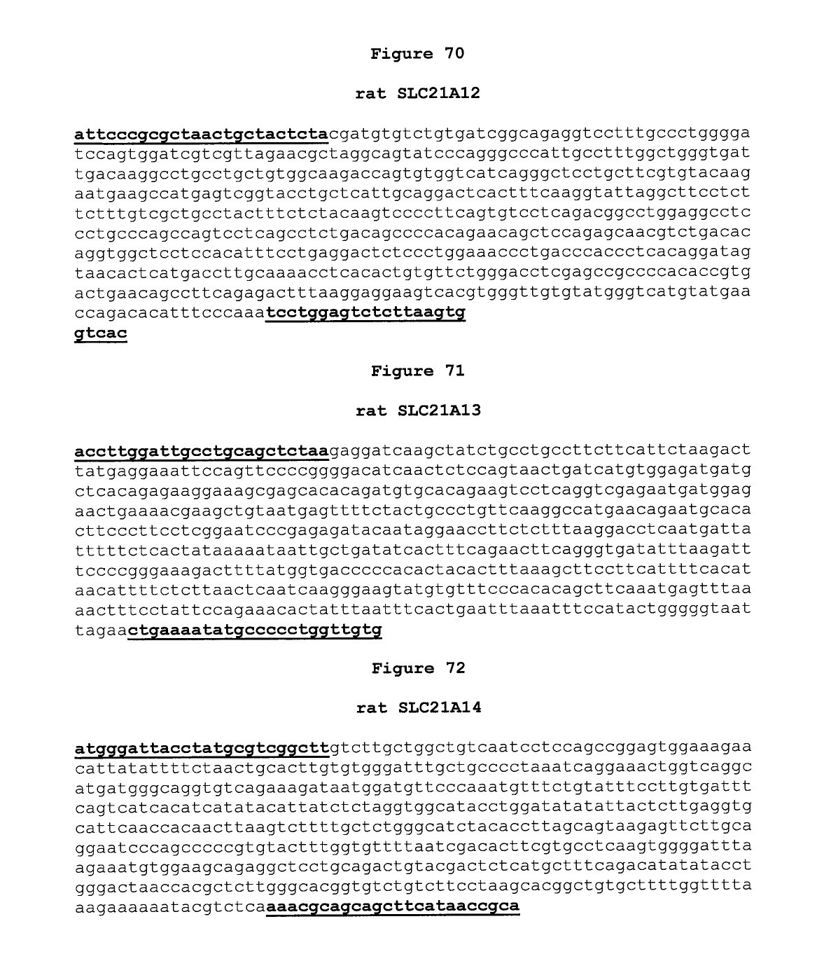

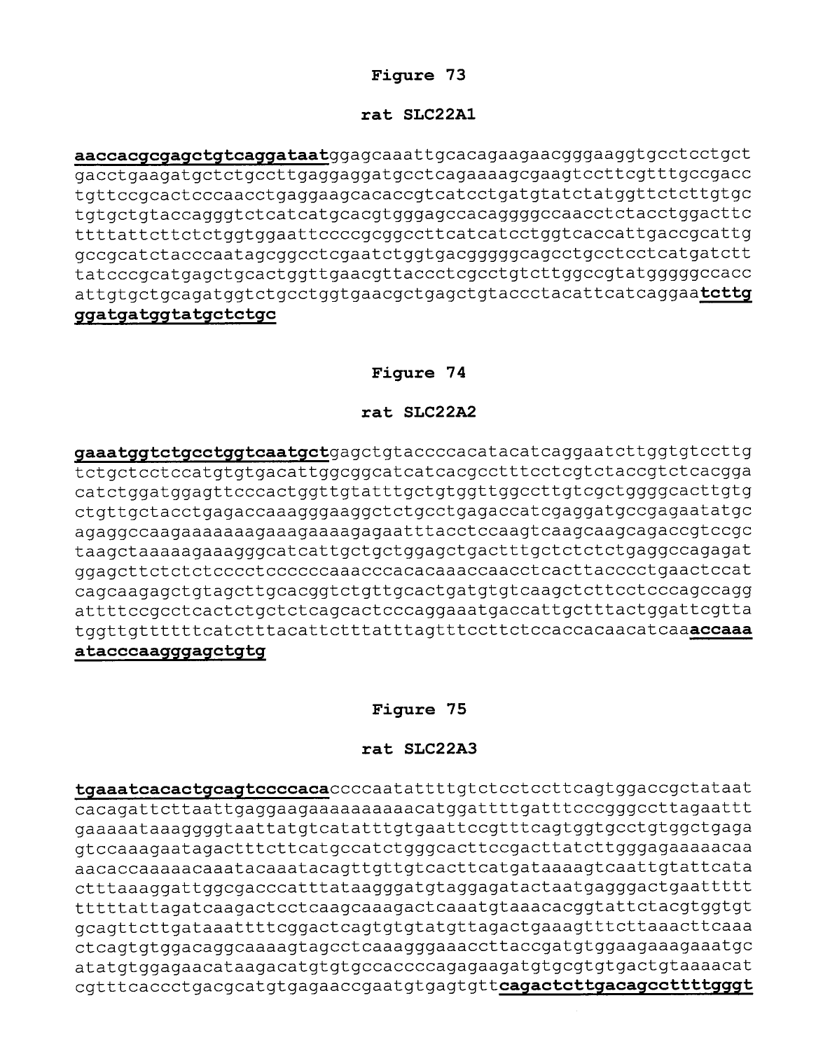

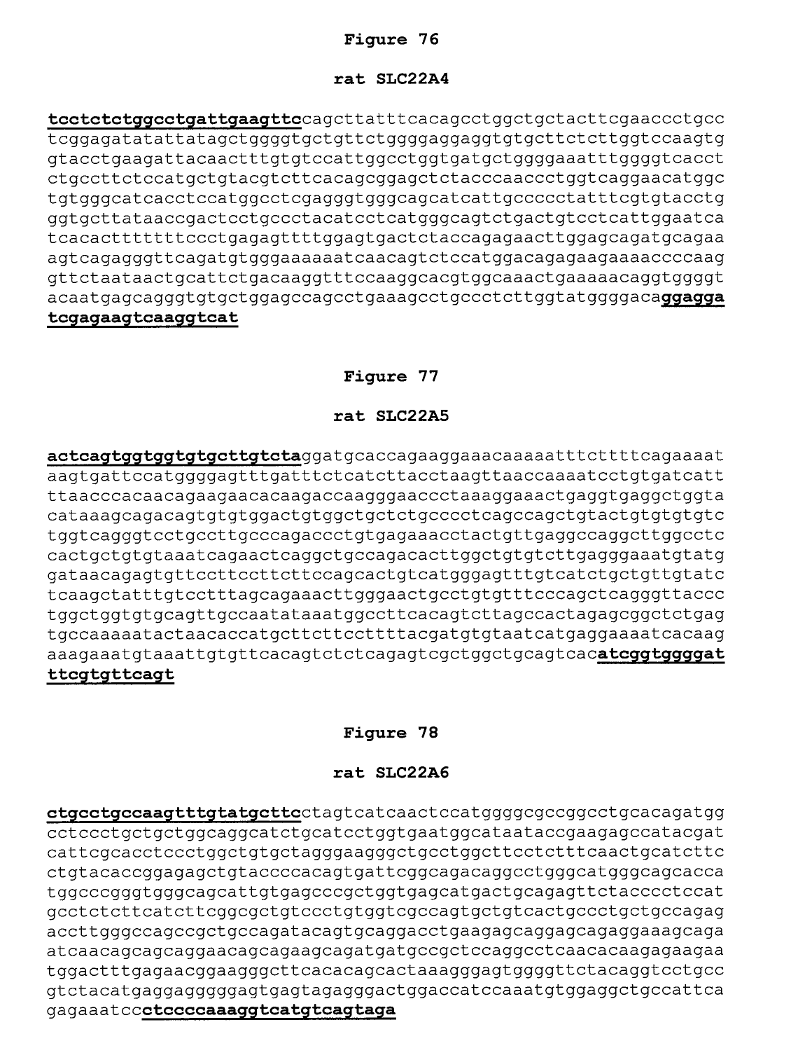

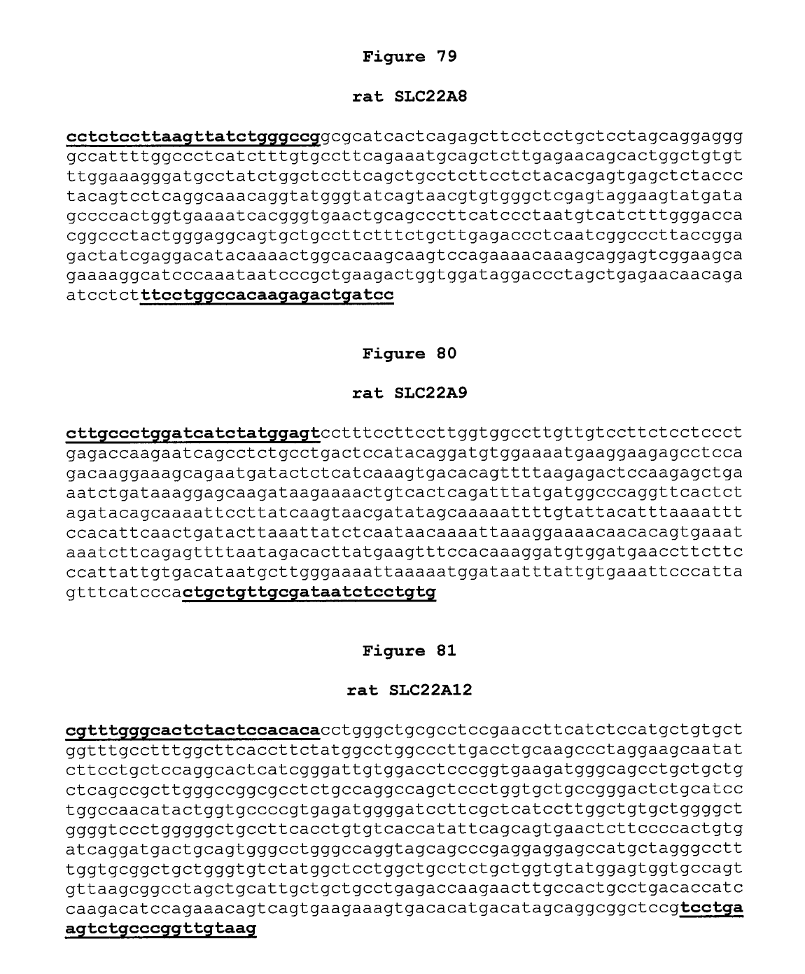

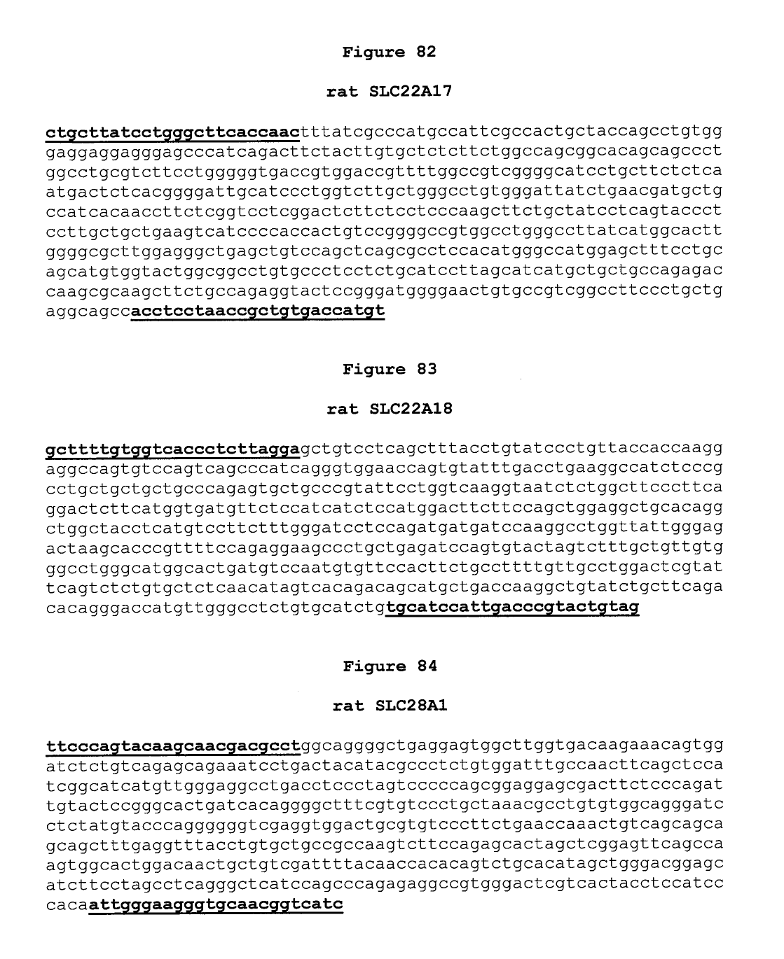

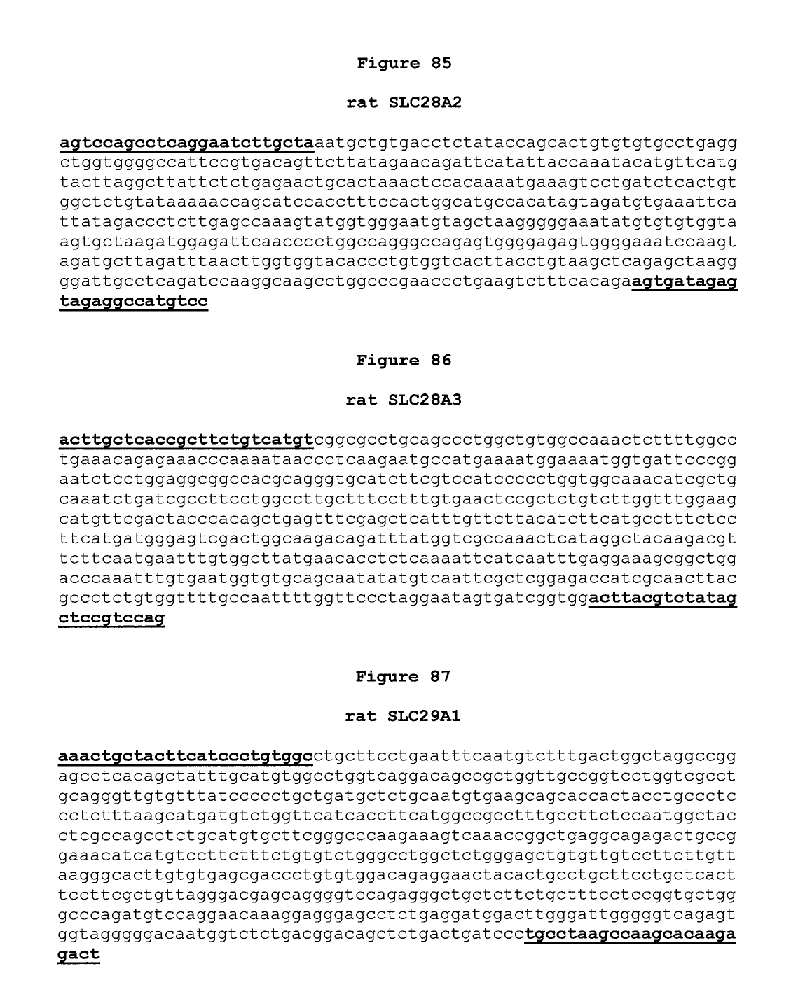

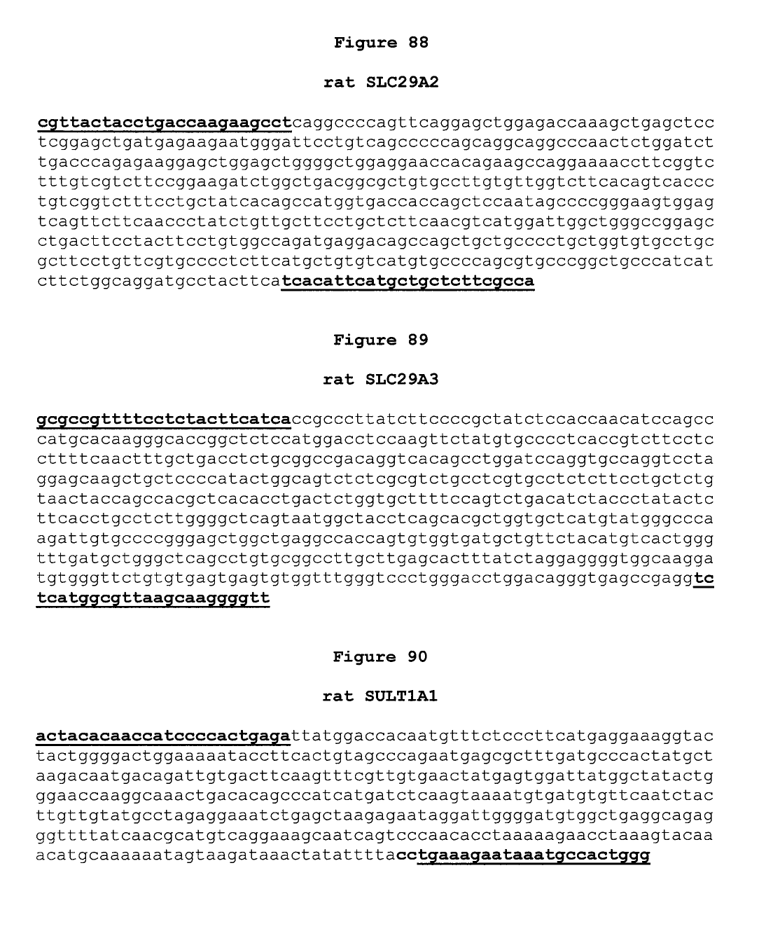

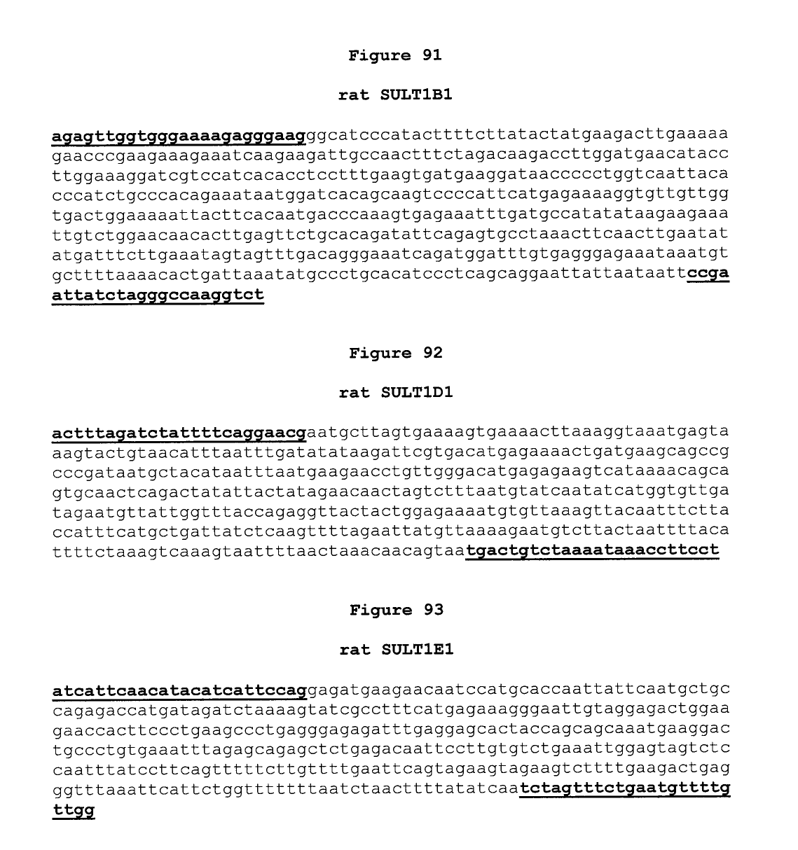

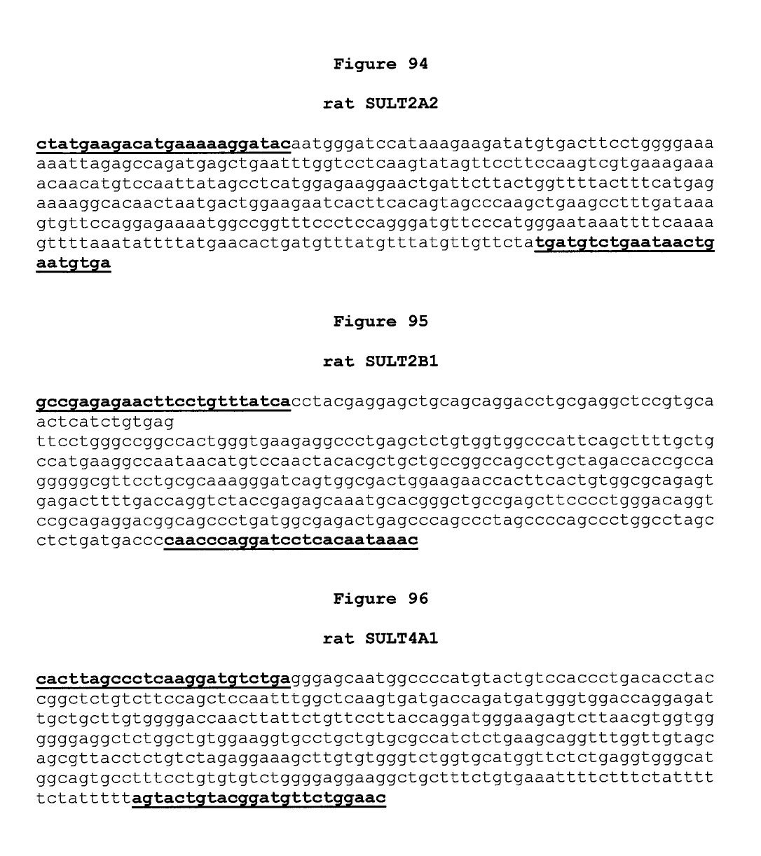

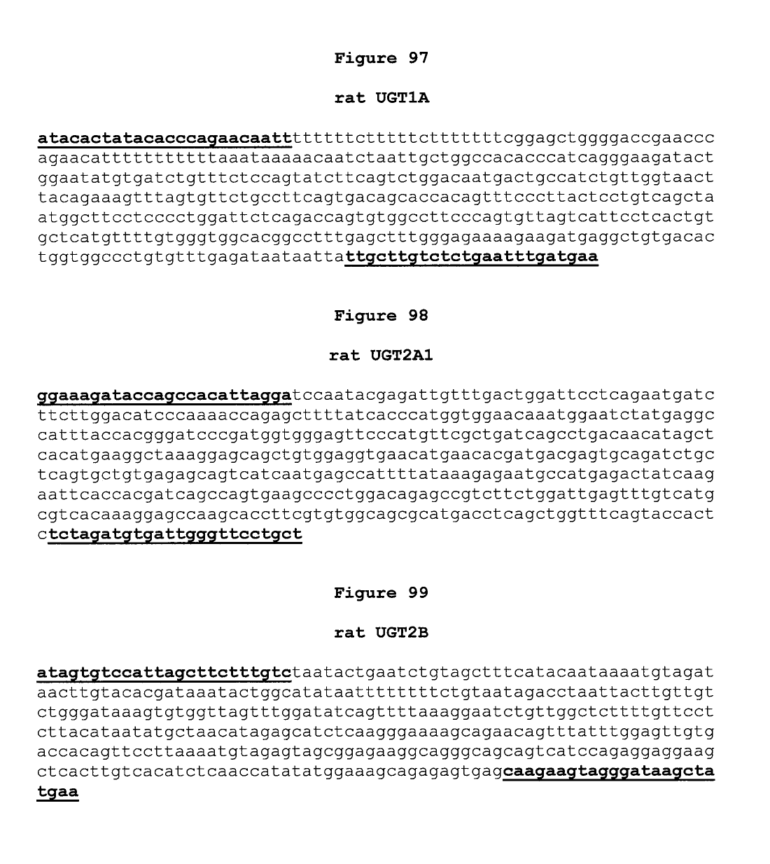

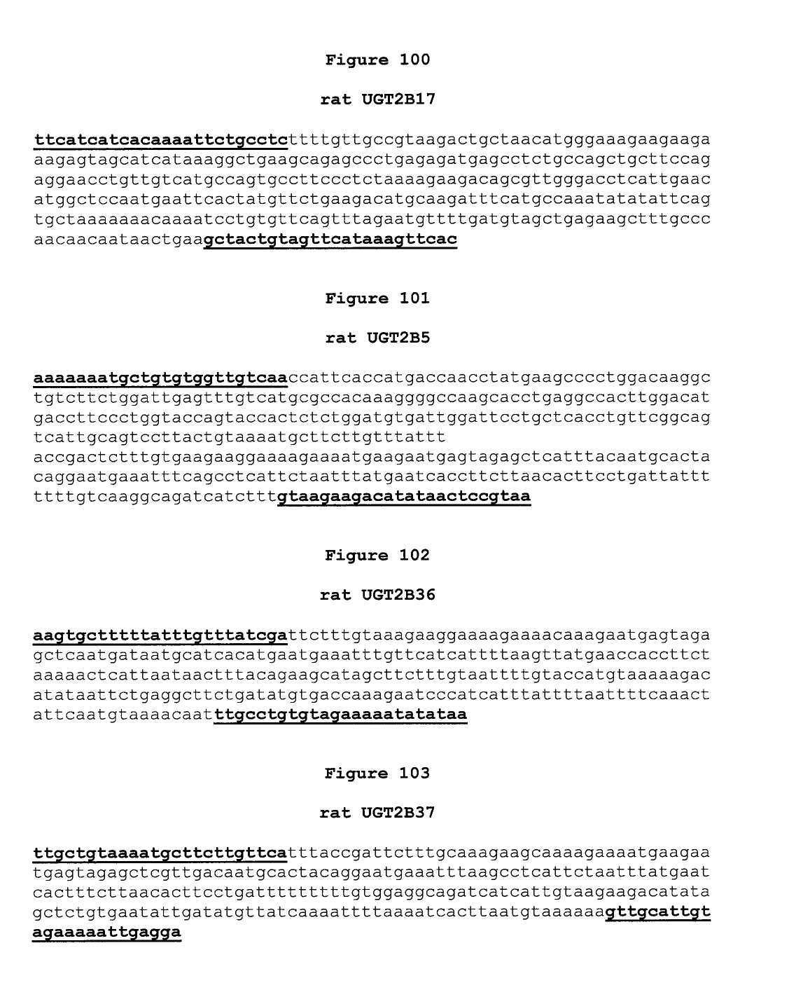

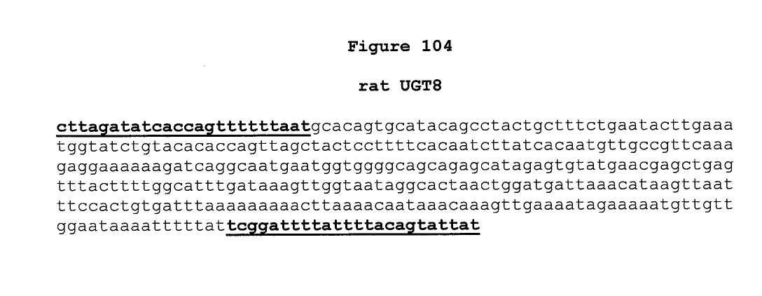

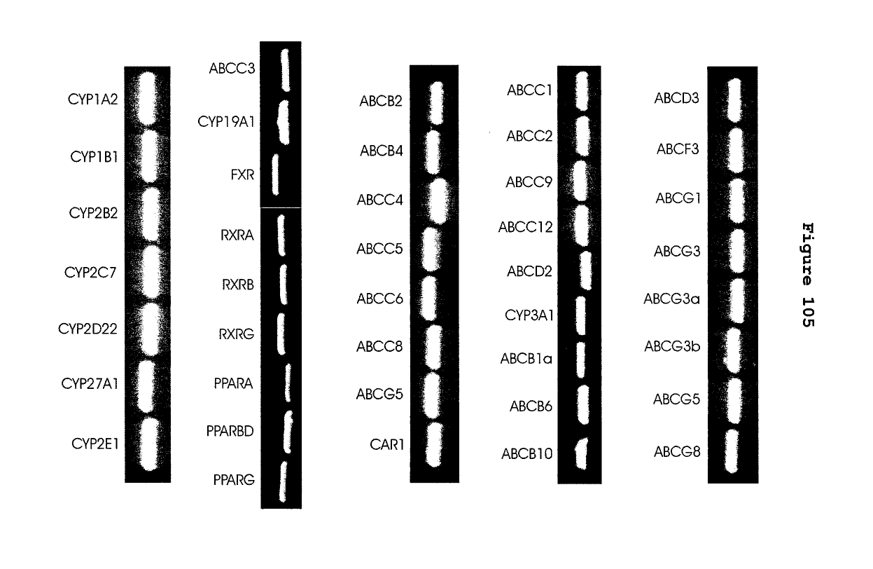

The sets of primers were designed such that the amplification product is a PCR amplicon that is a unique portion of a CYP, NXR, ABC Transporter, SLC Transporter, SULT or UGT gene. FIGS. 1-104 show the nucleic acid sequences of each PCR amplicon. The primers are shown in bold.

The NCBI and BCM search launcher websites were used to verify PCR primer identity with the CYP, NXR, ABC Transporter, SLC Transporter, SULT and UGT gene region of interest. BLAST sequence searches and alignment analyses were completed for each PCR primer pair and PCR amplicon to ensure minimum cross-hybridization with other known genes and other known CYP, NXR, ABC Transporter, SLC Transporter, SULT and UGT genes.

### (b) Total RNA Preparation

All rat tissue samples and cell lines were processed with TriZol reagent (Cat. No. 15596-018, Invitrogen Life Technologies) to lyse the sample and liberate the nucleic acids. The total RNA component of the nucleic acid lysate was isolated according to the manufacturer's instructions. Total RNA was quantitated by spectrophotometric analysis and OD₂₆₀ₙₘ:OD₂₈₀ₙₘ ratios.

(c) cDNA synthesis

cDNA was prepared from 20 μg of total RNA in a total volume of 40 μl. 20 μg of total RNA was added to a 200 μl RNase-free microcentrifuge tube and placed on ice. 4 μl of a 300 ng/μl solution of random primers (9mers, 12mers or 15mers, MWG-Biotech) was added to the tube containing the total RNA and the final volume made up to 22 μl with RNase-free dH₂O. The microcentrifuge tube was capped and then heated at 65° C. for 10 min in a thermal cycler (PTC200 DNA Engine, MJ Research). The microcentrifuge tube was then removed from the thermal cycler and placed on ice for 3 min. The microcentrifuge tube was spun in a microcentrifuge (C-1200, VWR Scientific Products) to collect the solution in the bottom of the microcentrifuge tube and placed on ice.

First-strand cDNA synthesis was accomplished with the SuperScript II RNase H-Reverse Transcriptase reagent set (Cat. No. 18064-014, Invitrogen Life Technologies). 8 μl 5× First-Strand Buffer [250 mM Tris-HCl pH 8.3, 375 mM KCl, 15 mM MgCl₂], 4 μl 100 mM DTT, 2 μl 10 mM dNTP Mix [10 mM each dATP, dCTP, dGTP, dTTP] were added to the microcentrifuge tube on ice. The microcentrifuge tube was capped and then heated at 25° C. for 10 min in a thermal cycler. The microcentrifuge tube was then heated at 42° C. for 2 min in a thermal cycler. The microcentrifuge tube was uncapped and left in the thermal cycler. 2 μl SuperScript II (200 U/μl) was added to the solution in the microcentrifuge tube and mixed with the micropipette tip. The microcentrifuge tube was recapped and incubated at 42° C. for 60 min in a thermal cycler. Subsequent to this incubation the microcentrifuge tube was heated at 70° C. for 15 min in a thermal cycler. The microcentrifuge tube was then removed from the thermal cycler and spun in a microcentrifuge to collect the solution in the bottom of the microcentrifuge tube and then returned to the thermal cycler. 1 μl of RNase H (2 U/μl) was added to the cDNA synthesis reaction and incubated at 37° C. for 20 min in a thermal cycler. The first-strand cDNA synthesis reaction was then stored at −20° C. until required for RT-PCR.

### (d) RT-PCR

RT-PCR was performed in a final volume of 25 μl. 2 μl of the first-strand cDNA synthesis reaction was added to a 200 μl microcentrifuge tube and placed on ice. 2 μl of a specific CYP, NXR, ABC Transporter, SLC Transporter, SULT or UGT gene primer pair mix [10 μM each forward PCR primer and reverse PCR primer], 2.5 μl 10×PCR Buffer [200 mM Tris-HCl pH 8.4, 500 mM KCl], 0.75 μl 50 mM MgCl₂, 0.5 μl 10 mM dNTP Mix [10 mM each dATP, dCTP, dGTP, dTTP], 16.25 μl dH₂O and 1 μl Taq polymerase (5 U/ul) were added to the side of the microcentrifuge tube. The reagents were mixed and collected in the bottom of the microcentrifuge tube by spinning the capped microcentrifuge tube in a microcentrifuge. The capped microcentrifuge tube was then placed in a thermal cycler block with a heated lid (PTC200 DNA Engine, MJ Research), both pre-heated to 95° C., and incubated at this temperature for 5 min. After this initial denaturation step 40 cycles of PCR amplification were performed as follows: Denature 95° C. for 30s, Anneal 60° C. for 30s, Extend 72° C. for 60s. Following the final 72° C. Extend step the PCR was incubated for an additional 10 min at 72° C. The PCR was then maintained at a temperature of 15° C. PCR products were stored at −20° C. until needed.

### (e) PCR Amplicon Purification

CYP, NXR, ABC Transporter, SLC Transporter, SULT and UGT gene RT-PCR amplification products (PCR amplicons) were analysed by electrophoresis at 150V for 20 min in 1×TAE running buffer in an agarose gel [0.8% agarose, 1×TAE, 0.5 μg/ml ethidium bromide] with 4 μl of a 250 bp DNA Ladder (Cat. No. 10596-013, Invitrogen Life Technologies) to permit size estimates of the PCR amplicons.

The CYP, NXR, ABC Transporter, SLC Transporter, SULT and UGT gene RT-PCR amplification products (PCR amplicons) were visualised “in gel” with a UV transilluminator (UVP M-15, DiaMed Lab Supplies) and photographed with a photo-documentation camera and hood (FB-PDC-34, FB-PDH-1216, Fisher Biotech), a #15 Deep Yellow 40.5 mm screw-in optical glass filter (FB-PDF-15, Fisher Biotech) and Polaroid Polapan 667 film.

The CYP, NXR, ABC Transporter, SLC Transporter, SULT and UGT gene RT-PCR amplification products (PCR amplicons) were isolated and purified from the CYP, NXR, ABC Transporter gene RT-PCR using the QIAquick PCR purification kit (Cat. No. 28104, QIAGEN Inc.) according to the manufacturer's instructions. In some cases the entire PCR was analysed by electrophoresis on an agarose gel [see below], the PCR product of interest excised from the gel and the PCR product purified using the MinElute gel extraction kit (Cat. No. 28604, QIAGEN Inc.) according to the manufacturer's instructions. After purification, the CYP, NXR and ABC Transporter gene RT-PCR amplification products (PCR amplicons) were analysed by electrophoresis at 150V for 20 min in 1×TAE running buffer in an agarose gel [0.8% agarose, 1×TAE, 0.5 ug/ml ethidium bromide] with 4 μl of a Low DNA Mass Ladder (Cat. No. 10068-013, Invitrogen Life Technologies) to permit PCR amplicon sizing and quantitation.

FIG. 105 shows the rat CYP, NXR and ABC Transporter gene RT-PCR amplification products from various rat tissue total RNA (brain, kidney, liver, lung) samples.

### Example 2

### Verification of rat CYP, NXR, ABC Transporter Gene Clone by DNA Sequencing

The sequences of the cloned PCR amplicons, which are each unique portions of each of the known rat CYP, NXR, ABC Transporter, SLC Transporter, SULT and UGT genes, were verified.

### (a) CYP, NXR, ABC Transporter Gene PCR Amplicon Cloning and Sequencing

A number of the purified CYP, NXR, ABC Transporter, SLC Transporter, SULT and UGT gene RT-PCR amplification products (PCR amplicons) were cloned into pCR4-TOPO vectors using the TOPO TA Cloning Kit for Sequencing (Cat. No. K4575-40, Invitrogen Life Technologies) according to the manufacturer's instructions to verify the sequence of the purified CYP, NXR, ABC Transporter, SLC Transporter, SULT or UGT gene PCR amplicon.

DNA sequence analysis was performed by MWG-Biotech. Sequence files from each clone were verified by comparison to the NCBI nucleotide database.

### Example 3

### DNA Microarray

(a) CYP, NXR, ABC Transporter, SLC Transporter, SULT and UGT Gene microarray (Rat DTEx™ microarray)

2 μg of each of the purified CYP, NXR, ABC Transporter, SLC Transporter, SULT and UGT gene vector-PCR amplification products (PCR amplicons) and 6 purified positive control vector-PCR amplification products (PCR amplicons) were aliquotted into individual wells of a CoStar SeroCluster 96 well U-bottom polypropylene microwell plates (source plates). The source plates was placed in a Speed-Vac concentrator (SPD101B, Savant Instruments Inc.) and dried under vacuum for 1 hour at 45° C. The dry RT-PCR amplification products (PCR amplicons) in the source plates were resuspended in 20 μl 1× Schott Nexterion Spot buffer (Cat. No. 1066029), sealed with mylar sealing tape (Cat. No. T-2162, Sigma Chemical Company) and dissolved by shaking at 300 rpm for 1 hour at room temperature on a microplate shaker (EAS2/4, SLT Lab Instruments).

The source plates were then placed in a humidified (21-25° C., 45-60% RH) microarrayer cabinet (SDDC-2, ESI/Virtek Vision Corp./BioRad Laboratories Inc.). Each purified RT-PCR amplification product (PCR amplicon) was printed in quadruplicate on Schott Nexterion Slide E glass slides (Cat. No. 1064016) using Stealth micro-spotting pins (Cat. No. SMP5, TeleChem International Inc.). The 768 element microarrays were air-dried in the microarrayer cabinet for at least 4 hours. Printed microarrays were stored in 20 slide racks under vacuum until needed.

### Example 4

### Method for Detecting CYP, NXR, ABC Transporter, SLC Transporter, SULT and UGT Gene Expression Using a DNA Microarray

The CYP, NXR, ABC Transporter, SLC Transporter, SULT and UGT gene expression profile for several different cell lines was prepared using the rat DTEx™ DNA microarray.

### (a) Total RNA Preparation

All rat tissue samples and cell lines were processed with TriZol reagent (Cat. No. 15596-018, Invitrogen Life Technologies) to liberate the nucleic acids. The total RNA component of the nucleic acid lysate was isolated according to the manufacturer's instructions. Total RNA was quantitated by spectrophotometric analysis and OD₂₆₀ₙₘ:OD₂₈₀ₙₘ ratios.

(b) Fluorescent cDNA Target Preparation

Fluorescently labeled cDNA targets were prepared from each of the cell lines using 20 μg of total RNA in a total volume of 40 μl.

20 μg of total RNA was added to a 200 μl RNase-free microcentrifuge tube and placed on ice. 3 μl of a 1 nmole/μl solution of Cy5-labeled random nonamer primers (Cy5-9mers, MWG-Biotech) was added to the tube containing the total RNA and the final volume made up to 22 μl with RNase-free dH₂O. The microcentrifuge tube was capped and then heated at 65° C. for 10 min in a thermal cycler (PTC200 DNA Engine, MJ Research). The microcentrifuge tube was then removed from the thermal cycler and placed on ice for 3 min. The microcentrifuge tube was spun in a microcentrifuge (C-1200, VWR Scientific Products) to collect the solution in the bottom of the microcentrifuge tube and placed on ice.

First-strand cDNA synthesis was accomplished with the SuperScript II RNase H-Reverse Transcriptase reagent set (Cat. No. 18064-014, Invitrogen Life Technologies). 8 μl 5× First-Strand Buffer [250 mM Tris-HCl pH 8.3, 375 mM KCl, 15 mM MgCl₂], 4 μl 100 mM DTT, 2 μl 10 mM dNTP Mix [10 mM each dATP, dCTP, dGTP, dTTP], were added to the microcentrifuge tube on ice. The microcentrifuge tube was capped and then heated at 25° C. for 10 min in a thermal cycler. The microcentrifuge tube was then heated at 42° C. for 2 min in a thermal cycler. The microcentrifuge tube was uncapped and left in the thermal cycler. 2 ul SuperScript II (200 U/μl) was added to the solution in the microcentrifuge tube and mixed with the micropipette tip. The microcentrifuge tube was recapped and incubated at 42° C. for 60 min in a thermal cycler. Subsequent to this incubation the microcentrifuge tube was heated at 70° C. for 15 min in a thermal cycler. The microcentrifuge tube was then removed from the thermal cycler and spun in a microcentrifuge to collect the solution in the bottom of the microcentrifuge tube and then returned to the thermal cycler. 1 μl of RNase H (2 U/μl) was added to the cDNA synthesis reaction and incubated at 37° C. for 20 min in a thermal cycler. The fluorescently labeled cDNA targets were stored at −20° C. overnight before QIAquick column purification.

The fluorescently labeled cDNA targets were thawed and the total volume adjusted to 100 μl with dH₂O. Labeled cDNA targets were isolated and purified using the QIAquick PCR purification kit (Cat. No. 28104, QIAGEN Inc.) according to the manufacturer's instructions except that the final elution volume was adjusted to 150 μl. The purified cDNA target preparation was stored at −20° C. until required for microarray hybridization.

### (c) Rat DTEx™ Microarray Hybridization

The printed Rat DTEx™ microarray(s) was removed from storage under vacuum and placed in a 20 slide rack. The Rat DTEx™ microarray was then denatured by dipping the microarray slide into “boiled” dH₂O for 30s. The denatured Rat DTEx™ microarray was then placed in a polypropylene 5 slide mailer (Cat. No. 240-3074-030, Evergreen Scientific) and blocked in 1× Schott Nexterion Block E buffer (Cat. No. 1066071) for 15 minutes at 50° C. Pre-hybridized, blocked Rat DTEx™ microarrays were removed from this solution and placed in a new polypropylene 5 slide mailer (Cat. No. 240-3074-030, Evergreen Scientific) containing a solution of denatured, labeled cDNA targets from a specific cell line.

The labeled cDNA target preparation was thawed and the 150 μl added to 850 μl Schott Nexterion Hyb buffer (Cat. No. 1066075) in a 1.5 ml microcentrifuge tube and heated at 95° C. for 10 min. Following denaturation the microcentrifuge tube was spun briefly in a microcentrifuge to collect all the liquid. The denatured, labeled cDNA targets were then added to a polypropylene 5 slide mailer (Cat. No. 240-3074-030, Evergreen Scientific) that contained a pre-hybridized, blocked Rat DTEx™ microarray placed “array-side” down in the bottom-most slot of the 5 slide mailer. In this orientation the entire surface of the microarray slide is bathed in the hybridization buffer. 5 slide mailers containing the Rat DTEx™ microarrays were incubated on their sides, “array-side” down, in a 60° C. incubator for 15-18 h.

Hybridized Rat DTEx™ microarrays were removed from the 5 slide mailers with forceps and placed directly into a 20 slide rack in a slide wash box containing a 2×SSC, 0.2% SDS solution. Rat DTEx™ microarrays were incubated in this solution at room temperature for 15 min. The slide rack containing the Rat DTEx™ microarrays was then transferred to a slide wash box containing 2×SSC and incubated in this solution at room temperature for 15 min. Following this step the Rat DTEx™ microarrays were rinsed in 0.2×SSC at room temperature and air-dried by centrifugation at 1200 rpm.

### (d) Rat DTEx Microarray Image Acquisition and Data Analysis

Processed Rat DTEx™ microarrays were scanned using ScanArray software in a ScanArray Lite MicroArray Analysis System (GSI Lumonics Inc.) at a scan resolution of 10 μm, a laser setting of 90 and a PMT gain of 80. Images were analysed using QuantArray software (GSI Lumonics Inc.). The data generated from QuantArray was exported to GeneLinker Gold (Molecular Mining Inc./Predictive Patterns Software) for bioinformatic analysis and data mining. Gene expression profiles and hierarchical clustering maps (“heat maps” or “dendrograms”) were also generated using GeneLinker Gold.

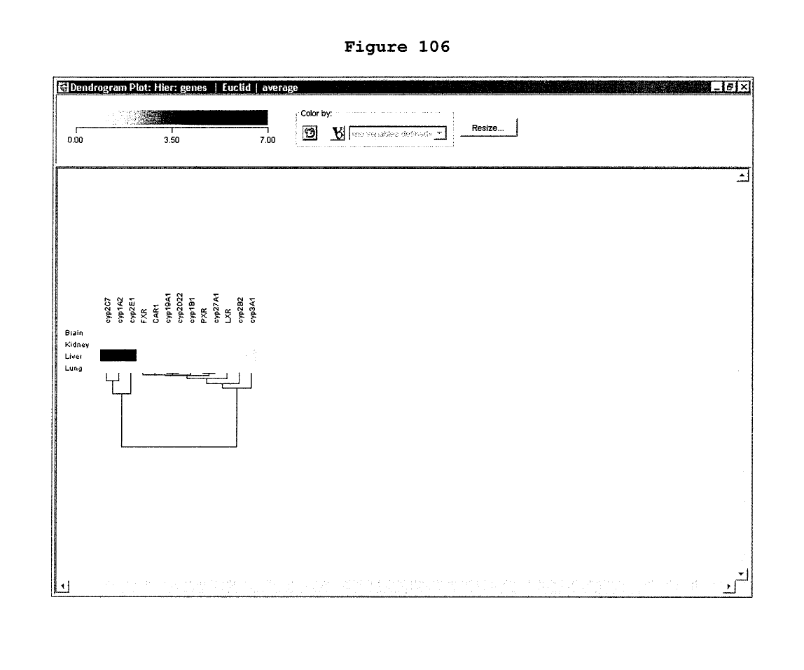

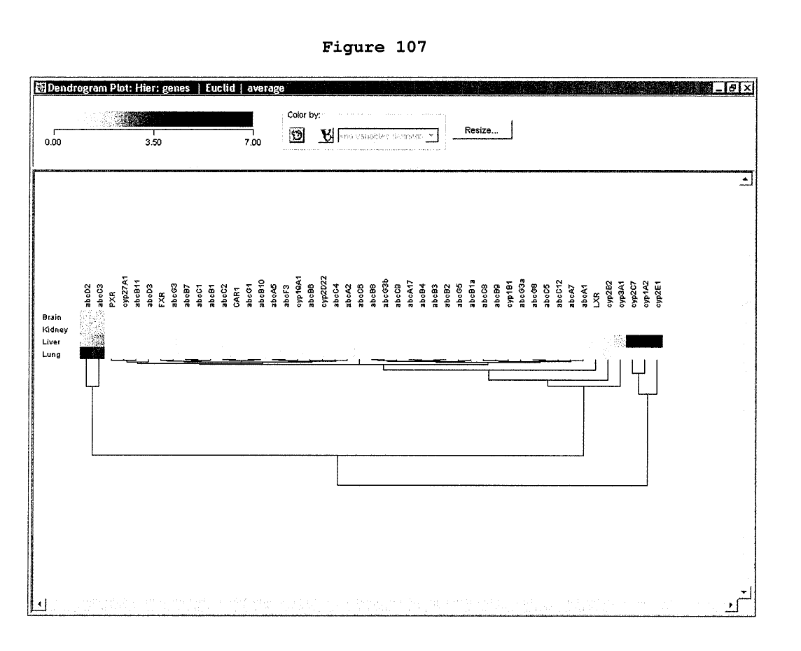

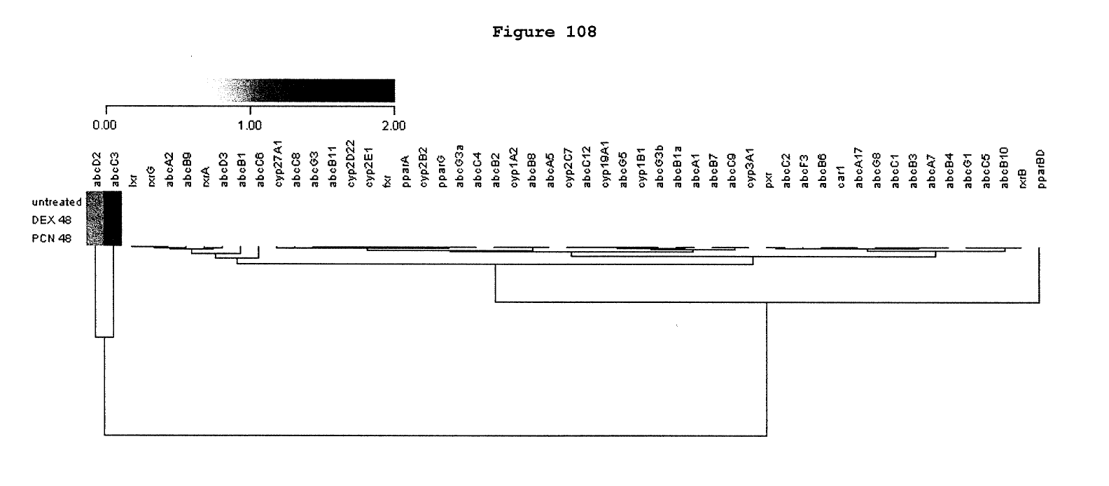

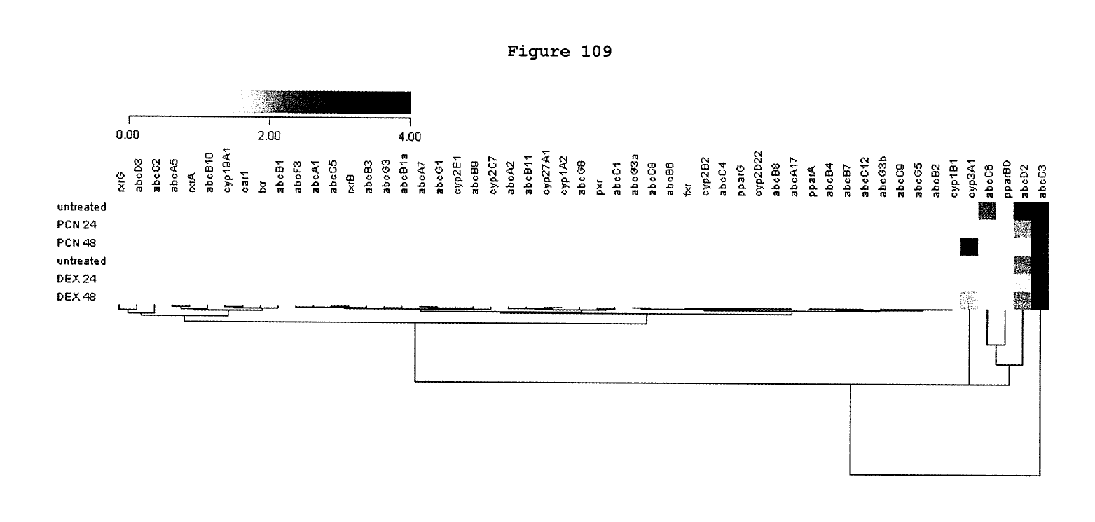

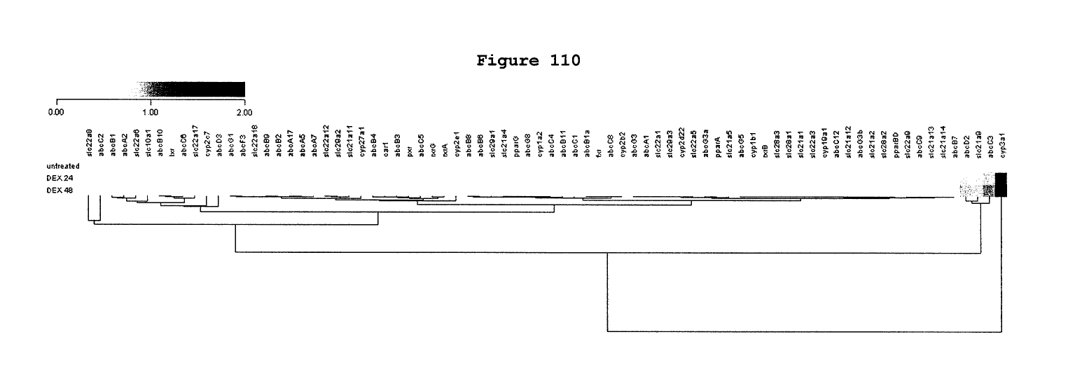

FIGS. 106 and 107 show the normalized fluorescence intensity dendrogram plots for CYP, NXR and ABC Transporter gene expression in normal rat brain, kidney, liver and lung tissue.

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

1. An array comprising a plurality of nucleic acid probes each corresponding to a unique gene transcript and each immobilized on a solid support wherein the plurality comprises a unique probe for each gene encoding at least one rat cytochrome p450 enzyme, at least one rat nuclear xenobiotic receptor, at least one rat transferase, at least one rat uptake transporter and at least one rat efflux transporter.

2. The array of claim 1, wherein the at least one rat cytochrome p450 enzyme, at least one rat nuclear xenobiotic receptor, at least one rat transferase, at least one rat uptake transporter and at least one rat efflux transporter are those that are relevant to the ADME of prototypical inducer compounds.

3. The array of claim 1, wherein the at least one rat transferase is a sulfotransferase and a UDP glucuronosyltransferase.

4. The array of claim 1, wherein the at least one uptake transporter is a solute ligand carrier (SLC) uptake transporter.

5. The array of claim 1, wherein the efflux transporter is an ATP biding cassetter (ABC) efflux transporter.

6. The array of claim 1, wherein the array comprises a unique probe for each of the following genes: rat CAR1 NR111, rat FXR NR1H4, rat LXR NR1H2, rat PPARA, rat PPARD, rat PPARG, rat PXR, rat RXRA, rat RXRB, rat RXRG, rat CYP1A2, rat CYP1B1, rat CYP2B2, rat CYP2C7, rat CYP2D22, rat CYP2E1, rat CYP3A1, rat CYP19A1, rat CYP27A1, rat ABCA1, rat ABCA2, rat ABCA5, rat ABCA7, rat ABCA17, rat ABCB1, rat ABCB1a, ABCB2, rat ABCB3, rat ABCB4, rat ABCB6, rat ABCB7, rat ABCB8, rat ABCB9, rat ABCB10, rat ABCB11, rat ABCC1, rat ABCC2, rat ABCC3, rat ABCC4, rat ABCC5, rat ABCC6, rat ABCC8, rat ABCC9, rat ABCC12, rat ABCD2, rat ABCD3, rat ABCF3, rat ABCG1, rat ABCC2, rat ABCG3, rat ABCG3a, rat ABCG3b, rat ABCG5, rat ABCG8, rat ACTb, rat B2M, rat GAPDH, rat RPLP0, rat VIL1, rat VIL2, rat SLC10A1, rat SLC10A2, rat SLC21A1, rat SLC21A2, rat SLC21A4, rat SLC21A5, rat SLC21A7, rat SLC21A9 rat SLC21A11, rat SLC21A12, rat SLC21A13, rat SLC21A14, rat SLC22A1, rat SLC22A2, rat SLC22A3, rat SLC22A4, rat SLC22A5, rat SLC22A6, rat SLC22A8, rat SLC22A9, rat SLC22A12, rat SLC22A17, rat SLC22A18, rat SLC28A1, rat SLC28A2, rat SLC28A3, rat SLC29A1, rat SLC29A2, rat SLC29A3, rat SULT1A1, rat SULT1B1, rat SULT1D1, rat SULT1E1, rat SULT2A2, rat SULT2B1, rat SULT4A1, rat UGT1A, rat UGT2A1, rat UGT2B, rat UGT2B17, rat UGT2B5, rat UGT2B36, rat UGT2B37 and rat UGT8.

7. An array comprising a plurality of nucleic acid probes each corresponding to a unique gene transcript and each immobilized on a solid support wherein the plurality comprises each of the sequences listed in SEQ ID NOs: 3, 6, 9, 12, 15, 18, 21, 24, 27, 30, 33, 36, 39, 42, 45, 48, 51, 54, 57, 60, 63, 66, 69, 72, 75, 78, 81, 84, 87, 90, 93, 96, 99, 102, 105, 108, 111, 114, 117, 120, 123, 126, 129, 132, 135, 138, 141, 144, 147, 150, 153, 156, 159, 162, 165, 168, 171, 174, 177, 180, 183, 186, 189, 192, 195, 198, 201, 204, 207, 210, 213, 216, 219, 222, 225, 228, 231, 234, 237, 240, 243, 246, 249, 252, 255, 258, 261, 264, 267, 270, 273, 276, 279, 282, 285, 288, 291, 294, 297, 300, 303, 306, 309 and 312 and wherein each probe in the plurality of nucleic acid probes consists of one of the sequences listed in SEQ ID NOs: 3, 6, 9, 12, 15, 18, 21, 24, 27, 30, 33, 36, 39, 42, 45, 48, 51, 54, 57, 60, 63, 66, 69, 72, 75, 78, 81, 84, 87, 90, 93, 96, 99, 102, 105, 108, 111, 114, 117, 120, 123, 126, 129, 132, 135, 138, 141, 144, 147, 150, 153, 156, 159, 162, 165, 168, 171, 174, 177, 180, 183, 186, 189, 192, 195, 198, 201, 204, 207, 210, 213, 216, 219, 222, 225, 228, 231, 234, 237, 240, 243, 246, 249, 252, 255, 258, 261, 264, 267, 270, 273, 276, 279, 282, 285, 288, 291, 294, 297, 300, 303, 306, 309 and 312.

8. The array of claim 7, wherein the probes on the array also comprise the perfect complement of each one of the sequences listed in SEQ ID NOs: 3, 6, 9, 12, 15, 18, 21, 24, 27, 30, 33, 36, 39, 42, 45, 48, 51, 54, 57, 60, 63, 66, 69, 72, 75, 78, 81, 84, 87, 90, 93, 96, 99, 102, 105, 108, 111, 114, 117, 120, 123, 126, 129, 132, 135, 138, 141, 144, 147, 150, 153, 156, 159, 162, 165, 168, 171, 174, 177, 180, 183, 186, 189, 192, 195, 198, 201, 204, 207, 210, 213, 216, 219, 222, 225, 228, 231, 234, 237, 240, 243, 246, 249, 252, 255, 258, 261, 264, 267, 270, 273, 276, 279, 282, 285, 288, 291, 294, 297, 300, 303, 306, 309 and 312.

9. An array comprising a plurality of nucleic acid probes immobilized on a solid support, wherein
the plurality of nucleic acid probes corresponds to a multiplicity of gene transcripts;
each nucleic acid probe is complementary to a distinct gene transcript; and
each nucleic acid probe of the plurality is prepared by amplification of cDNA using a primer pair consisting of nucleic acid sequences selected from:
SEQ ID NO:1 and SEQ ID NO:2;
SEQ ID NO:4 and SEQ ID NO:5;
SEQ ID NO:7 and SEQ ID NO:8;
SEQ ID NO:10 and SEQ ID NO:11;
SEQ ID NO:13 and SEQ ID NO:14;
SEQ ID NO:16 and SEQ ID NO:17;
SEQ ID NO:19 and SEQ ID NO:20;
SEQ ID NO:22 and SEQ ID NO:23;
SEQ ID NO:25 and SEQ ID NO:26;
SEQ ID NO:28 and SEQ ID NO:29;
SEQ ID NO:31 and SEQ ID NO:32;
SEQ ID NO:34 and SEQ ID NO:35;
SEQ ID NO:37 and SEQ ID NO:38;
SEQ ID NO:40 and SEQ ID NO:41;
SEQ ID NO:43 and SEQ ID NO:44;
SEQ ID NO:46 and SEQ ID NO:47;
SEQ ID NO:49 and SEQ ID NO:50;
SEQ ID NO:52 and SEQ ID NO:53;
SEQ ID NO:55 and SEQ ID NO:56;
SEQ ID NO:58 and SEQ ID NO:59;
SEQ ID NO:61 and SEQ ID NO:62;
SEQ ID NO:64 and SEQ ID NO:65;
SEQ ID NO:67 and SEQ ID NO:68;
SEQ ID NO:70 and SEQ ID NO:71;
SEQ ID NO:73 and SEQ ID NO:74;
SEQ ID NO:76 and SEQ ID NO:77;
SEQ ID NO:79 and SEQ ID NO:80;
SEQ ID NO:82 and SEQ ID NO:83;
SEQ ID NO:85 and SEQ ID NO:86;
SEQ ID NO:88 and SEQ ID NO:89;
SEQ ID NO:91 and SEQ ID NO:92;
SEQ ID NO:94 and SEQ ID NO:95;
SEQ ID NO:97 and SEQ ID NO:98;
SEQ ID NO:100 and SEQ ID NO:101;
SEQ ID NO:103 and SEQ ID NO:104;
SEQ ID NO:106 and SEQ ID NO:107;
SEQ ID NO:109 and SEQ ID NO:110;
SEQ ID NO:112 and SEQ ID NO:113;
SEQ ID NO:115 and SEQ ID NO:116;
SEQ ID NO:118 and SEQ ID NO:119;
SEQ ID NO:121 and SEQ ID NO:122;
SEQ ID NO:124 and SEQ ID NO:125;
SEQ ID NO:127 and SEQ ID NO:128;
SEQ ID NO:130 and SEQ ID NO:131;
SEQ ID NO:133 and SEQ ID NO:134;
SEQ ID NO:136 and SEQ ID NO:137;
SEQ ID NO:139 and SEQ ID NO:140;
SEQ ID NO:142 and SEQ ID NO:143;
SEQ ID NO:145 and SEQ ID NO:146;
SEQ ID NO:148 and SEQ ID NO:149;
SEQ ID NO:151 and SEQ ID NO:152;
SEQ ID NO:154 and SEQ ID NO:155;
SEQ ID NO:157 and SEQ ID NO:158;
SEQ ID NO:160 and SEQ ID NO:161;
SEQ ID NO:163 and SEQ ID NO:164;
SEQ ID NO:166 and SEQ ID NO:167;
SEQ ID NO:169 and SEQ ID NO:170;
SEQ ID NO:172 and SEQ ID NO:173;
SEQ ID NO:175 and SEQ ID NO:176;
SEQ ID NO:178 and SEQ ID NO:179;
SEQ ID NO:181 and SEQ ID NO:182;
SEQ ID NO:184 and SEQ ID NO:185;
SEQ ID NO:187 and SEQ ID NO:188;
SEQ ID NO:190 and SEQ ID NO:191;
SEQ ID NO:193 and SEQ ID NO:194;
SEQ ID NO:196 and SEQ ID NO:197;
SEQ ID NO:199 and SEQ ID NO:200;
SEQ ID NO:202 and SEQ ID NO:203;
SEQ ID NO:205 and SEQ ID NO:206;
SEQ ID NO:208 and SEQ ID NO:209;
SEQ ID NO:211 and SEQ ID NO:212;
SEQ ID NO:214 and SEQ ID NO:215;
SEQ ID NO:217 and SEQ ID NO:218;
SEQ ID NO:220 and SEQ ID NO:221;
SEQ ID NO:223 and SEQ ID NO:224;
SEQ ID NO:226 and SEQ ID NO:227;
SEQ ID NO:229 and SEQ ID NO:230;
SEQ ID NO:232 and SEQ ID NO:233;
SEQ ID NO:235 and SEQ ID NO:236;
SEQ ID NO:238 and SEQ ID NO:239;
SEQ ID NO:241 and SEQ ID NO:242;
SEQ ID NO:244 and SEQ ID NO:245;
SEQ ID NO:247 and SEQ ID NO:248;
SEQ ID NO:250 and SEQ ID NO:251;
SEQ ID NO:253 and SEQ ID NO:254;
SEQ ID NO:256 and SEQ ID NO:257;
SEQ ID NO:259 and SEQ ID NO:260;
SEQ ID NO:262 and SEQ ID NO:263;
SEQ ID NO:265 and SEQ ID NO:266;
SEQ ID NO:268 and SEQ ID NO:269;
SEQ ID NO:271 and SEQ ID NO:272;
SEQ ID NO:274 and SEQ ID NO:275;
SEQ ID NO:277 and SEQ ID NO:278;
SEQ ID NO:280 and SEQ ID NO:281;
SEQ ID NO:283 and SEQ ID NO:284;
SEQ ID NO:286 and SEQ ID NO:287;
SEQ ID NO:289 and SEQ ID NO:290;
SEQ ID NO:292 and SEQ ID NO:293;
SEQ ID NO:295 and SEQ ID NO:296;
SEQ ID NO:298 and SEQ ID NO:299;
SEQ ID NO:301 and SEQ ID NO:302;
SEQ ID NO:304 and SEQ ID NO:305;
SEQ ID NO:307 and SEQ ID NO:308 and
SEQ ID NO:310 and SEQ ID NO:311.

10. The array of claim 1, wherein the array is a microarray.

11. A method of gene expression analysis comprising:
(a) contacting one or more pools of nucleic acids under hybridization conditions with an array of claim 1; and
(b) detecting hybridization of the one or more pools of nucleic acids with the plurality of nucleic acid probes,
wherein the presence of hybridization indicates gene expression.

12. A method of preparing a gene expression profile comprising:
(a) contacting one or more pools of target nucleic acids from a plurality cells with an array of claim 1 under hybridization conditions; and
(b) detecting hybridization of the target nucleic acids with the nucleic acid probes on the array, wherein hybridization is indicative of the expression of the corresponding gene transcript in the plurality of cells; and
(c) creating a gene expression profile based on the hybridization detected in (b).

13. A method for predicting a potential for drug-drug interactions comprising:
(a) preparing a gene expression profile of a plurality of test cells that have been exposed to a first drug using the method of claim 1;
(b) separately preparing a gene expression profile of the plurality of test cells that have been exposed to a second drug using the method of claim 1; and
(c) quantitatively or qualitatively comparing the gene expression profiles from (a) and (b),
wherein if the first and second drugs modulate the expression of at least one of the same genes in the plurality of test cells, then there exists a potential for drug-drug interactions between the first and second drugs.


SEQUENCE LISTING (312 sequences)

SEQ ID NO: 1 - DNA, 24 bp, Rattus rattus
tgcggtccatgtagggttccagta

SEQ ID NO: 2 - DNA, 24 bp, Rattus rattus
ccgggccaggaggtgaataaagtt

SEQ ID NO: 3 - DNA, 638 bp, Rattus rattus
tgcggtccatgtagggttccagtacgagtttttggagttgatcatccacttccacaaaaccctgaaaagattgcagctccaggagcccgagtatgcgctcatggctgccatggctctcttctctcctgacaggcctggggttacccaaagagaagagattgatcagctgcaggaagaggtcgcgctgatcctcaataaccacattatggagcaacagtcaagactccaaagtcggtttctgtatgcaaagctgatgggcctgctagctgagcttcggagtataaacagcgcatactcatatgaaatccatcgcatccagggactgtctgctatgatgccgctgcttggggagatttgcagctgaggcccaggcttggatccttccccagacctcttgggatgcattggattggaaagggtaaagtgctggtacccgaaatgggaaccagaagaaaggagctccgttatggcaaagaaacactgaacagtaactgtctcttcgtgcggtcatcagtggggcagggagtgggtaggggacagagagaagggagttgggtggccatagggccaaagttgttctctggaaacacagagggtgggaaagacaggagcctccgggccaggaggtgaataaagtt

SEQ ID NO: 4 - DNA, 24 bp, Rattus rattus
aactccggacattcaaccatcacc

SEQ ID NO: 5 - DNA, 24 bp, Rattus rattus
ctgagctaaatccccaacccctat

SEQ ID NO: 6 - DNA, 542 bp, Rattus rattus
aactccggacattcaaccatcaccacgctgagatgctgatgtcttggagggtgaatgaccacaagttcaccccgctcctctgtgagatctgggatgtgcagtgaaggacacggggagaggctagctccttgtcctcctcagagcagcaacctggtattggacttcccttcttttcatttgtaccaggtctcactcaagaatctcaatgaatatttatgtggcaattatacaattcccacaactgtaaatacaggctccatagaattgcttcccctacactgtattttacaaggcttcgggaaaccccactgacacgccctttttgcctcattaaatcaattgttacttcaattttgtcaactgagctagggaccgcctcgttttatcctccatgcggcaacattatatatatatatattttatcaaatagctgttttctcttccttttttttttttttttttttcggagctggggactgaacccagggccttgcgcttgctaggcaagcgctctaccactgagctaaatccccaacccctat

SEQ ID NO: 7 - DNA, 24 bp, Rattus rattus
tgggcctagacgatgcagagtatg

SEQ ID NO: 8 - DNA, 24 bp, Rattus rattus
gccccctcttctgccccttttatt

SEQ ID NO: 9 - DNA, 630 bp, Rattus rattus
tgggcctagacgatgcagagtatgccttgctcattgccatcaacatcttctcagcggaccggcctaatgtgcaggagcccagccgtgtggaggctctgcagcagccctatgtggaggccctcctctcctacacgaggatcaagcggccgcaggaccagctgcgcttcccacgaatgctcatgaagctggtgagcctgcgcaccctcagctccgtgcactcggagcaggttttcgcattgcgtctccaggacaagaagctgccgcctttgctgtccgagatctgggatgtgcatgagtaggggccgccacaagtgccccagccttggtggtgtctacttgcagatggacgcttcctttgcctttcctggggtgggaggacactgtcacagcccagtcccctgggctcgggctgagcgagtggcagttggcactagaaggtcccaccccacccgctgagtcttccaggagtggtgagggtcacaggccctagcctctgatctttaccagctgcccttcctcccgagcttacacctcagcctaccacaccatgcaccttgagtggagagaggttagggcaggtggctccccacagttgggagaccacaggccccctcttctgccccttttatt

SEQ ID NO: 10 - DNA, 24 bp, Rattus rattus
tcatcacccgagagttcctaaaga

SEQ ID NO: 11 - DNA, 24 bp, Rattus rattus
tcagaggctagtaggattcagaca

SEQ ID NO: 12 - DNA, 625 bp, Rattus rattus
tcatcacccgagagttcctaaagaacctgaggaagccattctgcgacatcatggaacccaagtttgacttcgctatgaagttcaatgccctcgaactggatgacagtgacatttccctttttgtggctgctataatttgctgtggagatcggcctggccttctaaacataggatacattgagaagttgcaggaggggattgtgcacgtgctcaagctccacctgcagagcaaccatccggatgatacctttctcttcccaaaactccttcaaaaaatggtggacctccggcagctggtcacggagcatgcgcagctcgtgcaggtcatcaagaagaccgagtcagacgcggcgttgcacccactgttgcaagagatctacagagacatgtactgatttttcctgagatggtaggccgttgccactgttcagggacctctgaggtctgcggccccatacaggagagcagggatttgcacagatggcctccctccttacccttggagatgaagagggctgagcctaggcaatgcaggctcctcccacatccttactttctgaatgagcacttctaagacttcctgctactgaaatggtggtgatcagaggctagtaggattcagaca

SEQ ID NO: 13 - DNA, 24 bp, Rattus rattus
ccatcctgcaggctctagaattcc

SEQ ID NO: 14 - DNA, 24 bp, Rattus rattus
agaaacttgcctggactgactgcc

SEQ ID NO: 15 - DNA, 639 bp, Rattus rattus
ccatcctgcaggctctagaattccatctgcaggtcaaccaccccgacagccagtacctcttccccaagctgctgcagaaaatggccgacctgcggcagctggtcactgaacacgcgcagatgatgcagtggctgaagaagacggagagtgagaccttgctgcaccccctgctccaggagatctacaaggacatgtactaaggctgcacgcagccagcctcccgcagctccgctgggcccagccacggactgttcagaggacccgcccacaggcactggccacagcccacgcagctagagccactcacaacactccagacacggcccagactctcaccctctccgcccgccctcggcacccggttctccccagcacttcctgttcatgctgtctccccagcacccttgctcctccacctggccttctctagcatcctgcgcctccccgcctgtccccacatctgtctgattcacgccagtgagcccattagtccgctcaccagcagcctagaagcagtgaggcctgcactggcccggccctgcctgtctctgtcccctcttcaaggacatgagccatccaaagaaacactatgttctctctgagtccgactttccaagaaacttgcctggactgactgcc

SEQ ID NO: 16 - DNA, 24 bp, Rattus rattus
atccgtggaagctgtgcaagagat

SEQ ID NO: 17 - DNA, 24 bp, Rattus rattus
agtcccagtcgctgacaaagtgtt

SEQ ID NO: 18 - DNA, 601 bp, Rattus rattus
atccgtggaagctgtgcaagagatcacagagtatgccaaaaatatccctggtttcattaaccttgacttgaatgaccaagtgactctgctcaagtatggtgtccatgagatcatctacaccatgctggcctccctgatgaataaagatggagtcctcatatcagagggacaaggattcatgaccagggagttcctcaaaagcctgcggaagccctttggtgactttatggagcctaagtttgagtttgctgtgaagttcaatgcactggaattagatgacagtgacttggccatatttatagctgtcattattctcagtggagaccgcccaggcttgctgaacgtgaagcccatcgaggacatccaagacaacctgctgcaggccctggaactccagctgaagctgaaccacccggagtcctcccagctgttcgccaaggtgctccagaagatgacagacctcaggcagattgtcacagagcacgtgcagctactgcatgtgatcaagaagacggagacagatatgagccttcaccctctgctccaggagatctacaaggacttgtattagcagaaaagtcccagtcgctgacaaagtgtt

SEQ ID NO: 19 - DNA, 24 bp, Rattus rattus
tactgcttcgaagaccctaatggc

SEQ ID NO: 20 - DNA, 24 bp, Rattus rattus
ctgtggaaagtgctggcctagaaa

SEQ ID NO: 21 - DNA, 568 bp, Rattus rattus
tactgcttcgaagaccctaatggcggcttccagaagctcctgctggacccgttgatgaaattccactgcatgctgaagaagctacagctgcgtgaggaggagtacgtgctgatgcaggccatctccctcttctccccagatcgccctggcgtggttcaacgtagcgtggtagaccagctgcaggagcgatttgccctcaccctgaaggcctacatcgagtgtagtcggccctatcctgcacacaggttcctgttcctgaagatcatggctgtcctcaccgagctgcgcagtatcaatgcccagcagacccagcagctactgcgcatccaggacacgcacccctttgccacacctctcatgcaggagttattcagcagcacggacggctgagtggctgcccctgagtggagatctcacggagcagccagacccagatgttctgaattgccacttctagggctatcagatggacacactgataactaacaatgcctctgtctgcagctggctagcatttctcaggaaaaggacacaggagctcagcctgtggaaagtgctggcctagaaa

SEQ ID NO: 22 - DNA, 24 bp, Rattus rattus
acctgttcttcttcaagctcatcg

SEQ ID NO: 23 - DNA, 24 bp, Rattus rattus
aagcctgtttccaaagataccctg

SEQ ID NO: 24 - DNA, 580 bp, Rattus rattus
acctgttcttcttcaagctcatcggggatacacccatcgacactttcctcatggagatgctggaggccccacatcaaaccacctaggcccgtcacccatgtgccggtcccttgccccgcctggacacagctgctcagctccagccctgtccctgccctttctggatggcctgtgtggatctttggggtgcagcgtccccatggtcccaaaagatgcatcaccatcctcgccatcatcattaatgcttgcctttgcccagggccgtggcagagctggcgtgacacctacccagccccctgccctacaccaggctctaaggctggtcaccctgagggtcttggggtacttcgtggggtcttcagcacctggagctgcaggagctgggagaggggcttgttctggttgctggttgctgtcgctggttctcgacatgcccgcgtggcacctctgtttggagtaccccatctttgcccgtgcagagtcctggtacccagctaagggtgggaaagggagcaggtggggcaggtcatatcctcctggatcatagctaacctttaagcctgtttccaaagataccctg

SEQ ID NO: 25 - DNA, 24 bp, Rattus rattus
ccttctcattagcctcactccctt

SEQ ID NO: 26 - DNA, 24 bp, Rattus rattus
gttccctcccatctttcacttgca

SEQ ID NO: 27 - DNA, 598 bp, Rattus rattus
ccttctcattagcctcactcccttctgaagagtggaacggagctccccagaaaggggtgttgtggggcaggcccccaagccggtggtcttgggagggagcagggctcggacagcccttcagcctcccaggctcggcaggtggggcagaggagggcctgcctctgtcctgtcagccctttccacagtacctgctgcagtcagactgaagaacaaagaggctgtgaaggggccgctgaggaggaggccattgctatttttaatttcctgtgaggagagactgggagttagactcaaagaagaagtactgtacatccccaggttgacttaaatgtcagggctggaggtggcatgtgggcaaggaggcccctcaggtggtctgtcctggagctgtctgggctctgccttcctcatcttccctgcagctctggactgagaggcggtggcccctccttgccccgctcttccctaatcctcagcgcagctagtctgggaacagggagaatgtggggtggccagcctgcagagatgggtgctgggctgcatggtttttgccctggatctcttttgggggggggttccctcccatctttcacttgca

SEQ ID NO: 28 - DNA, 24 bp, Rattus rattus
gaaggacatgcggatggataagtc

SEQ ID NO: 29 - DNA, 24 bp, Rattus rattus
ggctgagatctttctggcagttct

SEQ ID NO: 30 - DNA, 556 bp, Rattus rattus
gaaggacatgcggatggataagtcggagctcgggtgcctgcgcgccattgtgctgttcaatccagatgccaagggtttgtccaacccctcggaggtggagactcttcgagagaaggtttatgccaccctcgaggcctataccaagcagaagtatccagaacagcctggcaggtttgccaagcttctgctgcgcctcccagctctgcgctccattggattgaaatgcctggaacacctcttcttcttcaagctcattggggatacccccattgacaccttcctcatggagatgttggagacccctctgcagatcacctgaaactcctcggctgtagcttcctcacccagagtgacccctgggctggtgtgtgtgtcgccctaccctgcacactgtcccccgtctcccactctgacttcccttcctgtccccaaaatgtgatgcttgtaataactacaacctttctacacatgagacttttctaggtggagttttgtatggttgttaaaggtgacccttctttgctacttaaggggctgagatctttctggcagttct

SEQ ID NO: 31 - DNA, 24 bp, Rattus rattus
gcatcttcataaaccagtggcagg

SEQ ID NO: 32 - DNA, 24 bp, Rattus rattus
cttgctgtgccacgtgctaatcta

SEQ ID NO: 33 - DNA, 538 bp, Rattus rattus
gcatcttcataaaccagtggcaggtcaaccatgatgagaagcagtggaaagacccctttgtgttccgcccagagcggtttcttaccaatgacaacacggccatcgacaagaccctgagtgagaaggtgatgctcttcggcttgggaaagcgccggtgcattggggagatcccggccaagtgggaagtcttcctcttcttagccatcctcctgcatcagctggagttcactgtgccaccgggcgtgaaggtggacctgacacccagctatgggctgaccatgaagcccagaacctgtgaacacgtccaggcctggccacgcttctccaagtgaagatggccgagacatcggccgccacccttgttccttttcctttctttttaaataacagctttttcaagatacaattcctccaccatttaattcagctccaatcaattttcaatattgtctacactgttccctgcaaacccatacccattaagatttatgactattcctcctaccctgtttcgcttgctgtgccacgtgctaatcta

SEQ ID NO: 34 - DNA, 24 bp, Rattus rattus
agtaaggtcgggacagtgatttga

SEQ ID NO: 35 - DNA, 24 bp, Rattus rattus
caccagggctgtgctagattaaat

SEQ ID NO: 36 - DNA, 570 bp, Rattus rattus
agtaaggtcgggacagtgatttgagcctccatggcctctttactatgagaaatttgtaagagtgaaaagtcttcatgaaccaatctggactcctcattaagccaaccagacccagatgttttgtgaacgtaggggtcatgttcgtctgatgctttcagcaaaggggaaagaagggggctactttgtatatatttagacccagtgaaaggaaggaggatacaagtcaggaaagagtaacaattgtcatattcggaagctaatagattactggcttagttggaaagcctgccttattctgctacagagggatttcttttgctggtcaccatcttcatcagagtatccacctcctgtcagggcaggcaaaaagtatgtttttattaaatgtctcccttgcacagtaaagcttggactatgtcagaacgttgcttttttttttaaaacaaaaaatatgcctcaggtgtgttttatgaattactcaaaagagttcatgccccagaacttagcctgtacctgtgaaatattatcatgccccttatgtattcacaccagggctgtgctagattaaat

SEQ ID NO: 37 - DNA, 24 bp, Rattus rattus
gaccatccagacaccttcaatcct

SEQ ID NO: 38 - DNA, 24 bp, Rattus rattus
atggtctcagtgctatgtctacag

SEQ ID NO: 39 - DNA, 646 bp, Rattus rattus
gaccatccagacaccttcaatcctgagcacttcctggatgccgatgggacactgaaaaagagtgaagcttttatgcccttctccacaggtgagacagacctgctaataatttatcagaactccattggaaagcgcatttgtcttggcgaaggcattgcccgaaatgaattgttcctcttcttcaccaccatcctccagaacttctctgtgtcaagccatttggctcccaaggacattgacctcacgcccaaggagagtggcattgcaaaaatacctccaacataccagatctgcttctcagctcggtgatcgggctgaggcagccaggtgccccagttctgttgggaatggcctcatgtttctgcctctgggggacctgctgaaaaccaggctcaaggccactgctcacatcttcctattgcagttctccaaagtcccaaggcttgttcttattcctgtgaatggcactgaagaagtcaatcgactgtcttattttgacatgtgaacagagatttcatgagtacacatctcatgctgagtcacttccctcttcctcctaatagcccacgtccccacttatcagccctccatggtctgtgatctgtgctaatggactctgtatatggtctcagtgctatgtctacag

SEQ ID NO: 40 - DNA, 24 bp, Rattus rattus
cagagattcattaactttgtcccg

SEQ ID NO: 41 - DNA, 24 bp, Rattus rattus
tgtgtcattgtgtatccattcctg

SEQ ID NO: 42 - DNA, 617 bp, Rattus rattus
cagagattcattaactttgtcccgaccaacctgccccatgcagtgacctgtgacattaaattcaggaactacctcatcccgaagggaacaaaagtgttaacatcactgacatcagtgctgcatgacagcaaggagttccccaacccagagatgtttgaccctggccactttctagatgagaatggaaactttaagaaaagtgactactttttgcctttctcagcaggaaaacgagcttgtgttggagagggcctggcccgcatgcagttgtttctattcttgacaaccattttacagaactttaacctgaaatctctggttcacccaaaggacattgatacgatgccagttctgaatggttttgcctctctgccacccacttaccagctctgcttcattccttcctgaatagatcaggcattttggcttctactgtgttgccttctgcaatccccttcaggtttttatccagtcccttccctctatcatccatcctgactcttgtcttaagatccagaaagcacatgcagtttctggagttatagcacaaatccacttgtattatctctttcatataacaatttatgatcccttgtgtcattgtgtatccattcctg

SEQ ID NO: 43 - DNA, 24 bp, Rattus rattus
gacccactacacaaccaaggctaa

SEQ ID NO: 44 - DNA, 24 bp, Rattus rattus
ccagccagctaataaagacctcct

SEQ ID NO: 45 - DNA, 616 bp, Rattus rattus
gacccactacacaaccaaggctaactcctcagccagcatcatcacaacttcttatatgacgtcgcagagatgtagagaagtcggggaggctggaaatgacatgcaggttaagtgcccaaggttacctgttgggtaccacatgcttccctaaacggttttgtgggggtccagaagcaggttgcctcctaagcttctttgtcaccattaattccatgacccagcagggatactggtgtccaggcccatgcacagtaagaaagtgactctaaccagggatggaaggacccgcaagcttagtgttgacacagactcccagaccttagcacaactgactccatggtagaagtaccatttgggccataaaacttagcacgtagacagcagctcctctcataatgaaaacaaagacctaacccatcaaattctatcctgggaaggtctcttgaagcactcctcttggcttcttggcttctgtagttctcctagctaactgctcttgctaactgaagtatgtcaacccaggatatggttgttggtaaaagctcgccctgagaacagctcaggacgacattgaggtgacccagtgtagtcaccagccagctaataaagacctcct

SEQ ID NO: 46 - DNA, 24 bp, Rattus rattus
aatgtttctgtgactttggccgac

SEQ ID NO: 47 - DNA, 24 bp, Rattus rattus
aactctgtgtcattccccgttcat

SEQ ID NO: 48 - DNA, 619 bp, Rattus rattus
aatgtttctgtgactttggccgacctgttctttgcaggaactgagaccaccagcacaactctgagatatgggctcctgatcctcatgaaatacccagaaattgaagagaaacttcatgaagaaattgacagggttattgggccaagccgcgtccctgctgtcagagacagactggatatgccctacatggatgctgtggtgcatgagatccagagattcatcaatcttgtcccttccaacctaccccatgaagcaaccagagatactgtgttccaaggatatgtcatccccaagggtacagttgtgattccaactctggactccctcttatatgacagccatgagtttccagatccagagaagtttaaacctgagcatttcctgaatgaaaatgggaagttcaagtacagtgactatttcaaggcattttctgcaggaaagcgtgtgtgtgttggagaaggcctggcccgcatggaattgtttctgctcctgtctgctattctgcagcattttaacctgaagtctctggttgaccctaaggatatcgacctcagtcctgtcacagttggctttggcagtatcccaccccaatttaaactctgtgtcattccccgttcat

SEQ ID NO: 49 - DNA, 24 bp, Rattus rattus
aaacttctccttccagccttgtaa

SEQ ID NO: 50 - DNA, 24 bp, Rattus rattus
acacttctttaaaaatccccaggg

SEQ ID NO: 51 - DNA, 572 bp, Rattus rattus
aaacttctccttccagccttgtaaggaaacacagatacctctgaaattaagcagacaaggacttcttcaaccaacaaaacccattattctaaaggttgtgccacgggatgaaatcataactggatcatgattttccctcaaggagttctgctgaattcttcagaaatgtggtgtctaagaacaccagaccctttaatttatgtcatgaataaaattcagatgaaattagggcttaatcgactttgttttgattcggtacatctttgatctttctcagtgtctacaatgtacccatctaatataaaggaaatgacaagtcagtgacagaacaggaacttaacctttggtgattctcacgggactacctccatccacatctggttgtctctgttaatttcttttgatagtaaccttgtctctgtgtaatttgatcaagaactttttcatgaaaatgtgaactattgtgacaactttaattgtagatttggtatcagatgttttagatgcattattctacactaaatgttacatggaaaaaatgtgaataaacacttctttaaaaatccccaggg

SEQ ID NO: 52 - DNA, 24 bp, Rattus rattus
tgatttgattttcgctgagagacg

SEQ ID NO: 53 - DNA, 24 bp, Rattus rattus
caccttttttgcaatgcctgtaca

SEQ ID NO: 54 - DNA, 677 bp, Rattus rattus
tgatttgattttcgctgagagacgtggagacctgacaaaggagaacgtgaatcagtgtatattggaaatgctgattgcggcccctgacaccatgtccgtcactctgtacgtcatgttgcttctcatcgcagagtatccggaggtggaaacagctatactgaaggaaatccacactgttgttggtgacagagacataaggattggtgatgtgcaaaatttgaaagtggtggaaaacttcattaacgagagcctgcggtatcagcctgtcgtggacttggtcatgcgcagagccctggaggatgacgtgattgacggctacccggttaaaaagggaactaacatcattctgaacatcggaagaatgcacaggctcgagtatttccccaagcccaatgaatttacccttgaaaactttgagaagaacgttccctacaggtattttcagccatttggctttgggccccgcagctgtgctgggaagtacatcgccatggtgatgatgaaagttgtcctggttacacttttgaaacgattccatgtgaagacattgcaaaaaaggtgtattgaaaatatgccgaaaaataatgacttgtccttgcatctagatgaggacagccccattgtggaaataatttttcggcatattttcaatacaccttttttgcaatgcctgtaca

SEQ ID NO: 55 - DNA, 24 bp, Rattus rattus
cacaaactcccggatcatcacaga

SEQ ID NO: 56 - DNA, 24 bp, Rattus rattus
gacgtctggcacaatctctactga

SEQ ID NO: 57 - DNA, 548 bp, Rattus rattus
cacaaactcccggatcatcacagaaaaggaaactgaaattaatggcttcctcttccctaagaatacacagtttgtgttatgccactacgtggtgtcccgagatcccagtgtctttcctgagcccgagagcttccagcctcaccgatggctgaggaagagagaggacgataactccgggatccaacacccatttggctctgtgccctttggctatggggttcggtcctgcctgggtcgcaggattgcagaactggagatgcaactcctgctgtcaaggctgatacaaaagtatgaggtggtcctgtctcccgggatgggagaagtgaagtctgtgtcccgcatcgtcctggttcccagcaagaaggtgagcctacgctttctgcagagacagtagtaccaagctgggctcctgtctccatgggacttgtcagaagccctggcacagaagttcttggccagtctcacgtcacatgtcacgatgccagattcaacaggggacctctctgcccttcccatagacaccagacgtctggcacaatctctactga

SEQ ID NO: 58 - DNA, 24 bp, Rattus rattus
ccatagttgtacgaatagcgggct

SEQ ID NO: 59 - DNA, 24 bp, Rattus rattus
aacacgattccattacaggggcag

SEQ ID NO: 60 - DNA, 553 bp, Rattus rattus
ccatagttgtacgaatagcgggctccaaccctgacctaaagcctgtccaggagttctttggacttgcctttcctggaagtgttctgaaagagaaacatcgaaacatgctacagtaccagcttccgtcctccttgtcatctctggccaggatattcagcattctctcccagagcaaaaagcgactccacatagaagactactctgtctctcagacaacacttgaccaagtattcgtgaactttgccaaggaccaaagtgatgatgaccacttaaaggacctgtcactacacaaaaaccagacagtggtggatgtggctgttctcacatccttcctgcaggacgagaaagtgaaagaaagttacgtatgaagaatcctgttaacacagggggaatgaaaggaagggagagctaggtctccctttgcaccgggtcaagtgttccagaagaaagcgtccagcgtttctgtggagtggaacaaactggattctgtactgacactattcaatgcaatgcacttcaatgcaacaagaacacgattccattacaggggcag

SEQ ID NO: 61 - DNA, 24 bp, Rattus rattus
gcaaagtgacaatgtggagcagca

SEQ ID NO: 62 - DNA, 24 bp, Rattus rattus
gtgaagaagttaggctaccatggg

SEQ ID NO: 63 - DNA, 660 bp, Rattus rattus
gcaaagtgacaatgtggagcagcaagaggctgagccatccaccttgccgtccccccttggactacttagcctgctgcggccccgccctgcacccacagagctccgggcactggtggccgatgagcctgaggacctggacacggaggacgagggcctcatcagcttcgaggaagagcgggcccagctctccttcaacaccgatacgctctgctgacgttcaagagtcacatcagggatgcagctgtttggggcagaagtcaggcggtggccgtagccccagtcacacatgccaggccctggaaaggcaggttcaggaccaaagggctcccgccctcctcccaactaccatcctccccgatcgtgccaaaggctgggctggccctgggctgcacacaccctcaccctgctttgccttaaagccttgggtcctggcccagccccttaccctgcccagcaccatccaccttcccagggtgacatgggctgccccaagtatcctgtgacccttctctgcagcggccaccagtctacccaggccagcatcttgcacagatgtctttcatgaaaagactgcagttggggaggtggcagcttgcctacttattttgctttaagagcctccctcactctgctgttgtgaagaagttaggctaccatggg

SEQ ID NO: 64 - DNA, 24 bp, Rattus rattus
ggatgagccgtctacaggtatgga

SEQ ID NO: 65 - DNA, 24 bp, Rattus rattus
gagtcgtgttctgaatgtctgcgc

SEQ ID NO: 66 - DNA, 572 bp, Rattus rattus
ggatgagccgtctacaggtatggaccccagagccaaacagcacatgtggcgagccattcgaactgcgtttaaaaacaagaagcgggctgccctcctcactacgcattacatggaagaggcggaggctgtctgtgacagggtggccatcatggtgtccgggcagctaagatgcattggaacagtacaacatctaaagagcaagtttggcaaaggctactttttagaaattaaactaaaggactggatagaaaacctggaaatagatcgccttcaaagagaaattcaatatattttcccaaatgcaagccgccaagagagcttctcttctattctggcttataaaattccaaaagaagatgtccagtctctctcacagtcctttgctaagttggaggaagcaaaacacacttttgccattgaagaatacagcttttctcaagcaaccctggaacaggtttttgtagaacttactaaggagcaggaggaggaagataatagctgcgggactttaaacagcacgctctggtgggaaagaaggcaggaagacagagtcgtgttctgaatgtctgcgc

SEQ ID NO: 67 - DNA, 24 bp, Rattus rattus
tgtttcgggctgctgggtgtcaat

SEQ ID NO: 68 - DNA, 24 bp, Rattus rattus
gggaagcgctcagcatctcaaaag

SEQ ID NO: 69 - DNA, 578 bp, Rattus rattus
tgtttcgggctgctgggtgtcaatggggcagggaagacatccaccttccgcatggtgacgggggacacgctgcccagcagtggtgaagcagtgctggcaggccacaatgtggcccaggagccgtctgctgcgcaccgcagcatgggctactgtccccagtctgatgccatcttcgatctgctgaccggccgggaacatctagaactgtttgcgcgcctgcgcggggtgcccgaggcccaagttgcccagacagcgctctctggcctggtgcgcctgggccttcctagctacgcagaccgacccgcgggtacctacagcggaggcaacaaacggaagctggcgacagctctggctctggttggtgatccagcagtggtctttctggacgagcccaccacaggcatggacccaagtgcgcggcgatttctttggaacaacttgctgtccgtggtgcgtgagggccgctccgtagtgctcacgtcgcacagcatggaagagtgtgaagcgctctgcacgcgcctggccatcatggtgaacgggcggttccgctgtctgggaagcgctcagcatctcaaaag

SEQ ID NO: 70 - DNA, 24 bp, Rattus rattus
atggcgaaggtgcagcagtggatt

SEQ ID NO: 71 - DNA, 24 bp, Rattus rattus
gcagatgctagaggagttcaaggc

SEQ ID NO: 72 - DNA, 536 bp, Rattus rattus
atggcgaaggtgcagcagtggattggttactgtcctgagtttgatgccctgctaaacttcatgacaggaagagagatgcttgtcatgcatgcccgtatccggggcatccccgagtgccacatcaaaacctgtgtggacatgatccttgagaacttactcatgtgcgtgtatgcagacaagctggtgaagacctatagtgacggcaacaagcgcgtgctgagcaccgccatcgccctcctcggagagcccacggtcatcctgctagacgagccatccactggcatggaccctgtggctcggcgcctggtgtgggatgctgtgggacgggtccgtgagtctggcaagaccatcgtcatcacctctcacagtatggaggagtgtgaagccttatgtacccggctggccatcatggtacagggccagttcaagtgcctgggcagcccgcagcacctcaagagcaggtttggcagcggctactccctgcaggccaaggtccggaggaaatggcagcagcagatgctagaggagttcaaggc

SEQ ID NO: 73 - DNA, 24 bp, Rattus rattus
cctacttggtggcacgagaactca

SEQ ID NO: 74 - DNA, 24 bp, Rattus rattus
aacatcgcctacggagacaacagc

SEQ ID NO: 75 - DNA, 530 bp, Rattus rattus
cctacttggtggcacgagaactcatgacatttgaaaatgttatgttggtattttctgctgttgtctttggtgccatggcagcagggaataccagttcattcgctcctgactacgcgaaggccaaagtctcagcatcccacatcatcaggatcattgagaaaatccccgagattgacagctacagcacggagggcttgaagcctaattggttagaaggaaatgtgaaatttaatggagtcatgttcaactatcccacccgacccaacatcccagtgcttcagggactgagcttcgaggtgaagaaggggcagacgctcgccctggtgggcagcagtggctgcgggaagagcacggtggtccagctgctcgagcgcttctacaaccccatggctggaacagtgtttctagatggcaaagaaataaaacaactcaacgtccagtggctccgcgcccacctgggcattgtgtcccaggagcccatcctgtttgactgcagcatcaccgagaacatcgcctacggagacaacagc

SEQ ID NO: 76 - DNA, 24 bp, Rattus rattus
actgtgaccatgcgagatgttaaa

SEQ ID NO: 77 - DNA, 24 bp, Rattus rattus
atgtaagcagaaaggtgtggtatg

SEQ ID NO: 78 - DNA, 581 bp, Rattus rattus
actgtgaccatgcgagatgttaaatatttttaatgtttgtattaatatatgacacttaatcaaagtcaaaaggaaaacacttactagaatagtcagttatctatttcctgtcacaaaggaaagcatttagtccattttagagtcttcagagactttgtaattaaaagaacaaaaatagatacatcatcaaatggagagtaatagtttaaaatgcactataaaatttacaaaagagttaaaagtaaatatttgataatatatacttttatttatactttctcatttgtaactataactgatttccttgcttaacaaattatgtatgtatcaaaactactgaaatgtttgtataaagtatatatatatagtgaaactgaatgtttatattttttgacttgttttgctcaaaatgcatgtgaaattatatattctaccaactggagtattgtacataattttagcctttaaaacttagtctatgggggaggggtcactctatgggtaatgtgcctgataatacacaaacatgagtatctgagtctagatccctagcacctatgtaagcagaaaggtgtggtatg

SEQ ID NO: 79 - DNA, 24 bp, Rattus rattus
caaccatggaggaaatcacagctg

SEQ ID NO: 80 - DNA, 24 bp, Rattus rattus
gagatgcccggaatttaccaccaa

SEQ ID NO: 81 - DNA, 602 bp, Rattus rattus
caaccatggaggaaatcacagctgtggccatggagtctggagcccacgatttcatctctggattccctcagggctatgacacagaggtaggtgaaactgggaaccagctgtcaggaggtcagcgacaggcggtggccttggctcgagccttgatccggaagccacgcctgcttatcttggacgatgccaccagtgccctggatgctggcaaccagctacgggtccagcggctcctgtatgagagcccggagtgggcctctcggacggttcttctgatcacccagcagctcagcctggcagagcgggcccaccacatcctcttcctcaaagaaggctctgtctgcgagcagggcacccacctgcagctcatggagagaggagggtgttaccggtccatggtggaggctcttgcggctccttcagactgaccggcttctggactgcacgctgcgcgagtccctccccctgctgtcctctgctctgtgtggcagagaacctgggagcaaagattttaccacatccacggagatagttgaggagcgatggtgtttgttacatgagaaaaatgtaacctctaggagatgcccggaatttaccaccaa

SEQ ID NO: 82 - DNA, 24 bp, Rattus rattus
gatgtctccttctcgtaccccagt

SEQ ID NO: 83 - DNA, 24 bp, Rattus rattus
gcaggatgtctacgctcacttggt

SEQ ID NO: 84 - DNA, 677 bp, Rattus rattus
gatgtctccttctcgtaccccagtcgccccgagaagcctgtgctccagggcctgacgttcaccctgcatcctggaaaggtgacggctttggtgggacccaatgggtcagggaagagcaccgtggccgccctgctgcagaacctgtaccagcccaccgggggccagctgctgctggatggcgagcccctggtccagtacgatcatcactacctgcaccgccaggtggttctggtggggcaggagcctgtgctgttctccggttctgtcaaggacaatattgcctatggcctgagggactgtgaggacgctcaagtgatggctgctgcccaggcggcctgtgcagacgacttcataggggaaatgacgaatggaataaacacagaaatcggggagaaagggagccagttagctgtgggacagaaacaacgtctggccattgcccgggcccttgtgcggaacccgcgggtcctcatcctggatgaggctaccagtgccctggacgccgagtgcgagcaggcccttcagacctggagatcgcaggaggacaggacgatgctggtcattgctcaccggctgcacacggttcagaatgctgaccaagttctggtgctcaagcaggggcagctggtggagcacgaccagctcagggatgagcaggatgtctacgctcacttggt

SEQ ID NO: 85 - DNA, 24 bp, Rattus rattus
gccggataagtttgaaggaagcgt

SEQ ID NO: 86 - DNA, 24 bp, Rattus rattus
agagtgaaaaggtcgtccaggaag

SEQ ID NO: 87 - DNA, 569 bp, Rattus rattus
gccggataagtttgaaggaagcgtgacattcaatgaagttgtgttcaattatcccacccgggccaatgtgccagtgcttcaggggctgagcctcgaggtgaagaaggggcagaccctggccctggtgggcagtagtggctgcgggaagagcaccgtggtccagctgctcgagcgcttctacgaccccatggccggaacagtgctcctcgatggtcaggaagcaaagaaactcaatgtccagtggctccgagctcaacttggcattgtgtcccaggagcccatcctgtttgactgcagcatcgccaagaacatcgcctacggagacaacagccgtgtcgtgtctcaggatgagattgtgagggcggccaaggaggccaacatccaccccttcattgagacactgccccaaaagtatgaaacaagagtaggagacaaggggacacagctctctggaggccagaaacagaggattgctatcgcccgagccctcatcagacagcctcgggtcctactgctggatgaagccacgtcggctttggacactgagagtgaaaaggtcgtccaggaag

SEQ ID NO: 88 - DNA, 24 bp, Rattus rattus
acgcctgctgtttcgcttctatga

SEQ ID NO: 89 - DNA, 24 bp, Rattus rattus
tcttaacctcaggacatggcgtag

SEQ ID NO: 90 - DNA, 631 bp, Rattus rattus
acgcctgctgtttcgcttctatgacatcagctctggctgcatccgaatagatggacaggacatttcacaggtaacccagatctctctccggtctcacattggagttgtgccccaggacactgtcctcttcaacgacaccattgccaacaatatccgctatggccgtgttacagctggggacagtgagatacaggctgctgctcaggctgcgggcatccatgatgccatcttgtctttccctgaagggtatgagacacaggttggggagcggggtctgaagctgagtggtggcgagaagcagcgagtggccattgcccgcaccatccttaaggctcctgacatcattctgctggatgaggcaacatcagcactggatacatctaatgagagagccatccaggcctctctggccaaagtctgcaccaaccgcaccaccatcgtagtagcacacaggctctcaactgtggtcaatgctgaccagattcttgtcatcaaggatggctgcatcatagagagaggaaggcacgaagccctgctatcccgaggtggcgtgtatgctgagatgtggcagctgcagcagcaaggacaagaaactgtccctgaagactcttaacctcaggacatggcgtag

SEQ ID NO: 91 - DNA, 24 bp, Rattus rattus
tgctcaaggtagacacgcggatta

SEQ ID NO: 92 - DNA, 24 bp, Rattus rattus
gactattcttggtgccatgaggga

SEQ ID NO: 93 - DNA, 619 bp, Rattus rattus
tgctcaaggtagacacgcggattaaagacaaagcgatggcatctccccttcaaataacaccacagacagccacggtggcctttgataatgtgcattttgagtacattgaaggacagaaagtccttagcggagtatcttttgaagtccctgcaggaaagaaagtggccattgtaggaggtagtgggtcaggaaaaagcacgatagtgaggctgctgtttcgcttctatgagcctcaaaagggtagcatttaccttgctggtcaaaatattcaagatgtgagcctggaaagtcttcggcgtgcagtgggagtagtacctcaggatgctgtcctcttccataatactatctactacaacctcttatatggaaacatcaatgcgtcaccagaggaagtatatgcagtcgcaaaattggctggtcttcatgatgcaattcttcgaatgccacatggatatgacacacaagtaggagaacgaggactcaagttatcaggaggagaaaagcagagggtagcgattgcaagagccattttgaaggatcccccagttattctctatgatgaagctacttcatcattagattcgattactgaagagactattcttggtgccatgaggga

SEQ ID NO: 94 - DNA, 24 bp, Rattus rattus
ccgacctggcttcaatgtgctcaa

SEQ ID NO: 95 - DNA, 24 bp, Rattus rattus
ctacgcagagcttatccggagaca

SEQ ID NO: 96 - DNA, 681 bp, Rattus rattus
ccgacctggcttcaatgtgctcaagaacttcaccctgaagctgccccctggcaagattgtggctctcgttggccagtctgggggaggaaagaccacagttgcttccctgctggaacgcttctatgaccccacagctggcgtggtgacgctggatgggcatgacctgcgtactctcgacccctcctggctccggggccaggtcataggtttcatcagccaggagccagtcctgtttgcaacaaccatcatggagaatatccgatttgggaagctagatgcttccgatgaagaggtgtatacagctgcacggaaagccaatgcccacgagttcatcagcagcttccctgatggctacagcactgtggttggtgaacggggcacaaccttgtccggtggtcagaagcagcgcctagccatcgcacgtgccctcatcaagaggcccacagtgttgatcctggatgaagccaccagtgcgctggacgcagagtctgagaggatagtacaggaggcactggaccgggccagtgctggtcgcaccgtgttggtcattgcccaccggctcagtactgttcgtgccgcccactccatcatcgtcatggccaatggccaagtctgtgaggctgggacccacgaagaactccttcaaaaaggcgggctctacgcagagcttatccggagaca

SEQ ID NO: 97 - DNA, 24 bp, Rattus rattus
actccagtcaactcctagatttca

SEQ ID NO: 98 - DNA, 24 bp, Rattus rattus
taagattttgggagaactgggtca

SEQ ID NO: 99 - DNA, 559 bp, Rattus rattus
actccagtcaactcctagatttcaaaaacacctttttgggactggcagtgagcaagctcactaggatgttttcaagacttctgagccaggagtgcacgaccctttctaactgcctggaagatgtctgggagagaactaagcactaccctttgcctctgggagaagcagcttccctgtccctagggggacacaagggttggccttccatccttccagtctcccggctctgtgagtcaggccagaggtggggcaagagagtgggaggtgcccactgcctatcaccccttgccaatcaaagccagtctcactgtgaaccaccagaacctcagcagaggaggggctggccaggcctggtgggcctcggggtgccctcagccccacacccagcacttgaacccttcatcctttcccctggctggcaccttcccctcctgtccacccctgcaactctgcagaggaaccttgtttgtaagatgtattctcagattggtggaggggaccgaggcaatgcccagggtctggctttgtcctggtttaagattttgggagaactgggtca

SEQ ID NO: 100 - DNA, 24 bp, Rattus rattus
gtttcctaatcactggggcaccta

SEQ ID NO: 101 - DNA, 24 bp, Rattus rattus
ttaacagagtgccaagaccaggag

SEQ ID NO: 102 - DNA, 616 bp, Rattus rattus
gtttcctaatcactggggcacctacctgggccactgagggaaagtttgccttttctgtccccttcatcttcaggtgtcggaattctgggacactacaggccgtccgtacctgtcagaatgtgcagtgtccccatctgggtactggagagcctgatgtatttgccaaaggtagaaatcccgttctgtgagctggaaagcttctgtttttatcacttcctcgttctttgactccttttgagaagcaaggtacaaacaaccaggtattaccaacagaggtgaatgaaaatccatttcacattcgttgaagcgtgtattttgagaaaaaatacccattttaaatatgtaactcacaggtatattgtagttttatattttaaatttttattaatgaggccgaatctgaataatagaattttcagacttgagtacggtggctcttgcagaagcaaggcaacaaaaggaacgtcatcctttggaaagcttcagaactaagacacgttgtcctgcttccattacgctaagtcctaccaccctccgaagtcgacctgtagtggcggcgagtgtggctgccctgccaagcacaagtgagtctttaacagagtgccaagaccaggag

SEQ ID NO: 103 - DNA, 24 bp, Rattus rattus
gcctactacaagctggtcatcact

SEQ ID NO: 104 - DNA, 24 bp, Rattus rattus
aaggctcagggtattggtgtcact

SEQ ID NO: 105 - DNA, 673 bp, Rattus rattus
gcctactacaagctggtcatcactggagcccccatcagttgacctgactggagacttcacacagataatgatgtgctgagtacaggagggctgtgggtttttgtagtcatatagagaattattaatgctttacagacagaagtatccactgggatccaaagtaattttgagtgactttcagtaataatttcagtttgaaatgtctatgtagaaaggagagagcccagagtcagcatgagtcaaagttcaaagtccaaggtcaagtagctgcttatctgccggccagtgctgctctgggtagaaactggtcactgtctccatcgaggacgccgcggtgagagcaaggagtcctccttcaggacagagggttatctcttgcatctgggaaagctccctgcgcactgagcctgctctgtaatctgcactcaactgtttgagccagttcaaggccaagagctaaggacccaaggctactggtatttcttaactaagtttagtttgtttactataaggaagcaaatttatttacctttaactcctgtgagtagggtggggagccctttcctattctggcatctcccaggctcagggaggccaaggtgacaaaaggagaagtagaggtcgctggtcaggtgtgttgattgtaccgaaggctcagggtattggtgtcact

SEQ ID NO: 106 - DNA, 24 bp, Rattus rattus
tgcctgacaagctgaaccatgagt

SEQ ID NO: 107 - DNA, 24 bp, Rattus rattus
aaagttcacccatgctcctgctgt

SEQ ID NO: 108 - DNA, 632 bp, Rattus rattus
tgcctgacaagctgaaccatgagtgtgcagaaggtggagagaatctgagtgtggggcagcgacagcttgtgtgcctggcccgggctttgctgaggaagacaaagattctagtgttggacgaggctacagcagctgtggatctggagacagatgaccttattcagtccaccatccggacgcagtttgaagacagtactgtgctcactattgctcatcggctgaataccataatggactatacaagggtgattgtcctggacaaaggagaaattcgggagtgtggtgcaccctctgagctcctgcagcaaagaggcgtcttctatagcatggccaaggatgctggcttggtgtgaactgatctctggcatatctgatgaggactgcagggccaggatcccagtgtccaggcatgagccagcaaccctggaaacctacactccccagagaaaaaccaaaaattgaaagaaaaccaaactaaaaggaagcaaaacacataaagcatcagtcacagtttgccccagcctggatctgacctcgaagaagcctgaagacagatgtgccccacttcaaacacgtctggcttctggcaccacttgtgaggctccctgaaagttcacccatgctcctgctgt

SEQ ID NO: 109 - DNA, 24 bp, Rattus rattus
agctggatctggtactgaaaggga

SEQ ID NO: 110 - DNA, 24 bp, Rattus rattus
gaggttccttctatctgatggcca

SEQ ID NO: 111 - DNA, 663 bp, Rattus rattus
agctggatctggtactgaaagggatcacttgtaacatcaagagcggagagaaggtcggcgtagtgggcaggactggggctgggaaatcatccctcacaaactgcctcttcagaatcttagagtctgcggggggccagatcatcattgatgggatagatgttgcctccattggactgcacgaccttcgagagaggctgaccatcattccccaggaccccattttgttctcggggagtctgaggatgaatctcgaccctttcaacaaatattcagatgaggaggtttggagggccctggagttggctcacctcagatcctttgtgtctggcctacagcttgggttgttatccgaagtgacagagggtggtgacaacctgagcatagggcagaggcagctcctatgcctgggcagggctgtgcttcgaaaatccaaaatcctggtcctggatgaagccacggctgcagtggatctcgagacggatagcctcattcagacgaccatccgaaaggagttctcccagtgcacggtcatcaccatcgctcacaggctgcacaccatcatggacagtgacaagataatggtcctagacaacgggaagattgtcgagtatggcagtcctgaagaactgctgtccaacagaggttccttctatctgatggcca

SEQ ID NO: 112 - DNA, 24 bp, Rattus rattus
cggctcaacacaatcatggactac

SEQ ID NO: 113 - DNA, 24 bp, Rattus rattus
aatccctggttggtgctgtctgaa

SEQ ID NO: 114 - DNA, 660 bp, Rattus rattus
cggctcaacacaatcatggactacaaccgggtcctggtcttggacaaaggagtagtagctgaatttgattctccagtaaacctcattgcagctggaggcatcttctatgggatggccaaagatgcaggactcgcctagaatctgcattccaaaggtttcttccttgtctgaatcggacagcaagtagctgcagcatggatttgatggcaacgagtggggacatttgagttggttttggtttttttttgttttttgttttttttttttttttaaattctgcaaattgccttacagactagccatacttaacagtggaatgaggaagtgggtccttggaggtcacagccagttcacagccaagttcagaccagtccctgggtctcctagacctagtctaccattattcccgtactgcatttttttttggttctttttttcagagctggggaccgaacccagggccttgcccttcctaggtaagcgctctaccactgagctaaatccccagcccccgtactgcagtttttaagagaccctgctcctgcctctacatattcatagtttccaattttttttttaaatgagcctttctccttctggaccagggactgctaggtcagtctgtccggggaacagaatccctggttggtgctgtctgaa

SEQ ID NO: 115 - DNA, 24 bp, Rattus rattus
gccgtatgttttgctgcagaatcc

SEQ ID NO: 116 - DNA, 24 bp, Rattus rattus
gacttagctaggacccgttacttc

SEQ ID NO: 117 - DNA, 661 bp, Rattus rattus
gccgtatgttttgctgcagaatccagagagcctcttttacaagatggttcagcagctgggtaagggcgaagccgctgccctcaccgaaacagcaaaacaggtgtacttcagacggaattatccggatattgcattcagcagccctgcggttatgagcacctccaacggacagccctccgccttaacgatatttgaaacagcattgtgactactaccaggacgtcaagtctgtttccagggtgtcccctgccccaacaaggggctcgcacttcttagactacagcactcctggtcttcattctgcaacagatccttcacagacaagagaccggcgtctttggactttccccttcgaccttatcctgtgacttcaggtcctaacaacatggcctgttgttttatttaaatgttcctactgttctttacaaatccagttctgaggtgcaggccactgacaacagctgcctaccaggttttgtgccttaacagactctagggccaaagcccgtgcgttttataagctgtcacagtgggttgtttcttcctcttgccttaaaagtacactctccgggtgcgtcagggactctgtttacttgaagacggtgtgcagatgccagtttgtttccctgctttctctgacttagctaggacccgttacttc

SEQ ID NO: 118 - DNA, 24 bp, Rattus rattus
gtgtttccttctccagctggtcgt

SEQ ID NO: 119 - DNA, 24 bp, Rattus rattus
tggggtccgttcttcctcacttca

SEQ ID NO: 120 - DNA, 528 bp, Rattus rattus
gtgtttccttctccagctggtcgtttcacggtgctgggctccctaggtgtccagggggagacacttggcagcagcgggccctccatggcctgctccgtgggctccccagtggaaacccagtacagtgggctgcaggaggccttgcagagcaccgtgaattctcagggctcctgctttcctgtctccctgtcagttgccatttatgttagagcagcgggcaaagccccacccccttcccctctcaggaatgagaactccagcattcctcagaggggagagcttctttctgcctcccttcttctgctgtcatttctaagcaaggtccagtctgctgccagtgttccgtgcttcaggttcctgaggctggccaccgcagagctcccaagctccccggccagttggttcccagcccccacccgggctccactgctgctgctgttgtaggtggcgttttcatttgcctgaccccacagctccagagctcagcaacagggctcaggagtgtggggtccgttcttcctcacttca

SEQ ID NO: 121 - DNA, 24 bp, Rattus rattus
agacaggatttcacatagcccagg

SEQ ID NO: 122 - DNA, 24 bp, Rattus rattus
ttgatccgccctaatagcacccat

SEQ ID NO: 123 - DNA, 526 bp, Rattus rattus
agacaggatttcacatagcccaggctggccctgaactcactttgttgctgaggatggccttgaacatctgatgctcctgccttccctcccaagtgctgggattatggcctgtgtcaccacgccctgtgtgggggtctcaaacaaggctttgtgtgtgcttgacaggcactcactctaaaaactgtgttacagccccggctctggattcggttctactcctgtttaaaattgtagtggtgaagggtctcttgctcaaactggcctcaaactcgagatgctcctgtctcggtctccagagtgctggaatgacagacgtgtgccactacacctgccttgactcaccacagctaagtagtgacatccccatgggccagggctggtgagtcccgtgcgtgacagtgtgctgagcagtacccttcgcttctgctcagagatgcccttctaaagctgtggcaaagagatttccacacactgccgtgcccccccaggactgcatcatgaattgatccgccctaatagcacccat

SEQ ID NO: 124 - DNA, 24 bp, Rattus rattus
gggtatccacacactcctgaaaac

SEQ ID NO: 125 - DNA, 24 bp, Rattus rattus
tgaagcaactgcctccatcgacat

SEQ ID NO: 126 - DNA, 603 bp, Rattus rattus
gggtatccacacactcctgaaaactgaggcagagagctatgaggggctcctggcaccatcgctgatccccaagaactggccagaccaagggaagatccaaattcaaaacctgagtgtacgctatgacagctccctgaagcccgtgctgaagcacgtcaacgccctcatctccccaggacagaagattgggatctgcggccgcacaggcagtggaaaatcctccttctctctcgcctttttccgaatggtggatatgtttgaagggcgtatcatcatcgatggcattgacatcgccaagctgccgctgcacacgctccgctcacgcctgtctatcatcctacaggaccctgttctcttcagtggtaccatcagattcaacctggacccagagaagaaatgctcagacagcacgctgtgggaggctctggagatcgctcagctgaagctggtggtgaaggccctgccaggaggcctggatgccatcatcacggaaggaggggagaattttagccagggccagaggcagctgttctgcctggcccgggcctttgtgaggaagaccagcatcttcatcatggatgaagcaactgcctccatcgacat

SEQ ID NO: 127 - DNA, 24 bp, Rattus rattus
cttgggcaaatttcagtggcagac

SEQ ID NO: 128 - DNA, 24 bp, Rattus rattus
ggctgatacccatgacgtttgttg

SEQ ID NO: 129 - DNA, 606 bp, Rattus rattus
cttgggcaaatttcagtggcagacattgatgtcacacatgtggccattggtcctgttctaatttatagagtgtaccagaagtctatatgatattagtgtcacatttcatttaavtgcccattaataaagccaaactgactgaagttcacttccctgttatccagcttccacagtttctgtaacctttaaccatcagatataagcagctgctcaattccatatgagggtctccacagaaaatagatgtccatcgcccaccgttcctgtagtcatatggcgttgtttattctgtgtcaagacttatagttcttgtgcatcgagatatttcaaggtgcctttatggatatagaacgtaatgtaagaaaaacgttcatagagatatacagaaacggcccaggttacttagcctaaatagtcaccttttcttccatatcaaaaacttcattagaaaaaaataatagtattatttgcagaaagctagtaggtcacagctattagcaatgagttcaaccgcaaaagtacttcataagagaatcgactaatctactaaaatattgctggtgctgcagaaggttctgctggggctgatacccatgacgtttgttg

SEQ ID NO: 130 - DNA, 24 bp, Rattus rattus
gctctggtaaatcatcactgggca

SEQ ID NO: 131 - DNA, 24 bp, Rattus rattus
actgtaaaggtcccgtggttggtt

SEQ ID NO: 132 - DNA, 628 bp, Rattus rattus
gctctggtaaatcatcactgggcatggccctgtttcgtctggtggaaccagcctctggcaccatcttcattgacgaggtggatatctgcactgtgggtctggaagagctccgaaccaagctgaccatgatcccccaggatcctgtcctgtttgtaggtacagtaaggtacaacttggatcccttggggagtcacaccgacgagatgctctggcatgttttggagagaacattcatgagagacacaataatgaaactcccagagaaattacaggcagaagtcacagaaaacggggaaaacttctcagtaggagaacgccagctgctttgtatggcccgggcacttctccgtaattcaaaaatcattctccttgatgaagctactgcctccatggattccaagacggacacccttgttcagagcaccataaaagaggccttcaaaagctgcacagtgctgaccatcgctcatcgcctaaacactgttctcaactgtgaccttgtcctggtcatggaaaatgggaaggtgattgagtttgacaagcctgaagtcctcgctgagaagcctgactctgcatttgcgatgttactagctgcagaagttggactgtaaaggtcccgtggttggtt

SEQ ID NO: 133 - DNA, 24 bp, Rattus rattus
ttacacagtggatgggggttcaac

SEQ ID NO: 134 - DNA, 24 bp, Rattus rattus
accagcccagttcaccctatgttt

SEQ ID NO: 135 - DNA, 697 bp, Rattus rattus
ttacacagtggatgggggttcaacgatgtttggaattcggtactaaaactctagtcacgaaatttaaacgttaaggtttcaggactaactgtttcccagtagccttttggtaactactgatttaatgctggatatctttttttttcttttttttctttttttttccagagctggggaccgaacccagggccttgcgcttcctaggcaagcgctctaccactgagctaaatccccaaccccactactgattttctgaactgcctcttctgagccagagtaccctccgtcttagagggagaacccgatgtggatctgtgttgtgtataatctgactctttccaaagtgctcccacgggagaccagagctgatactctgacaggcatacttgtgaaaacacaaagaccactgagacctcttctttgactaggacaaagaataataaggaagacgaaggatagcttcatctgtcaaactactttttttttccttagaaaaggcataaatgtatggagttcgattatttcggggaataactcaaaacctgcattgtgacatccgatctctggagcatgctatggtatgccaagcacccaagcacactgtgttcactcttacagacgagataattgctaaaatcctcttgagtcacaaggtcggtgatcgtacttgaaaaccagcccagttcaccctatgttt

SEQ ID NO: 136 - DNA, 24 bp, Rattus rattus
gtgcatttgattccaggagagcca

SEQ ID NO: 137 - DNA, 24 bp, Rattus rattus
ggaatgggccttatcacgatggtt

SEQ ID NO: 138 - DNA, 568 bp, Rattus rattus
gtgcatttgattccaggagagccatttgggttttctttagctaaataataaatgtacccgtctcagtcttttggactgagtcgttctgaaggctctcgtgtggacagcagtgtgtgcagtctcttacagtccgtgcctgctccacatggtaccagtcttaccagtgcttgagagctcagacacaccctgctgcatgaagttggaggtctcgggagggttttagattttgtgacgggaaccggaaaggctcgtcagagtgtggctgtgtcatggtgagcaccacgtggctgtagaggcccgacatgaggtaatgcactgagcacacaacgccactgctgctgtctgtggctgtgggttcttaaaagtgctggactttgtcatgctcgtgggccaatgacatttcctaggagcggcctctgactcctgtgcagctgcgtctgtgtcagctctggctccctggaaccacgagtgactttgcacaaaggagggctgagagcggacttgatcagtaagtcgtcgtgaatcagtttgcttgagtgggctcggaatgggccttatcacgatggtt

SEQ ID NO: 139 - DNA, 24 bp, Rattus rattus
ggaaatccactatgctgaagctgc

SEQ ID NO: 140 - DNA, 24 bp, Rattus rattus
tttgcaagacccctgagctaccat

SEQ ID NO: 141 - DNA, 609 bp, Rattus rattus
ggaaatccactatgctgaagctgctcatgggggacctggctcctgttcggggtattaggcatgcccacaggaatctgaagataggctatttcagccagcaccatgtggagcagctagacttgaatgtcagtgctgtggaactcctggctcgaaaatttcctgggcgacctgaagaggaatatcgtcaccagttgggccgctatggtatctccggggagctggccatgcgccctgttgcgagcctgtctgggggccagaagagccgggtggcctttgctcagatgaccatgccttgccccaacttctatattctggatgaacccacaaaccacctggacatggagacaattgaagctctgggccatgctctcaacaacttcaggggtggtgtggttctggtatctcatgacgagcgcttcatccgactggtgtgcaaggagctgtgggtgtgcgagaaaggcagtgtcactcgggtcgagggaggatttgaccagtaccgagccctcctccaagaacagttccgccgggagggcttcctctgaaggcccagctgagtaagaactgtgcctaggacgtggactggtttttgcaagacccctgagctaccat

SEQ ID NO: 142 - DNA, 24 bp, Rattus rattus
gaagagtccaacatagtcaccgag

SEQ ID NO: 143 - DNA, 24 bp, Rattus rattus
tgcactggatcttgttttgaccgg

SEQ ID NO: 144 - DNA, 619 bp, Rattus rattus
  misc_feature (315)..(315): n is a, c, g, or t
gaagagtccaacatagtcaccgagtgggggcgctcacaggcaaaaccggagaagaaggtcaaacgcaggctccaggtgagggagacaccacaccagctgcgctgggccagcagggactcaatgcaatgcaacacaatgcagacagtgctggggggaggttggcaggctccttccagacttcctttctcatgtgcttcttattttaagcaaactagatgggtttaaaaactcttcctggttttccggctacttttattttgaccaagaaatcctctatccaccctgtcaatttttaaaagaccattttcccttttnttcataaatcacattaactacctccacagagcctgggaagccggcctggggacacatggggtgcatccctcaaacttgggggggggcaatagggtgtcaaggacgggcaggccagctgagtggaaggggaggtgccatgaatgtccccattaagaaaacgcagctgctcacctctgccagagtaccaccaccctaggatcagtctcctacaaaagtctctatttttgtgggcaggtcagtttaacccctgtgagcctcagtttccccacctgtaagtaattgcactggatcttgttttgaccgg

SEQ ID NO: 145 - DNA, 24 bp, Rattus rattus
ccagtgttttaccagtgtgtcagc

SEQ ID NO: 146 - DNA, 24 bp, Rattus rattus
tggccctggcttgcatgatcatta

SEQ ID NO: 147 - DNA, 614 bp, Rattus rattus
ccagtgttttaccagtgtgtcagctgtggagctcttcgtagtggagaagaaactctttatacatgagtacatcagtggatattacagagtatcttcttacttctttggaaagcttgtgtctgacttactacctatgaggttcttgccaagtgttatatacacttgtttattgtacttcatgttaggactgaagaggacggtggaggcttttttcatcatgatgtttacccttataatggtggcttatacggccagttccatggccctggccatagccgcaggccaaagcgtagtgtctgtagcaacacttctcatgacgatctcttttgtgtttatgatgctcttttctggcctcttggtgaatctcagaaccatcgggccttggctgtcctggcttcagtactttagcattcctcgatatggcttcacagctttgcagcataatgaattcttgggacaagaattttgcccaggactcaatgtaactatgaacagcacctgtgttaacagctatacaatatgtactggtaatgactacttgataaatcagggcatcgatctgtcaccttggggactgtggaggaatcatgtggccctggcttgcatgatcatta

SEQ ID NO: 148 - DNA, 24 bp, Rattus rattus
ggatggaagaactcagtagatgcc

SEQ ID NO: 149 - DNA, 24 bp, Rattus rattus
tattggctactggcagatcatggg

SEQ ID NO: 150 - DNA, 640 bp, Rattus rattus
ggatggaagaactcagtagatgccataactatgtaatatgtgctggtgaagaattcttggcgatccagggcatcgatctctcatcgtggggcttctgggagaatcacctggctttagcttgtataatgattatcctcttaacaattacctatgtgcagttattacaggttaagacattagaagttcttagatcgcgggggaggaattttcttcagttgtttaactaaataccaaagtatcttctgtatgtctgtaattgtattcctggacaaatgctacatccagcctgaccctgagaggatccctctgctgtgaacactgatgaatgtagagactcatggctgctcacagtacagggctaagggacactccagtgcttatctccaacaggacacctattgcgtgccctctatagctcagagcattgtacagtagaaagagtgcaggagccagaatatgagaagaaggagtggaaatgcaatattgtggtcctgcacagccaaggcaaccatggtctgtgtctcaactctacggctacctacagaagactggatccctcatcagcacagaaggagcagaggagaactcaatgggtccatcccccattctgctcaactattggctactggcagatcatggg

SEQ ID NO: 151 - DNA, 24 bp, Rattus rattus
ggagctctttgtgattgaccagga

SEQ ID NO: 152 - DNA, 24 bp, Rattus rattus
gaatcacctggccttagcttgtac

SEQ ID NO: 153 - DNA, 573 bp, Rattus rattus
ggagctctttgtgattgaccaggatcgctttctacatgagcacaccagtggatactacagagtgtcatcctatttctttgggaaattgctggctgagctaatacccaggagactgttgccaagtacaatatttactcttataacatacttcatagcaggactaagaacgagtgtgcggggtttcttcaccatgacatttaccatcatgatgctggcttattctgccagttccctgtcactgtctttaggagctggggagaacgtagcagctataacaacactactggtgaccatctactttgtgttcatgctgtttttttcaggtctgtcactagatacaggcttcctgcctgtactctcgtggattcggtactttagcattcctcattatggatttagggctttgctacacaacgaattcctgggacaaaacttctgtccagaatacaacacagaagaagtcagtagatgtcagaactatgtaatatgtactggtgaagaattcttggagatccagggcttccatctctcatcgtggggcttctgggagaatcacctggccttagcttgtac

SEQ ID NO: 154 - DNA, 24 bp, Rattus rattus
gacacttgtgctgcttggtatggt

SEQ ID NO: 155 - DNA, 24 bp, Rattus rattus
gcatggacattgtgactgaactgg

SEQ ID NO: 156 - DNA, 606 bp, Rattus rattus
gacacttgtgctgcttggtatggtccaaaaccccaatattgtcaacagcatagtggctctgctgagtatttctgggttgctcattggatctggatttatcagaaacatagaagaaatgcccattcctttaaaaatcctgggttactttaccttccaaaagtactgttgtgagattcttgtggtcaatgagttctatggcctgaacttcacttgtggtggctccaacacttctgtgccaaataacccaatgtgttccatgacccaagggatccaattcattgagaaaacctgcccaggggccacgtccagattcacgacaaacttcctgatcttgtactcgttcatcccgactcttgtcatcctggggatggtggtctttaaagtccgggactacctgattagcagataggtaagatggcaggcaggaaagggttaatgggcaggctcgcccgctgtggagtacagagaaatactgtcttctaatcatcatggttccatctgtgaccctggcatctatgcagagcctcaagggctccgagaactcaccgtcctttgctagtccagcttatggggcagtgtggtgcatggacattgtgactgaactgg

SEQ ID NO: 157 - DNA, 24 bp, Rattus rattus
tcctagtcacgttcctgtcatcac

SEQ ID NO: 158 - DNA, 24 bp, Rattus rattus
ttcagtttgtccccagagcagttc

SEQ ID NO: 159 - DNA, 555 bp, Rattus rattus
tcctagtcacgttcctgtcatcactggggactccgacaaaacaaagtatttgggaatcatcccgaattttcccagctcagccctgggattgaatgcgtctctgtagaatctttttagtgggaaaaagatagtttgaagcccagatgtgactgagtctgctctgctgctgtacattgctgcttcaggactctcagtgggcagtgagtgaccacgtgtgcatatgtgcatgtgtgtactcagtcctaactgcatatatgctcatgtacacactctgtagttcacccgggtgaccacgtgtgcatatgtgcatgtgtgtactcagtcctaactgcatatatgctcatgtacacactctgtacagggcctccagcccatcccgtactccctccccagatcctggctctattttggtaacccactatctttaggcctggatggagaagtgtggaagagaaggaaggttggcagccatctgcctttgtaaattcgtcacttgtgctgtggtaccgaaacccaggcagttgctggttcttcagtttgtccccagagcagttc

SEQ ID NO: 160 - DNA, 24 bp, Rattus rattus
caaccgtgaaaagatgacccagat

SEQ ID NO: 161 - DNA, 24 bp, Rattus rattus
ctgagctgcgttttacaccctttc

SEQ ID NO: 162 - DNA, 822 bp, Rattus rattus
caaccgtgaaaagatgacccagatcatgtttgagaccttcaacaccccagccatgtacgtagccatccaggctgtgttgtccctgtatgcctctggtcgtaccactggcattgtgatggactccggagacggggtcacccacactgtgcccatctatgagggttacgcgctccctcatgccatcctgcgtctggacctggctggccgggacctgacagactacctcatgaagatcctgaccgagcgtggctacagcttcaccaccacagctgagagggaaatcgtgcgtgacattaaagagaagctgtgctatgttgccctagacttcgagcaagagatggccactgccgcatcctcttcctccctggagaagagctatgagctgcctgacggtcaggtcatcactatcggcaatgagcggttccgatgccccgaggctctcttccagccttccttcctgggtatggaatcctgtggcatccatgaaactacattcaattccatcatgaagtgtgacgttgacatccgtaaagacctctatgccaacacagtgctgtctggtggcaccaccatgtacccaggcattgctgacaggatgcagaaggagattactgccctggctcctagcaccatgaagatcaagatcattgctcctcctgagcgcaagtactctgtgtggattggtggctctatcctggcctcactgtccaccttccagcagatgtggatcagcaagcaggagtacgatgagtccggcccctccatcgtgcaccgcaaatgcttctaggcggactgttactgagctgcgttttacaccctttc

SEQ ID NO: 163 - DNA, 24 bp, Rattus rattus
tctttctggtgcttgtctctctgg

SEQ ID NO: 164 - DNA, 24 bp, Rattus rattus
gagcacaccatcttcttcatatct

SEQ ID NO: 165 - DNA, 460 bp, Rattus rattus
tctttctggtgcttgtctctctggccgtcgtgcttgccattcagaaaactccccaaattcaagtgtactctcgccatccaccggagaatgggaagcccaacttcctcaactgctacgtgtctcagttccacccacctcagatagaaattgagctactgaagaatggaaagaagataccaaatatcgagatgtcagatctgtccttcagcaaggactggtctttctacatcctggctcacactgaattcacacccaccgagaccgatgtatatgcttgcagagttaaacacgtcactctgaaggagcccaaaaccgtcacctgggaccgagacatgtaatcaagctctatggagctctgaatcatctggaccagtttaactccagatccggtttctaatatgctatacaatttatccacaaagtaaagaatagcaatgagcacaccatcttcttcatatct

SEQ ID NO: 166 - DNA, 24 bp, Rattus rattus
tgatgctggtgctgagtatgtcgt

SEQ ID NO: 167 - DNA, 24 bp, Rattus rattus
tccatcccagaccccataacaaca

SEQ ID NO: 168 - DNA, 883 bp, Rattus rattus
tgatgctggtgctgagtatgtcgtggagtctactggcgtcttcaccaccatggagaaggctggggctcacctgaagggtggggccaaaagggtcatcatctccgccccttccgctgatgcccccatgtttgtgatgggtgtgaaccacgagaaatatgacaactccctcaagattgtcagcaatgcatcctgcaccaccaactgcttagcccccctggccaaggtcatccatgacaactttggcatcgtggaagggctcatgaccacagtccatgccatcactgccactcagaagactgtggatggcccctctggaaagctgtggcgtgatggccgtggggcagcccagaacatcatccctgcatccactggtgctgccaaggctgtgggcaaggtcatcccagagctgaacgggaagctcactggcatggccttccgtgttcctacccccaatgtatccgttgtggatctgacatgccgcctggagaaacctgccaagtatgatgacatcaagaaggtggtgaagcaggcggccgagggcccactaaagggcatcctgggctacactgaggaccaggttgtctcctgtgacttcaacagcaactcccattcttccacctttgatgctggggctggcattgctctcaatgacaactttgtgaagctcatttcctggtatgacaatgaatatggctacagcaacagggtggtggacctcatggcctacatggcctccaaggagtaagaaaccctggaccacccagcccagcaaggatactgagagcaagagagaggccctcagttgctgaggagtccccatcccaactcagcccccaacactgagcatctccctcacaattccatcccagaccccataacaaca

SEQ ID NO: 169 - DNA, 24 bp, Rattus rattus
cactaaaatctccagaggtaccat

SEQ ID NO: 170 - DNA, 24 bp, Rattus rattus
ttgagaaagatggaaataaaggct

SEQ ID NO: 171 - DNA, 576 bp, Rattus rattus
cactaaaatctccagaggtaccattgaaatcctgagcgatgtgcagctgataaagactggagacaaggtgggagccagcgaagccacactgctgaacatgttgaacatctcccccttctccttcgggctgatcatccagcaggtgtttgacaatggcagcatctacagcccagaggtgctggacatcacagagcaggccctgcacactcgcttcctagagggtgtccgcaatgtggccagcgtctgtctgcagattggctacccgactgttgcctcagtgcctcactccatcatcaatggatacaaaagggtcctggctttgtctgtggagactgactacaccttcccactggctgaaaaggtcaaggccttcctggccgatccatctgcatttgcggctgcggcccctgtggctgctgccaccactgctgctcctgcagctgctgctgccccagccaaggtcgaagcaaaggaagagtcggaggaatccgatgaggacatgggattcggtctcttcgactaagcccctcacaccaagtcagcctgcttaatttgagaaagatggaaataaaggct

SEQ ID NO: 172 - DNA, 24 bp, Rattus rattus
tctttattccagctgagtagttca

SEQ ID NO: 173 - DNA, 24 bp, Rattus rattus
tatgctgaggtttgaactattgga

SEQ ID NO: 174 - DNA, 659 bp, Rattus rattus
tctttattccagctgagtagttcagacaaccgtcctttgttcttgatctggctggacacacctggatcgtgactactgaccctcatccagcttcctctcaggcttgaggactatctcctatctgtaacttttaagtccactgttactaaaatgtttattcatatgggaacacctaattacaacctccagaccttaggtacacagcactcatggaaaggacgcaatttacaatcgtgtacaaatgagagactgctcagatctagtaactaaagcaaccatcaagtctactgtggcaacatacagagtacctctgttacaaaactcctgtggccaagaaactagaggttttcaataaaatagttctccagatgataagacaatatagacagaatcttaagtaatgcattacaaaggtgtttgaaggcagagatctgtttttgtgtgtttgcagagatgttactgtaaagcaggcagaagagcagacactttatgccactctcatgtgtgttgggcccagtttctgaaagtgtccctatatatacacagttcacatgagtgcaaggttcacatgagcacagatctggttagagacctgcatatgagtctgtggtgtgcagggaaaaacgcaaagtcactatgctgaggtttgaactattgga

SEQ ID NO: 175 - DNA, 24 bp, Rattus rattus
ataagaggacccacaatgacatca

SEQ ID NO: 176 - DNA, 24 bp, Rattus rattus
taccctgttagcattcattgttgg

SEQ ID NO: 177 - DNA, 690 bp, Rattus rattus
ataagaggacccacaatgacatcatccacaatgagaacatgcggcaaggccgggacaagtataagacgctgcggcagatcaggcagggcaacaccaagcagcgcatcgacgagtttgaggccatgtagaggccaggccgggaccaagggcggagggcacctcacagcaggcaggtgtcactcttggctctttagtactctataagtctagaaacccccttgccgtgttccagtcccttaaagagcaggtaccgggcgatgttctgccccaagacccagtggaatcctccctggttgcttccaatagtatcacatagtgccaaacaggccagatttttatgacagttgccgaatcacttcccgttcggagcagggattcggagggctggcccgaatgacgcgattcagtgtcactggggataataatagcactgtggctcacacacgggtgccatactttctctagttttacaatgagctcaaatcgattttgttcttgatttctatgaaggatccatctctgtgtgttgaggggtgaaaatgattttgaaatttgagtcttaaaggacgcccccacacagtctccttcctccagaccgctggcagagtctcctgcggtccctcagagtgtacggtacaggactctccgatacaaaattctcatgcttaccctgttagcattcattgttgg

SEQ ID NO: 178 - DNA, 24 bp, Rattus rattus
cctctctgtcatcaatgtgggcaa

SEQ ID NO: 179 - DNA, 24 bp, Rattus rattus
tcctgcctataatcccgatgctca

SEQ ID NO: 180 - DNA, 707 bp, Rattus rattus
cctctctgtcatcaatgtgggcaacagcatcatgttcgtcatgacaccacacttactggctacctcctccctgatgcccttctctggctttctgatgggttacattctctctgctctcttccaactcaatccaagctgcagacgcaccatcagcatggaaacaggattccaaaacattcaactctgttctaccatcctcaatgtgaccttcccccctgaagtcattgggccacttttcttctttcctctcctctacatgattttccagcttgcagaaggacttctcatcatcattatcttccggtgctatgagaaaatcaagcctccaaaggaccaaacaaaaattacctacaaagctgctgcaactgaggatgctactccagcagctctggaaaaaggtacccacaatgggaatattcctcctctccaacctggtccttcccctaatggcctgaattctggtcagatggcaaattagaatgtgaaacttcgaagcagcaagaaaaggaacgaacgtcgacgttgccggaatgtttgtctagcacttcgggcaaaccatcagaaccatggagccatgaactgagacagaagggcatctatctatccagtaactgtaacccataccaatttgcttttgtttaaattttctatttaaaagataaacaagaattaggcaaaaatgttcctgcctataatcccgatgctca

SEQ ID NO: 181 - DNA, 24 bp, Rattus rattus
cacacggagcatcttctatcacta

SEQ ID NO: 182 - DNA, 24 bp, Rattus rattus
tgactgggatacaagagactggat

SEQ ID NO: 183 - DNA, 553 bp, Rattus rattus
cacacggagcatcttctatcactagacaaaagaagtaagttgaactcagaatgtttgctttttgtgtgtgtaagtctaatttatttttttcttaaattgaactgattatggaatgtgaaggttaatttcttttttttttacttttttttattaacttgagtgtttcttatttacatttcgagtgttattccctttcctggtttcggggccaacatccccctaatccctccacctccccttctttatgggtgttcccctccccatcctccccccattgccgccctccccacaacaatcacgttcactgggggttcagtcttagcaggaccaagggcttccccttccactggtgatcttactagaatattcattgctacctatgaggtcagagtccacggtcagtccatgtatagtccttaggtagtggcttagtccctggaagctctggttgcttggcattgttgttcataaggggtctcgagctctatcaagctcttcagaactcagaatgttttaaagcactgggcattgactgggatacaagagactggat

SEQ ID NO: 184 - DNA, 24 bp, Rattus rattus
taagagtatttgctggtattcccg

SEQ ID NO: 185 - DNA, 24 bp, Rattus rattus
ccacactacactttaaagcttcct

SEQ ID NO: 186 - DNA, 615 bp, Rattus rattus
taagagtatttgctggtattcccgcacctgtttactttggcgctttgatagacagaacctgtttacattggggaaccctgaaatgtggtcagcgaggggcatgcaggatgtatgacataaacagtttcaggcacatttacctggggttgcctatagcactaagaggatcaagctatctgcctgccttcttcattctgatacttatgaggaaattccagttccccggggacattgactcttcagcaactgatcatacagagatgatgctcggagagaaggaaagcgagcacacagatgtgcatggaagtcctcaggtcgagaatgacggagaactgaaaacgaagctgtaatgagttttctactgccctgttcaaggccatgaacagaatgcacacttcccttcctcggaatcctgagagatacaataggaaccttctctttaaggacctcaacaattgtttttctcactataaaaataattgctgatatcatttttatagtgagaaaaacaataaaaataattgctgatatcattttcagaatttcaggtgatatttaagatttccctggggaagacttttatggtgacccccacactacactttaaagcttcct

SEQ ID NO: 187 - DNA, 24 bp, Rattus rattus
caccctttgagatcacctgccttt

SEQ ID NO: 188 - DNA, 24 bp, Rattus rattus
aaactatgccccggtatctgagga

SEQ ID NO: 189 - DNA, 456 bp, Rattus rattus
caccctttgagatcacctgccttttctcttctgcctaaagtcttaaggcctgaagtacactgagctgaatgagcaccgggcctgagagtttagtttctccaagtccttggaaggtatccccagcgtaggccctacgtcctccagacaagatgcccataatgaggcggcctctgttttcaccagtgtctcaggaatacttaatggagtgaaaagagggagtcttgccttcttgggccaggcagcccggatctcctctgcctctgcccacacccaggagagccagaggagaagcaggtagttggtttcttatctgctccagcggggctaagggagctgggtgtgtccacttttcatctggattccgtctagcatgaaagccgtgccctcgaggctgttttggaaaccaccattttgggaagtatccctctctataaactatgccccggtatctgagga

SEQ ID NO: 190 - DNA, 24 bp, Rattus rattus
accttgggatgtctgcagctctaa

SEQ ID NO: 191 - DNA, 24 bp, Rattus rattus
gacttctctctcatgtgccatctc

SEQ ID NO: 192 - DNA, 717 bp, Rattus rattus
accttgggatgtctgcagctctaagaggatcaagctatctccctgcatttgttattgtaatacttacaaggaagttctctcttcctgggaaaatcaactcttcagaaatggaaattgcagagatgaagctcacagagaaggaaagccagtgcacagatgtgcacagaaatcctaagttcaagaatgatggagaactgaaaacgaagctgtaatgacttttctactgccttgtgtaaggccatgaacagaatgctagaattcaaaacacttcacttttgaatcatgagataaacaacaggaatgcttaactttaagaacctcaacaattagttttacactcatgataaaagtagcattttcatgaggctggtgtaggacttaagtttttcccaggatagatttctatagagacccccacattgaacattaaagcttccttcattgtatcaaggaaagtatgtatttctaagatatcttcaagtagctttaaagcctagtccttaaacactatttcattctgttgaacttatgtttcgatgtggggggatttagagagacaaatatgcattgtggctgtgctcagaaaaaaaaaaaaaaaacctattctttctatgcacaagctgtctgcatacgtttatatctagaagttattaacccttattttttattttagtcatgatgcttccgagattagacttctctctcatgtgccatctc

SEQ ID NO: 193 - DNA, 24 bp, Rattus rattus
ttcagggggcttcaatggcttagt

SEQ ID NO: 194 - DNA, 24 bp, Rattus rattus
ggtgcttgccttcatgaacttcca

SEQ ID NO: 195 - DNA, 595 bp, Rattus rattus
ttcagggggcttcaatggcttagtgttcattctattcaagggccatggagcacatagttattaacattcataataaacttagagtaaaacctttaaagagggaccagatagaaagttcgatagaaagaactgtttgccaccgaacctgaaaaggttgttgtgatccttgggaccaacgtgaaggagagaacaaactctcacaagttgtgctatatctctttttaattgtgcatgccccattgcaaatcaattaataaaaaaagcattaaaaggtttaagaccgacatttgctgtaaaattatagctcataaacgtgaaagtacacatcaaaaataaaatcaagttgtggttgttttaatgagaaatatccctcctaggcataggcatttggatatttggtttctaatgaatgactctgcttagggaagattggatgtgcatccctaagacaaaaggtgaatcactgagatgggttgaaagttaaaagcctcacctacttccagtacactctctgctttgtgctttggttgatgatatgaaatcatggtttcctgctccagccaccatgcctggtgcttgccttcatgaacttcca

SEQ ID NO: 196 - DNA, 24 bp, Rattus rattus
acctagtgttgcctgcagctctta

SEQ ID NO: 197 - DNA, 24 bp, Rattus rattus
atctctgggaccaacatagtaggc

SEQ ID NO: 198 - DNA, 632 bp, Rattus rattus
acctagtgttgcctgcagctcttagaggatcaagctatctccctgcactcttcattctgatacttatgaggaaattccagttccctggggaaatcgactcttcagaaactgaacttgcagagatgaagatcacagtgaagaaaagtgagtgcacagatgtgcatggaagtcctcaggtcgagaatgacggagaactgaaaacgaggctgtaatgagttttctactgccctgtgcaagatcatgaacagaatgcatacttcatgtcctttgcgtcacgagaagcactagagcaactctttgatgctctcagatgcactctggcattcaggtgcatcaagttgtgtgtcgtttcatgctgctacttggggtattttaggagtatttttctaaaatatatcagggctggatacagtgtaagatattctccaaaggccactgtctcatcctcaggaggtctctaatgttcagtgttcatattattcatgtgtcctcagagcacatggctactaactttcaaaatcaacttagggtaaaacctttaaggaggggacagttaaatatctcagtggagaggtgtgctttctaccaagcctgacaaggtgggtttgatctctgggaccaacatagtaggc

SEQ ID NO: 199 - DNA, 24 bp, Rattus rattus
catgggtgacctctgtttctctga

SEQ ID NO: 200 - DNA, 24 bp, Rattus rattus
gatgagtctgttagcgggtttcca

SEQ ID NO: 201 - DNA, 685 bp, Rattus rattus
catgggtgacctctgtttctctgaggtctttggaccaatgtgaggtctctgggcggagaagagcaaagccaacccaattcctcacagtgagctgtggtgtagtattctagggtcagattccctggaaccccagtcttttccaagacagacctggtcctgctttctagacaattctgtctggcctagttgcttccgggcagcagaagagaaacccctgatctgctcccaggctggcctgttaacgctactcctccctgtgtagccatgaagggaggtgaggaactaccagcagccttccaacctgtgtgccagctcttagctaagggaccaggtatttgtcctcggtgcagaagaagggactacagaagctctcattcctgtcaggcatggtggcttggcacacatctgtcacctagcatttagaggctagatcagaagttcaatcagtgagtctcagctccatagtgagtttgagtctaacctggactacatgagaatgtcttgaaaaatctaaaaagaataaagagaaggaaagaggagaaggggaggaggatgaggagaagatcctggtcgacgatgtcagtcctacagttgagtagtttaaccagtgcctgatcctacactaatcagtgccaagacttttgaaaatcactttcaccaagatgagtctgttagcgggtttcca

SEQ ID NO: 202 - DNA, 24 bp, Rattus rattus
ctactctccgtgcaacaacaactg

SEQ ID NO: 203 - DNA, 24 bp, Rattus rattus
tgagcaccagtgagttcttagcct

SEQ ID NO: 204 - DNA, 611 bp, Rattus rattus
ctactctccgtgcaacaacaactgtgaatgccagacagattccttcacgccagtgtgcggggccgatggcatcacctatctgtcagcctgcttcgccggctgcaatagcacgaacctcacaggctgtgcgtgcctcaccaccgtcccccctgagaatgccaccgtggttcctggaaaatgtcccagtcctgggtgccaagaggccttcctaaccttcctctgtgtgatgtgtgtgtgcagcctgatcggggccatggcgcaaaccccttctgtcatcatcctcatcaggacagtcagccctgaactcaagtcttacgcgctgggagttctttttctgctccttcgtttgttgggtttcatccccccacccctcatcttcggggccggcatcgactccacctgtctgttctggagcaccttctgcggggaacagggcgcctgtgtcctctatgacaacgtggtctacagatacctgtacgtcagcatcgccattgcactcaaatccttcgccttcatcctctacaccaccacgtggcagtgcctgcggaaaaactataaacgctacatcaaaaaccacgagggcgggctgagcaccagtgagttcttagcct

SEQ ID NO: 205 - DNA, 24 bp, Rattus rattus
attcccgcgctaactgctactcta

SEQ ID NO: 206 - DNA, 24 bp, Rattus rattus
tcctggagtctcttaagtggtcac

SEQ ID NO: 207 - DNA, 618 bp, Rattus rattus
attcccgcgctaactgctactctacgatgtgtctgtgatcggcagaggtcctttgccctggggatccagtggatcgtcgttagaacgctaggcagtatcccagggcccattgcctttggctgggtgattgacaaggcctgcctgctgtggcaagaccagtgtggtcatcagggctcctgcttcgtgtacaagaatgaagccatgagtcggtacctgctcattgcaggactcactttcaaggtattaggcttcctcttctttgtcgctgcctactttctctacaagtccccttcagtgtcctcagacggcctggaggcctccctgcccagccagtcctcagcctctgacagccccacagaacagctccagagcaacgtctgacacaggtggctcctccacatttcctgaggactctccctggaaaccctgacccaccctcacaggatagtaacactcatgaccttgcaaaacctcacactgtgttctgggacctcgagccgccccacaccgtgactgaacagccttcagagactttaaggaggaagtcacgtgggttgtgtatgggtcatgtatgaaccagacacatttcccaaatcctggagtctcttaagtggtcac

SEQ ID NO: 208 - DNA, 24 bp, Rattus rattus
accttggattgcctgcagctctaa

SEQ ID NO: 209 - DNA, 24 bp, Rattus rattus
ctgaaaatatgccccctggttgtg

SEQ ID NO: 210 - DNA, 605 bp, Rattus rattus
accttggattgcctgcagctctaagaggatcaagctatctgcctgccttcttcattctaagacttatgaggaaattccagttccccggggacatcaactctccagtaactgatcatgtggagatgatgctcacagagaaggaaagcgagcacacagatgtgcacagaagtcctcaggtcgagaatgatggagaactgaaaacgaagctgtaatgagttttctactgccctgttcaaggccatgaacagaatgcacacttcccttcctcggaatcccgagagatacaataggaaccttctctttaaggacctcaatgattatttttctcactataaaaataattgctgatatcactttcagaacttcagggtgatatttaagatttccccgggaaagacttttatggtgacccccacactacactttaaagcttccttcattttcacataacattttctcttaactcaatcaagggaagtatgtgtttcccacacagcttcaaatgagtttaaaactttcctattccagaaacactatttaatttcactgaatttaaatttccatactgggggtaattagaactgaaaatatgccccctggttgtg

SEQ ID NO: 211 - DNA, 24 bp, Rattus rattus
atgggattacctatgcgtcggctt

SEQ ID NO: 212 - DNA, 24 bp, Rattus rattus
aaacgcagcagcttcataaccgca

SEQ ID NO: 213 - DNA, 554 bp, Rattus rattus
atgggattacctatgcgtcggcttgtcttgctggctgtcaatcctccagccggagtggaaagaacattatattttctaactgcacttgtgtgggatttgctgcccctaaatcaggaaactggtcaggcatgatgggcaggtgtcagaaagataatggatgttcccaaatgtttctgtatttccttgtgatttcagtcatcacatcatatacattatctctaggtggcatacctggatatatattactcttgaggtgcattcaaccacaacttaagtcttttgctctgggcatctacaccttagcagtaagagttcttgcaggaatcccagcccccgtgtactttggtgttttaatcgacacttcgtgcctcaagtggggatttaagaaatgtggaagcagaggctcctgcagactgtacgactctcatgctttcagacatatatacctgggactaaccacgctcttgggcacggtgtctgtcttcctaagcacggctgtgcttttggttttaaagaaaaaatacgtctcaaaacgcagcagcttcataaccgca

SEQ ID NO: 214 - DNA, 24 bp, Rattus rattus
aaccacgcgagctgtcaggataat

SEQ ID NO: 215 - DNA, 24 bp, Rattus rattus
tcttgggatgatggtatgctctgc

SEQ ID NO: 216 - DNA, 531 bp, Rattus rattus
aaccacgcgagctgtcaggataatggagcaaattgcacagaagaacgggaaggtgcctcctgctgacctgaagatgctctgccttgaggaggatgcctcagaaaagcgaagtccttcgtttgccgacctgttccgcactcccaacctgaggaagcacaccgtcatcctgatgtatctatggttctcttgtgctgtgctgtaccagggtctcatcatgcacgtgggagccacaggggccaacctctacctggacttcttttattcttctctggtggaattccccgcggccttcatcatcctggtcaccattgaccgcattggccgcatctacccaatagcggcctcgaatctggtgacgggggcagcctgcctcctcatgatctttatcccgcatgagctgcactggttgaacgttaccctcgcctgtcttggccgtatgggggccaccattgtgctgcagatggtctgcctggtgaacgctgagctgtaccctacattcatcaggaatcttgggatgatggtatgctctgc

SEQ ID NO: 217 - DNA, 24 bp, Rattus rattus
gaaatggtctgcctggtcaatgct

SEQ ID NO: 218 - DNA, 24 bp, Rattus rattus
accaaaatacccaagggagctgtg

SEQ ID NO: 219 - DNA, 658 bp, Rattus rattus
gaaatggtctgcctggtcaatgctgagctgtaccccacatacatcaggaatcttggtgtccttgtctgctcctccatgtgtgacattggcggcatcatcacgcctttcctcgtctaccgtctcacggacatctggatggagttcccactggttgtatttgctgtggttggccttgtcgctggggcacttgtgctgttgctacctgagaccaaagggaaggctctgcctgagaccatcgaggatgccgagaatatgcagaggccaagaaaaaaagaaagaaaagagaatttacctccaagtcaagcaagcagaccgtccgctaagctaaaaagaaagggcatcattgctgctggagctgactttgctctctctgaggccagagatggagcttctctctcccctccccccaaacccacacaaaccaacctcacttacccctgaactccatcagcaagagctgtagcttgcacggtctgttgcactgatgtgtcaagctcttcctcccagccaggattttccgcctcactctgctctcagcactcccaggaaatgaccattgctttactggattcgttatggttgttttttcatctttacattctttatttagtttccttctccaccacaacatcaaaccaaaatacccaagggagctgtg

SEQ ID NO: 220 - DNA, 24 bp, Rattus rattus
tgaaatcacactgcagtccccaca

SEQ ID NO: 221 - DNA, 24 bp, Rattus rattus
cagactcttgacagccttttgggt

SEQ ID NO: 222 - DNA, 704 bp, Rattus rattus
tgaaatcacactgcagtccccacaccccaatattttgtctcctccttcagtggaccgctataatcacagattcttaattgaggaagaaaaaaaaaacatggattttgatttcccgggccttagaatttgaaaaataaaggggtaattatgtcatatttgtgaattccgtttcagtggtgcctgtggctgagagtccaaagaatagactttcttcatgccatctgggcacttccgacttatcttgggagaaaaacaaaacaccaaaaacaaatacaaatacagttgttgtcacttcatgataaaagtcaattgtattcatactttaaaggattggcgacccatttataagggatgtaggagatactaatgagggactgaattttttttttattagatcaagactcctcaagcaaagactcaaatgtaaacacggtattctacgtggtgtgcagttcttgataaattttcggactcagtgtgtatgttagactgaaagtttcttaaacttcaaactcagtgtggacaggcaaaagtagcctcaaagggaaaccttaccgatgtggaagaaagaaatgcatatgtggagaacataagacatgtgtgccaccccagagaagatgtgcgtgtgactgtaaaacatcgtttcaccctgacgcatgtgagaaccgaatgtgagtgttcagactcttgacagccttttgggt

SEQ ID NO: 223 - DNA, 24 bp, Rattus rattus
tcctctctggcctgattgaagttc

SEQ ID NO: 224 - DNA, 24 bp, Rattus rattus
ggaggatcgagaagtcaaggtcat

SEQ ID NO: 225 - DNA, 658 bp, Rattus rattus
tcctctctggcctgattgaagttccagcttatttcacagcctggctgctacttcgaaccctgcctcggagatatattatagctggggtgctgttctggggaggaggtgtgcttctcttggtccaagtggtacctgaagattacaactttgtgtccattggcctggtgatgctggggaaatttggggtcacctctgccttctccatgctgtacgtcttcacagcggagctctacccaaccctggtcaggaacatggctgtgggcatcacctccatggcctcgagggtgggcagcatcattgccccctatttcgtgtacctgggtgcttataaccgactcctgccctacatcctcatgggcagtctgactgtcctcattggaatcatcacactttttttccctgagagttttggagtgactctaccagagaacttggagcagatgcagaaagtcagagggttcagatgtgggaaaaaatcaacagtctccatggacagagaagaaaaccccaaggttctaataactgcattctgacaaggtttccaaggcacgtggcaaactgaaaaacaggtggggtacaatgagcagggtgtgctggagccagcctgaaagcctgccctcttggtatggggacaggaggatcgagaagtcaaggtcat

SEQ ID NO: 226 - DNA, 24 bp, Rattus rattus
actcagtggtggtgtgcttgtcta

SEQ ID NO: 227 - DNA, 24 bp, Rattus rattus
atcggtggggatttcgtgttcagt

SEQ ID NO: 228 - DNA, 716 bp, Rattus rattus
actcagtggtggtgtgcttgtctaggatgcaccagaaggaaacaaaaatttcttttcagaaaataagtgattccatggggagtttgatttctcatcttacctaagttaaccaaaatcctgtgatcattttaacccacaacagaagaacacaagaccaagggaaccctaaaggaaactgaggtgaggctggtacataaagcagacagtgtgtggactgtggctgctctgcccctcagccagctgtactgtgtgtgtctggtcagggtcctgccttgcccagaccctgtgagaaacctactgttgaggccaggcttggcctccactgctgtgtaaatcagaactcaggctgccagacacttggctgtgtcttgagggaaatgtatggataacagagtgttccttccttcttccagcactgtcatgggagtttgtcatctgctgttgtatctcaagctatttgtcctttagcagaaacttgggaactgcctgtgtttcccagctcagggttaccctggctggtgtgcagttgccaatataaatggccttcacagtcttagccactagagcggctctgagtgccaaaaatactaacaccatgcttcttccttttacgatgtgtaatcatgaggaaaatcacaagaaagaaatgtaaattgtgttcacagtctctcagagtcgctggctgcagtcacatcggtggggatttcgtgttcagt

SEQ ID NO: 229 - DNA, 24 bp, Rattus rattus
ctgcctgccaagtttgtatgcttc

SEQ ID NO: 230 - DNA, 24 bp, Rattus rattus
ctccccaaaggtcatgtcagtaga

SEQ ID NO: 231 - DNA, 673 bp, Rattus rattus
ctgcctgccaagtttgtatgcttcctagtcatcaactccatggggcgccggcctgcacagatggcctccctgctgctggcaggcatctgcatcctggtgaatggcataataccgaagagccatacgatcattcgcacctccctggctgtgctagggaagggctgcctggcttcctctttcaactgcatcttcctgtacaccggagagctgtaccccacagtgattcggcagacaggcctgggcatgggcagcaccatggcccgggtgggcagcattgtgagcccgctggtgagcatgactgcagagttctacccctccatgcctctcttcatcttcggcgctgtccctgtggtcgccagtgctgtcactgccctgctgccagagaccttgggccagccgctgccagatacagtgcaggacctgaagagcaggagcagaggaaagcagaatcaacagcagcaggaacagcagaagcagatgatgccgctccaggcctcaacacaagagaagaatggactttgagaacggaagggcttcacacagcactaaagggagtggggttctacaggtcctgccgtctacatgaggagggggagtgagtagagggactggaccatccaaatgtggaggctgccattcagagaaatccctccccaaaggtcatgtcagtaga

SEQ ID NO: 232 - DNA, 24 bp, Rattus rattus
cctctccttaagttatctgggccg

SEQ ID NO: 233 - DNA, 24 bp, Rattus rattus
ttcctggccacaagagactgatcc

SEQ ID NO: 234 - DNA, 543 bp, Rattus rattus
cctctccttaagttatctgggccggcgcatcactcagagcttcctcctgctcctagcaggaggggccattttggccctcatctttgtgccttcagaaatgcagctcttgagaacagcactggctgtgtttggaaagggatgcctatctggctccttcagctgcctcttcctctacacgagtgagctctaccctacagtcctcaggcaaacaggtatgggtatcagtaacgtgtgggctcgagtaggaagtatgatagccccactggtgaaaatcacgggtgaactgcagcccttcatccctaatgtcatctttgggaccacggccctactgggaggcagtgctgccttctttctgcttgagaccctcaatcggcccttaccggagactatcgaggacatacaaaactggcacaagcaagtccagaaaacaaagcaggagtcggaagcagaaaaggcatcccaaataatcccgctgaagactggtggataggaccctagctgagaacaacagaatcctctttcctggccacaagagactgatcc

SEQ ID NO: 235 - DNA, 24 bp, Rattus rattus
cttgccctggatcatctatggagt

SEQ ID NO: 236 - DNA, 24 bp, Rattus rattus
ctgctgttgcgataatctcctgtg

SEQ ID NO: 237 - DNA, 547 bp, Rattus rattus
cttgccctggatcatctatggagtcctttccttccttggtggccttgttgtccttctcctccctgagaccaagaatcagcctctgcctgactccatacaggatgtggaaaatgaaggaagagcctccagacaaggaaagcagaatgatactctcatcaaagtgacacagttttaagagactccaagagctgaaatctgataaaggagcaagataagaaaactgtcactcagatttatgatggcccaggttcactctagatacagcaaaattccttatcaagtaacgatatagcaaaaattttgtattacatttaaaatttccacattcaactgatacttaaattatctcaataacaaaattaaaggaaaacaacacagtgaaataaatcttcagagttttaatagacacttatgaagtttccacaaaggatgtggatgaaccttcttcccattattgtgacataatgcttgggaaaattaaaaatggataatttattgtgaaattcccattagtttcatcccactgctgttgcgataatctcctgtg

SEQ ID NO: 238 - DNA, 24 bp, Rattus rattus
cgtttgggcactctactccacaca

SEQ ID NO: 239 - DNA, 24 bp, Rattus rattus
tcctgaagtctgcccggttgtaag

SEQ ID NO: 240 - DNA, 658 bp, Rattus rattus
cgtttgggcactctactccacacacctgggctgcgcctccgaaccttcatctccatgctgtgctggtttgcctttggcttcaccttctatggcctggcccttgacctgcaagccctaggaagcaatatcttcctgctccaggcactcatcgggattgtggacctcccggtgaagatgggcagcctgctgctgctcagccgcttgggccggcgcctctgccaggccagctccctggtgctgccgggactctgcatcctggccaacatactggtgccccgtgagatggggatccttcgctcatccttggctgtgctggggctggggtccctgggggctgccttcacctgtgtcaccatattcagcagtgaactcttccccactgtgatcaggatgactgcagtgggcctgggccaggtagcagcccgaggaggagccatgctagggcctttggtgcggctgctgggtgtctatggctcctggctgcctctgctggtgtatggagtggtgccagtgttaagcggcctagctgcattgctgctgcctgagaccaagaacttgccactgcctgacaccatccaagacatccagaaacagtcagtgaagaaagtgacacatgacatagcaggcggctccgtcctgaagtctgcccggttgtaag

SEQ ID NO: 241 - DNA, 24 bp, Rattus rattus
ctgcttatcctgggcttcaccaac

SEQ ID NO: 242 - DNA, 24 bp, Rattus rattus
acctcctaaccgctgtgaccatgt

SEQ ID NO: 243 - DNA, 608 bp, Rattus rattus
ctgcttatcctgggcttcaccaactttatcgcccatgccattcgccactgctaccagcctgtgggaggaggagggagcccatcagacttctacttgtgctctcttctggccagcggcacagcagccctggcctgcgtcttcctgggggtgaccgtggaccgttttggccgtcggggcatcctgcttctctcaatgactctcacggggattgcatccctggtcttgctgggcctgtgggattatctgaacgatgctgccatcacaaccttctcggtcctcggactcttctcctcccaagcttctgctatcctcagtaccctccttgctgctgaagtcatccccaccactgtccggggccgtggcctgggccttatcatggcacttggggcgcttggagggctgagctgtccagctcagcgcctccacatgggccatggagctttcctgcagcatgtggtactggcggcctgtgccctcctctgcatccttagcatcatgctgctgccagagaccaagcgcaagcttctgccagaggtactccgggatggggaactgtgccgtcggccttccctgctgaggcagccacctcctaaccgctgtgaccatgt

SEQ ID NO: 244 - DNA, 24 bp, Rattus rattus
gcttttgtggtcaccctcttagga

SEQ ID NO: 245 - DNA, 24 bp, Rattus rattus
tgcatccattgacccgtactgtag

SEQ ID NO: 246 - DNA, 568 bp, Rattus rattus
gcttttgtggtcaccctcttaggagctgtcctcagctttacctgtatccctgttaccaccaaggaggccagtgtccagtcagcccatcagggtggaaccagtgtatttgacctgaaggccatctcccgcctgctgctgctgcccagagtgctgcccgtattcctggtcaaggtaatctctggcttcccttcaggactcttcatggtgatgttctccatcatctccatggacttcttccagctggaggctgcacaggctggctacctcatgtccttctttgggatcctccagatgatgatccaaggcctggttattgggagactaagcacccgttttccagaggaagccctgctgagatccagtgtactagtctttgctgttgtgggcctgggcatggcactgatgtccaatgtgttccacttctgccttttgttgcctggactcgtattcagtctctgtgctctcaacatagtcacagacagcatgctgaccaaggctgtatctgcttcagacacagggaccatgttgggcctctgtgcatctgtgcatccattgacccgtactgtag

SEQ ID NO: 247 - DNA, 24 bp, Rattus rattus
ttcccagtacaagcaacgacgcct

SEQ ID NO: 248 - DNA, 24 bp, Rattus rattus
attgggaagggtgcaacggtcatc

SEQ ID NO: 249 - DNA, 540 bp, Rattus rattus
ttcccagtacaagcaacgacgcctggcaggggctgaggagtggcttggtgacaagaaacagtggatctctgtcagagcagaaatcctgactacatacgccctctgtggatttgccaacttcagctccatcggcatcatgttgggaggcctgacctccctagtcccccagcggaggagcgacttctcccagattgtactccgggcactgatcacaggggctttcgtgtccctgctaaacgcctgtgtggcagggatcctctatgtacccaggggggtcgaggtggactgcgtgtcccttctgaaccaaactgtcagcagcagcagctttgaggtttacctgtgctgccgccaagtcttccagagcactagctcggagttcagccaagtggcactggacaactgctgtcgattttacaaccacacagtctgcacatagctgggacggagcatcttcctagcctcagggctcatccagcccagagaggccgtgggactcgtcactacctccatcccacaattgggaagggtgcaacggtcatc

SEQ ID NO: 250 - DNA, 24 bp, Rattus rattus
agtccagcctcaggaatcttgcta

SEQ ID NO: 251 - DNA, 24 bp, Rattus rattus
agtgatagagtagaggccatgtcc

SEQ ID NO: 252 - DNA, 526 bp, Rattus rattus
agtccagcctcaggaatcttgctaaatgctgtgacctctataccagcactgtgtgtgcctgaggctggtggggccattccgtgacagttcttatagaacagattcatattaccaaatacatgttcatgtacttaggcttattctctgagaactgcactaaactccacaaaatgaaagtcctgatctcactgtggctctgtataaaaaccagcatccacctttccactggcatgccacatagtagatgtgaaattcattatagaccctcttgagccaaagtatggtgggaatgtagctaagggggaaatatgtgtgtggtaagtgctaagatggagattcaacccctggccagggccagagtggggagagtggggaaatccaagtagatgcttagatttaacttggtggtacaccctgtggtcacttacctgtaagctcagagctaaggggattgcctcagatccaaggcaagcctggcccgaaccctgaagtctttcacagaagtgatagagtagaggccatgtcc

SEQ ID NO: 253 - DNA, 24 bp, Rattus rattus
acttgctcaccgcttctgtcatgt

SEQ ID NO: 254 - DNA, 24 bp, Rattus rattus
acttacgtctatagctccgtccag

SEQ ID NO: 255 - DNA, 526 bp, Rattus rattus; identical to SEQ ID NO: 252

SEQ ID NO: 256 - DNA, 24 bp, Rattus rattus
acttgctcaccgcttctgtcatgt

SEQ ID NO: 257 - DNA, 24 bp, Rattus rattus
acttacgtctatagctccgtccag

SEQ ID NO: 258 - DNA, 586 bp, Rattus rattus
acttgctcaccgcttctgtcatgtcggcgcctgcagccctggctgtggccaaactcttttggcctgaaacagagaaacccaaaataaccctcaagaatgccatgaaaatggaaaatggtgattcccggaatctcctggaggcggccacgcagggtgcatcttcgtccatccccctggtggcaaacatcgctgcaaatctgatcgccttcctggccttgctttcctttgtgaactccgctctgtcttggtttggaagcatgttcgactacccacagctgagtttcgagctcatttgttcttacatcttcatgcctttctccttcatgatgggagtcgactggcaagacagatttatggtcgccaaactcataggctacaagacgttcttcaatgaatttgtggcttatgaacacctctcaaaattcatcaatttgaggaaagcggctggacccaaatttgtgaatggtgtgcagcaatatatgtcaattcgctcggagaccatcgcaacttacgccctctgtggttttgccaattttggttccctaggaatagtgatcggtggacttacgtctatagctccgtccag

SEQ ID NO: 259 - DNA, 24 bp, Rattus rattus
aaactgctacttcatccctgtggc

SEQ ID NO: 260 - DNA, 24 bp, Rattus rattus
tgcctaagccaagcacaagagact

SEQ ID NO: 261 - DNA, 644 bp, Rattus rattus
aaactgctacttcatccctgtggcctgcttcctgaatttcaatgtctttgactggctaggccggagcctcacagctatttgcatgtggcctggtcaggacagccgctggttgccggtcctggtcgcctgcagggttgtgtttatccccctgctgatgctctgcaatgtgaagcagcaccactacctgccctccctctttaagcatgatgtctggttcatcaccttcatggccgcctttgccttctccaatggctacctcgccagcctctgcatgtgcttcgggcccaagaaagtcaaaccggctgaggcagagactgccggaaacatcatgtccttctttctgtgtctgggcctggctctgggagctgtgttgtccttcttgttaagggcacttgtgtgagcgaccctgtgtggacagaggaactacactgcctgcttcctgctcacttccttcgctgttagggacgagcaggggtccagagggctgctcttctgctttcctccggtgctgggcccagatgtccaggaacaaaggagggagcctctgaggatggacttgggattgggggtcagagtggtagggggacaatggtctctgacggacagctctgactgatccctgcctaagccaagcacaagagact

SEQ ID NO: 262 - DNA, 24 bp, Rattus rattus
cgttactacctgaccaagaagcct

SEQ ID NO: 263 - DNA, 24 bp, Rattus rattus
tcacattcatgctgctcttcgcca

SEQ ID NO: 264 - DNA, 559 bp, Rattus rattus
cgttactacctgaccaagaagcctcaggccccagttcaggagctggagaccaaagctgagctcctcggagctgatgagaagaatgggattcctgtcagcccccagcaggcaggcccaactctggatcttgacccagagaaggagctggagctggggctggaggaaccacagaagccaggaaaaccttcggtctttgtcgtcttccggaagatctggctgacggcgctgtgccttgtgttggtcttcacagtcaccctgtcggtctttcctgctatcacagccatggtgaccaccagctccaatagccccgggaagtggagtcagttcttcaaccctatctgttgcttcctgctcttcaacgtcatggattggctgggccggagcctgacttcctacttcctgtggccagatgaggacagccagctgctgcccctgctggtgtgcctgcgcttcctgttcgtgcccctcttcatgctgtgtcatgtgccccagcgtgcccggctgcccatcatcttctggcaggatgcctacttcatcacattcatgctgctcttcgcca

SEQ ID NO: 265 - DNA, 24 bp, Rattus rattus
gcgccgttttcctctacttcatca

SEQ ID NO: 266 - DNA, 24 bp, Rattus rattus
tctcatggcgttaagcaaggggtt

SEQ ID NO: 267 - DNA, 598 bp, Rattus rattus
gcgccgttttcctctacttcatcaccgcccttatcttccccgctatctccaccaacatccagcccatgcacaagggcaccggctctccatggacctccaagttctatgtgcccctcaccgtcttcctccttttcaactttgctgacctctgcggccgacaggtcacagcctggatccaggtgccaggtcctaggagcaagctgctccccatactggcagtctctcgcgtctgcctcgtgcctctcttcctgctctgtaactaccagccacgctcacacctgactctggtgcttttccagtctgacatctaccctatactcttcacctgcctcttggggctcagtaatggctacctcagcacgctggtgctcatgtatgggcccaagattgtgccccgggagctggctgaggccaccagtgtggtgatgctgttctacatgtcactgggtttgatgctgggctcagcctgtgcggccttgcttgagcactttatctaggaggggtggcaaggatgtgggttctgtgtgagtgagtgtggtttgggtccctgggacctggacagggtgagccgaggtctcatggcgttaagcaaggggtt

SEQ ID NO: 268 - DNA, 24 bp, Rattus rattus
actacacaaccatccccactgaga

SEQ ID NO: 269 - DNA, 24 bp, Rattus rattus
cctgaaagaataaatgccactggg

SEQ ID NO: 270 - DNA, 442 bp, Rattus rattus
actacacaaccatccccactgagattatggaccacaatgtttctcccttcatgaggaaaggtactactggggactggaaaaataccttcactgtagcccagaatgagcgctttgatgcccactatgctaagacaatgacagattgtgacttcaagtttcgttgtgaactatgagtggattatggctatactgggaaccaaggcaaactgacacagcccatcatgatctcaagtaaaatgtgatgtgttcaatctacttgttgtatgcctagaggaaatctgagctaagagaataggattggggatgtggctgaggcagagggttttatcaacgcatgtcaggaaagcaatcagtcccaacacctaaaaagaacctaaagtacaaacatgcaaaaaatagtaagataaactatattttacctgaaagaataaatgccactggg

SEQ ID NO: 271 - DNA, 24 bp, Rattus rattus
agagttggtgggaaaagagggaag

SEQ ID NO: 272 - DNA, 24 bp, Rattus rattus
ccgaattatctagggccaaggtct

SEQ ID NO: 273 - DNA, 532 bp, Rattus rattus
agagttggtgggaaaagagggaagggcatcccatacttttcttatactatgaagacttgaaaaagaacccgaagaaagaaatcaagaagattgccaactttctagacaagaccttggatgaacataccttggaaaggatcgtccatcacacctcctttgaagtgatgaaggataaccccctggtcaattacacccatctgcccacagaaataatggatcacagcaagtccccattcatgagaaaaggtgttgttggtgactggaaaaattacttcacaatgacccaaagtgagaaatttgatgccatatataagaagaaattgtctggaacaacacttgagttctgcacagatattcagagtgcctaaacttcaacttgaatatatgatttcttgaaatagtagtttgacagggaaatcagatggatttgtgagggagaaataaatgtgcttttaaaacactgattaaatatgccctgcacatccctcagcaggaattattaataattccgaattatctagggccaaggtct

SEQ ID NO: 274 - DNA, 24 bp, Rattus rattus
actttagatctattttcaggaacg

SEQ ID NO: 275 - DNA, 24 bp, Rattus rattus
tgactgtctaaaataaaccttcct

SEQ ID NO: 276 - DNA, 447 bp, Rattus rattus
actttagatctattttcaggaacgaatgcttagtgaaaagtgaaaacttaaaggtaaatgagtaaagtactgtaacatttaatttgatatataagattcgtgacatgagaaaactgatgaagcagccgcccgataatgctacataatttaatgaagaacctgttgggacatgagagaagtcataaaacagcagtgcaactcagactatattactatagaacaactagtctttaatgtatcaatatcatggtgttgatagaatgttattggtttaccagaggttactactggagaaaatgtgttaaagttacaatttcttaccatttcatgctgattatctcaagttttagaattatgttaaaagaatgtcttactaattttacattttctaaagtcaaagtaattttaactaaacaacagtaatgactgtctaaaataaaccttcct

SEQ ID NO: 277 - DNA, 24 bp, Rattus rattus
atcattcaacatacatcattccag

SEQ ID NO: 278 - DNA, 24 bp, Rattus rattus
tctagtttctgaatgttttgttgg

SEQ ID NO: 279 - DNA, 388 bp, Rattus rattus
atcattcaacatacatcattccaggagatgaagaacaatccatgcaccaattattcaatgctgccagagaccatgatagatctaaaagtatcgcctttcatgagaaagggaattgtaggagactggaagaaccacttccctgaagccctgagggagagatttgaggagcactaccagcagcaaatgaaggactgccctgtgaaatttagagcagagctctgagacaattccttgtgtctgaaattggagtagtctccaatttatccttcagtttttcttgttttgaattcagtagaagtagaagtcttttgaagactgagggtttaaattcattctggtttttttaatctaacttttatatcaatctagtttctgaatgttttgttgg

SEQ ID NO: 280 - DNA, 24 bp, Rattus rattus
ctatgaagacatgaaaaaggatac

SEQ ID NO: 281 - DNA, 24 bp, Rattus rattus
tgatgtctgaataactgaatgtga

SEQ ID NO: 282 - DNA, 391 bp, Rattus rattus
ctatgaagacatgaaaaaggatacaatgggatccataaagaagatatgtgacttcctggggaaaaaattagagccagatgagctgaatttggtcctcaagtatagttccttccaagtcgtgaaagaaaacaacatgtccaattatagcctcatggagaaggaactgattcttactggttttactttcatgagaaaaggcacaactaatgactggaagaatcacttcacagtagcccaagctgaagcctttgataaagtgttccaggagaaaatggccggtttccctccagggatgttcccatgggaataaattttcaaaagttttaaatattttatgaacactgatgtttatgtttatgttgttctatgatgtctgaataactgaatgtga

SEQ ID NO: 283 - DNA, 24 bp, Rattus rattus
gccgagagaacttcctgtttatca

SEQ ID NO: 284 - DNA, 24 bp, Rattus rattus
caacccaggatcctcacaataaac

SEQ ID NO: 285 - DNA, 433 bp, Rattus rattus
gccgagagaacttcctgtttatcacctacgaggagctgcagcaggacctgcgaggctccgtgcaactcatctgtgagttcctgggccggccactgggtgaagaggccctgagctctgtggtggcccattcagcttttgctgccatgaaggccaataacatgtccaactacacgctgctgccggccagcctgctagaccaccgccagggggcgttcctgcgcaaagggatcagtggcgactggaagaaccacttcactgtggcgcagagtgagacttttgaccaggtctaccgagagcaaatgcacgggctgccgagcttcccctgggacaggtccgcagaggacggcagccctgatggcgagactgagcccagccctagccccagccctggcctagcctctgatgaccccaacccaggatcctcacaataaac

SEQ ID NO: 286 - DNA, 24 bp, Rattus rattus
cacttagccctcaaggatgtctga

SEQ ID NO: 287 - DNA, 24 bp, Rattus rattus
agtactgtacggatgttctggaac

SEQ ID NO: 288 - DNA, 417 bp, Rattus rattus
cacttagccctcaaggatgtctgagggagcaatggccccatgtactgtccaccctgacacctaccggctctgtcttccagctccaatttggctcaagtgatgaccagatgatgggtggaccaggagattgctgcttgtggggaccaacttattctgttccttaccaggatgggaagagtcttaacgtggtggggggaggctctggctgtggaaggtgcctgctgtgcgccatctctgaagcaggtttggttgtagcagcgttacctctgtctagaggaaagcttgtgtgggtctggtgcatggttctctgaggtgggcatggcagtgcctttcctgtgtgtctggggaggaaggctgctttctgtgaaattttctttctatttttctatttttagtactgtacggatgttctggaac

SEQ ID NO: 289 - DNA, 24 bp, Rattus rattus
atacactatacacccagaacaatt

SEQ ID NO: 290 - DNA, 24 bp, Rattus rattus
ttgcttgtctctgaatttgatgaa

SEQ ID NO: 291 - DNA, 437 bp, Rattus rattus
atacactatacacccagaacaattttttttctttttctttttttcggagctggggaccgaacccagaacatttttttttttaaataaaaacaatctaattgctggccacacccatcagggaagatactggaatatgtgatctgtttctccagtatcttcagtctggacaatgactgccatctgttggtaacttacagaaagtttagtgttctgccttcagtgacagcaccacagtttcccttactcctgtcagctaatggcttcctcccctggattctcagaccagtgtggccttcccagtgttagtcattcctcactgtgctcatgttttgtgggtggcacggcctttgagctttgggagaaaagaagatgaggctgtgacactggtggccctgtgtttgagataataattattgcttgtctctgaatttgatgaa

SEQ ID NO: 292 - DNA, 24 bp, Rattus rattus
ggaaagataccagccacattagga

SEQ ID NO: 293 - DNA, 24 bp, Rattus rattus
tctagatgtgattgggttcctgct

SEQ ID NO: 294 - DNA, 473 bp, Rattus rattus
ggaaagataccagccacattaggatccaatacgagattgtttgactggattcctcagaatgatcttcttggacatcccaaaaccagagcttttatcacccatggtggaacaaatggaatctatgaggccatttaccacgggatcccgatggtgggagttcccatgttcgctgatcagcctgacaacatagctcacatgaaggctaaaggagcagctgtggaggtgaacatgaacacgatgacgagtgcagatctgctcagtgctgtgagagcagtcatcaatgagccattttataaagagaatgccatgagactatcaagaattcaccacgatcagccagtgaagcccctggacagagccgtcttctggattgagtttgtcatgcgtcacaaaggagccaagcaccttcgtgtggcagcgcatgacctcagctggtttcagtaccactctctagatgtgattgggttcctgct

SEQ ID NO: 295 - DNA, 24 bp, Rattus rattus
atagtgtccattagcttctttgtc

SEQ ID NO: 296 - DNA, 24 bp, Rattus rattus
caagaagtagggataagctatgaa

SEQ ID NO: 297 - DNA, 388 bp, Rattus rattus
atagtgtccattagcttctttgtctaatactgaatctgtagctttcatacaataaaatgtagataacttgtacacgataaatactggcatataattttttttctgtaatagacctaattacttgttgtctgggataaagtgtggttagtttggatatcagttttaaaggaatctgttggctcttttgttcctcttacataatatgctaacatagagcatctcaagggaaaagcagaacagtttatttggagttgtgaccacagttccttaaaatgtagagtagcggagaaggcagggcagcagtcatccagaggaggaagctcacttgtcacatctcaaccatatatggaaagcagagagtgagcaagaagtagggataagctatgaa

SEQ ID NO: 298 - DNA, 24 bp, Rattus rattus
ttcatcatcacaaaattctgcctc

SEQ ID NO: 299 - DNA, 24 bp, Rattus rattus
gctactgtagttcataaagttcac

SEQ ID NO: 300 - DNA, 360 bp, Rattus rattus
ttcatcatcacaaaattctgcctcttttgttgccgtaagactgctaacatgggaaagaagaagaaagagtagcatcataaaggctgaagcagagccctgagagatgagcctctgccagctgcttccagaggaacctgttgtcatgccagtgccttccctctaaaagaagacagcgttgggacctcattgaacatggctccaatgaattcactatgttctgaagacatgcaagatttcatgccaaatatatattcagtgctaaaaaaacaaaatcctgtgttcagtttagaatgttttgatgtagctgagaagctttgcccaacaacaataactgaagctactgtagttcataaagttcac

SEQ ID NO: 301 - DNA, 24 bp, Rattus rattus
aaaaaaatgctgtgtggttgtcaa

SEQ ID NO: 302 - DNA, 24 bp, Rattus rattus
gtaagaagacatataactccgtaa

SEQ ID NO: 303 - DNA, 406 bp, Rattus rattus
aaaaaaatgctgtgtggttgtcaaccattcaccatgaccaacctatgaagcccctggacaaggctgtcttctggattgagtttgtcatgcgccacaaaggggccaagcacctgaggccacttggacatgaccttccctggtaccagtaccactctctggatgtgattggattcctgctcacctgttcggcagtcattgcagtccttactgtaaaatgcttcttgtttatttaccgactctttgtgaagaaggaaaagaaaatgaagaatgagtagagctcatttacaatgcactacaggaatgaaatttcagcctcattctaatttatgaatcaccttcttaacacttcctgattatttttttgtcaaggcagatcatctttgtaagaagacatataactccgtaa

SEQ ID NO: 304 - DNA, 24 bp, Rattus rattus
aagtgctttttatttgtttatcga

SEQ ID NO: 305 - DNA, 24 bp, Rattus rattus
ttgcctgtgtagaaaaatatataa

SEQ ID NO: 306 - DNA, 297 bp, Rattus rattus
aagtgctttttatttgtttatcgattctttgtaaagaaggaaaagaaaacaaagaatgagtagagctcaatgataatgcatcacatgaatgaaatttgttcatcattttaagttatgaaccaccttctaaaaactcattaataactttacagaagcatagcttctttgtaattttgtaccatgtaaaaagacatataattctgaggcttctgatatgtgaccaaagaatcccatcatttattttaattttcaaactattcaatgtaaaacaatttgcctgtgtagaaaaatatataa

SEQ ID NO: 307 - DNA, 24 bp, Rattus rattus
ttgctgtaaaatgcttcttgttca

SEQ ID NO: 308 - DNA, 24 bp, Rattus rattus
gttgcattgtagaaaaattgagga

SEQ ID NO: 309 - DNA, 270 bp, Rattus rattus
ttgctgtaaaatgcttcttgttcatttaccgattctttgcaaagaagcaaaagaaaatgaagaatgagtagagctcgttgacaatgcactacaggaatgaaatttaagcctcattctaatttatgaatcactttcttaacacttcctgatttttttttgtggaggcagatcatcattgtaagaagacatatagctctgtgaatattgatatgttatcaaaattttaaaatcacttaatgtaaaaaagttgcattgtagaaaaattgagga

SEQ ID NO: 310 - DNA, 24 bp, Rattus rattus
cttagatatcaccagttttttaat

SEQ ID NO: 311 - DNA, 24 bp, Rattus rattus
tcggattttattttacagtattat

SEQ ID NO: 312 - DNA, 360 bp, Rattus rattus
cttagatatcaccagttttttaatgcacagtgcatacagcctactgctttctgaatacttgaaatggtatctgtacacaccagttagctactccttttcacaatcttatcacaatgttgccgttcaaagaggaaaaaagatcaggcaatgaatggtggggcagcagagcatagagtgtatgaacgagctgagtttacttttggcatttgataaagttggtaataggcactaactggatgattaaacataagttaatttccactgtgatttaaaaaaaaacttaaaacaataaacaaagttgaaaatagaaaaatgttgttggaataaaatttttattcggattttattttacagtattat